(19) United States
(12) Patent Application Publication
(10) Pub. No.: US 2022/0049331 A1
(43) Pub. Date: Feb. 17, 2022

(54) LONG DURABILITY HIGH PERFORMANCE STEEL FOR STRUCTURAL, MACHINE AND TOOLING APPLICATIONS

(71) Applicant: ROVALMA, S.A., Barcelona (ES)

(72) Inventor: Isaac VALLS ANGLÉS, Barcelona (ES)

(73) Assignee: ROVALMA, S.A., Barcelona (ES)

(21) Appl. No.: 17/501,629

(22) Filed: Oct. 14, 2021

Related U.S. Application Data
(62) Division of application No. 16/065,622, filed on Jun. 22, 2018.

(30) Foreign Application Priority Data
Aug. 4, 2016 (EP) 16382386.7
Dec. 5, 2016 (ES) 20163552

(51) Int. Cl. C22C 38/04; B22F 3/04; B22F 3/15; B22F 10/20

(52) U.S. Cl. CPC C22C 38/04; B22F 10/20; B22F 3/15; B22F 3/04

(57) ABSTRACT

Steels, in particular hot work steels having high toughness even for high thickness, including steels having long durability combined with mechanical, tribological and thermal properties for highly demanding applications, and steels which can achieve a very good environmental resistance and resistance to certain aggressive media combined with other relevant properties, are described. These steels may also be obtained at low cost. A method for the manufacture of steels having high thickness and manufacturing methods to shape the materials of the invention through several steps, including an additive manufacturing step to manufacture at least apart of an intermediate mold, a mold or a model, a Cold Isostatic Pressing (CIP) step, the elimination of the mold and densification among other steps, are also described.

### CROSS REFERENCE TO THE RELATED APPLICATION

This application is a Divisional of U.S. patent application Ser. No. 16/065,622 filed Jun. 22, 2018 which is a national phase entry under 35 USC 371 of International Patent Application No.: PCT/EP2017/050039 filed on Jan. 2, 2017, which claims priority to Spanish Application 201631552 filed Dec. 5, 2016, EPO application 16382386.7 filed Aug. 4, 2016 and EPO 15382664.9 filed Dec. 24, 2015 the contents of all of which are incorporated herein by reference.

### FIELD OF THE INVENTION

The present invention relates to steels, in particular tool steels which present high levels of toughness properties even for large cross-sections.

Further, the present invention relates to steels which present long durability combined with mechanical, tribological and thermal properties for highly demanding applications. The steels of the present invention can achieve a very good environmental resistance and resistance to certain aggressive media combined with other relevant properties through certain compositional rules. It is also possible by means of the present invention to obtain such steels at low cost.

### STATE OF THE ART

Hot work tool materials have known for a long time and we classified by AISI in family H. Those having better combination of mechanical properties for aluminium die casting are H11 and H13 and thus are the more employed.

In last years some efforts have been invested in trying to increase hardenability of these materials, mainly through raise a few alloying elements like % Mo and even % Cr, and through the addition of other elements in small amounts like % N. These efforts have resulted in an increase of the cross-sections that can be treated maintaining good yield strength at working temperature, but the effect in toughness has in all cases been negligible. Also in last years efforts have been made in the reduction of the contents of % S and % P for an increase in toughness in general. This has also been extended to other elements like % Sn, % Sb, % Pb, % As, . . . . Finally, efforts have been made to increase the thermal conductivity of these steels by reducing the alloy, especially trace elements not required for basic mechanical properties. (among others: % Cu, % Ni, . . . ). These efforts have had a marginal reward in terms of resistance to cracking and slight increase in conductivity. But in no case in terms of obtaining good properties of the relevant parameters of toughness for big thicknesses.

Since the development of stainless steels by Harry Brearley a huge amount of patents, articles and scientific works have been produced to combine such a property with other relevant properties, normally mechanical ones, for high demanding applications.

The strong effect of % P on the strengthening of ferrite has long been known as much as the associated drop in formability or other ductility related properties. For strengthening purposes, and when ductility is not a concern % P might be added up to 0.2%. Also the positive effect on bake hardenability is industrially used with contents up to 0.10%. Phosphor is also known to strongly contribute to the diminishing of the core loss of motor lamination steel and is used for this purpose with contents up to 0.155%. It is also extensively reported in the literature that the negative effect of % P in terms of ductility loss is strongly aggravated by the presence of Mn, Si, Ti, Nb, V, Mo, Cr and other carbide formers (see FIG. 1 for the case of % Ti).

Although % P is considered a toughness limiting impurity in steel and often is desired as low as possible, sometimes when lowest cost is pursued, high % P ferro-alloys can be used which increase somewhat the % P content of the alloy but the level remains below 0.1%. Some inventors have added % P intentionally to their alloys principally for two reasons: Searching to increase the lubricious-effect of the alloy by creating phosphides, precipitating eutectic steadite and/or promoting sulfides or to decrease the liquidus temperature to have liquid phase sintering. In both cases, the alloy might be simultaneously requiring wear resistance for which carbide builders might be added, principally % Cr, % Mo, % W and % V and far more rarely % Zr, % Ta, % Ti and % Hf. In all cases the carbide builders are there to form carbides or other hard particles (principally nitrides, borides or combinations), but not as free element to oxidize and passivate the surface, like is the case in the present invention. The alloys might further include % Ni, % Mn, % Si, % Cu and more rarely % Al for various purposes, but mainly to provide hardenability and sometimes even to provide precipitation hardening in the case of the % Al. There is also one document searching to increase the scale resistance of the alloy. Some comments are provided on the most relevant documents to the eyes of the inventor:

U.S. Pat. No. 1,707,364 A document searching to increase the scale resistance of the alloy. (% C<1.5%; % P: 0.05-50%, % Cr: 3-30%, the alloy might further comprise % Mo and % Si). The alloy includes % P contents well above the limit of solubility in iron which means the toughness levels are not adequate for the present invention, the alloy might have an improved resistance to the scale formation but lacks corrosion resistance since the strong, insoluble and thin oxide former is missing and thus falls completely out of the scope of the present invention in its preferred embodiment. If % Cr is considered as the only protective oxide former, the document does also not teach that when the levels of this element are low, like the ones taught in the present invention special care has to be taken for this % Cr to be available for oxidation. % P of 50% is actually almost impracticable with the means described in the invention, the examples do provide practicable levels, the highest being 0.157%. The examples provide % Cr 2-3% with % C 0.4% and the absence of strong carbide builders, meaning almost all % Cr is bound into the carbides and not free to form a protective oxide layer.

U.S. Pat. No. 4,909,843, Wear resistant alloys containing % P to provide lubricant effect, all characterized by having high % C contents and the absence of strong oxide builders. % Cr might be added U.S. Pat. Nos. 5,545,247, 5,631,431, 6,852,143 B2; DE3712107; DE3712108 Al; U.S. Pat. Nos. 2,038,639; 2,186,758; 2,256,135; 3,698,877; 3,977,838; 4,000,980; 4,702,771; 4,778,522; 4,836,848.

U.S. Pat. No. 3,767,386 describes a cast-iron for making brake shoes (% C:2.7-3.5%; % Si 1.0-2.0%; % Mn:0.4-1.5%; % P: 1.0-3.0; s<0.15% and Ti 0.3-0.7% where % V, % Cr and % Mo can be present up to a 1.25%). Again the lubricant effect is looked after and the Ti is in low contents and firmly bound into carbides to control grain size and provide extra wear resistance. Besides that the % C content is much higher than that of the present invention.

U.S. Pat. No. 4,243,414 describes a liquid phase sintered alloy where either % P, % B or % Si is added to lower the melting point. % Cr content is very high and there is no presence of preferred strong, insoluble thin oxides, let alone its presence as active elements. A similar case is that of U.S. Pat. No. 4,790,875 where in this case % Ti can be present. In this case the % C is mostly out of the scope of the present invention, and both % P and % Ti are bound and thus cannot act with the purpose of the present invention. % Ti is bound into carbides and thus cannot oxidize and % P is bound into steadite Fe—C—P.

U.S. Pat. No. 4,043,808 where the % P addition is used to control the fragmentation behaviour of the steel. % P contents are too low and proper oxide formers not present in the correct form, actually in this case not present at all.

For almost as long as stainless steels were invented, substitutes have been pursued, containing less Chromium or no chromium at all. One of the most remarkable advances in this respect are the so called Fe—Mn—Al. With Mn contents ranging from 15-40% and Al contents ranging from 5-15% these alloys have been reported to have good resistance against some aggressive environments like NACE solutions (5% wt NaCl, 0.5% wt acetic acid, balance distilled water and H2S gas bubbling.) and not so good performance in acidic chloride bearing media. The metallurgical concept is quite different to the one of the present invention. Large amounts of Mn are used to make the alloy austenitic and also to diminish the % Fe content, then large amounts of Al are used to provide a protective aluminium oxide layer, without the need to stabilize the iron oxide. Much higher alloying is needed than in the present invention, especially in terms of % Al. Also no improved mixed oxides are employed. The high % Al contents are detrimental for the mechanical properties and the cost of the alloy.

Another interesting group of alloys are the so called high Mn TRIP and TWIP steels. There were developed later than the Fe—Mn—Al corrosion resistant steels described in the previous paragraph and are steels that pursue the high elongation at high mechanical strength levels associated to high % Mn containing steels. Since corrosion resistance is not an issue, but mechanical properties, % Al is lowered and provided only to increase the stacking fault energy of austenite and suppress the formation of epsilon/martensite. Aluminium in this alloys will often form precipitates with iron. There are numerous patents and publications on these alloys like JPH0483852 (A) or EP0889144 (A1). In this family of alloys the usage of % P as a strengthener and especially as improvement of castability (in terms of flowing ability of the melt) has been employed like in WO2013124283A1 where % P is newly employed to improve cold workability of TRIP & TWIP steels. No ambient resistance of this alloys is reported, despite the same authors having made significant efforts to attain simultaneously corrosion resistance and TRIP/TWIP effect as can be seen in DE102010026808A1 (where % Cr is used to provide the ambient resistance of the alloy). The main reason lays in that they were not providing the % Al as a protective oxide former, and they were not providing the % P as an iron oxide stabilizer and thus have not observed the alloying rules and other steps necessary, as reported in the present invention, to make sure that the alloying elements are present in the desirable manner.

It is very important for the implementation of the present invention to take special care to make sure that the critical elements are present in the right form, since if the elements have to be active and are not their presence is worthless, this is specially the case for the protective oxide formers whose presence in the form of carbides, borides or nitrides is meaningless and also for % P whose presence in the form of steadite or phosphate is also of little value. So the elements not only have to be added but special care has to be taken to make sure they are present in the right form.

### DESCRIPTION OF DRAWINGS

FIG. 1. Shows a plot of the d(dL/L)/dt (increment of length increase normalized with length divided by increment of time) vs. temperature during cooling and looking for conventional steel H11, at temperatures below 600° C. the curve is quite horizontal and suffers a sudden drop at a certain temperature TD. Number 1 in a circle of FIG. 1 refers to the curve plot and number 2 in a circle of the FIG. 1 refers to an example of TD value.

FIG. 2. Shows a plot of the d(dL/L)/dt (increment of length increase normalized with length divided by increment of time) vs. temperature during cooling and looking for steel 3356LAB-3 of the invention, at temperatures below 600° C. the curve is quite horizontal and suffers a sudden drop at a certain temperature TD. Number 1 in a circle of FIG. 2 refers to the curve plot and number 2 in a circle of the FIG. 2 refers to an example of TD value.

FIG. 3. Shows a Taffel Plot for the compositions of Table 3.

FIG. 4: Example of Hot Stamping die: 1—Internal feature AM intermediate mold. 2-External feature AM intermediate mold. 3—Very elastic material cover mold. 4-Particulate material. 5—Acting pressure during CIP.

### DETAILED DESCRIPTION OF THE INVENTION

Hot work materials commonly employed for applications having high mechanical solicitations are steels for hot working tools, usually alloys of chromium, molybdenum or tungsten. Often, these materials include also other alloying elements such as vanadium, silicon, manganese, niobium, aluminium, etc. These materials present a very good combination of creep tension at working temperature and toughness.

The process of constructing the tools and/or tools with this type of material includes a stage of soft machining, heat treatment and a machining step of finishing and/or adjustment. Some of the material's properties are very sensitive to quenching. For these reasons particular attention is directed to the homologation process in the heat treatment. It is generally accepted that in this kind of materials it is very critical the time spent in moving from 800 to 500 during the quenching step, especially to which refers in particular to properties related to toughness. It is also critical if structures different from martensite are formed during the quenching step of the heat treatment.

The problem is that the cooling media to ensure a sufficiently rapid quenching are limited, and almost always these tools or dies have complex shapes, so that a fast cooling leading to cracking and/or extreme distortion. Thus, due to the limitation on the maximum cooling rate, the critical speed of cooling will only be obtained if the cross-section of quenched material is small enough. So that, the heat treatment of hot working materials, for applications having high mechanical solicitations (like most of light alloys injections, forging, superelastic deformation of sheets, extrusion, injection of cooper/bronze/brass) is not possible for dies and/or large thick tools.

In this document, if a piece is defined by its three orthogonal measures in the Cartesian reference system, the thickness is the smallest measure of the three.

In this document all percentages are referred to weight percentages.

In this document, elements whose amounts are expressed as less than a value explicitly include the value 0% or which is the same, their absence. Elements whose amounts are expressed by a range beginning with zero include the possibility that they are not intentionally present, and even that they are absent.

In this document fracture toughness is measured according to the norm ASTM E399.

A first aspect of the invention refers to steels having high toughness even for high thickness.

As mentioned, achieving high hardenability in hot work tool materials is possible, but achieving high toughness values when big thickness are quenched is another history. Inventor has found that this is surprisingly possible if correct alloy strategy and heat treatment are chosen. This is possible with the following compositional range:

| | | | |
|---|---|---|---|
| % Ceq = 0.31-0.69 | % C = 0.31-0.69 | % N = 0-0.2 | % B = 0-0.1 |
| % Cr = 2.6-6.8 | % Ni = 0-3 | % Si = 0-1.8 | % Mn = 0-5.8 |
| % Al = 0-0.4 | % Mo = 0-4.4 | % W = 0-7.8 | % Ti = 0-2 |
| % Ta = 0-0.3 | % Zr = 0-0.4 | % Hf = 0-0.3 | % V = 0-2.9 |
| % Nb = 0-0.6 | % Cu = 0-1.2 | % Co = 0-2.9 | % Moeq = 0.01-4.4 |
| % La = 0-0.2 | % Ce = 0-5 0.2 | % Cs = 0-0.2 | |

wherein

% Gd+% Nd+% Sm+% Y+% Pr+% Sc+% Pm+% Eu+% Tb+% Dy+% Ho++% Er+% Tm+% Yb+% Lu=0-0.5%;

the rest consisting of iron and trace elements wherein, % Ceq=% C+0.86*% N+1.2*% B; and

% Moeq=% Mo+Bz % W;

With the proviso:

If % B<20 ppm or % Ni<0.25% then % Mn>0.8%

In another aspect, the invention refers to a steel having the above composition having high levels of toughness properties even for large cross-sections. In an embodiment the steel of the above composition is a hot work steel. In an embodiment the steel of the above composition is a hot work tool steel. In an embodiment the steel of the above composition is at least partially martensitic. In another embodiment the steel of the above composition is at least partially bainitic.

In the meaning of this text, trace elements refer to any element, otherwise indicated, in a quantity less than 2%. For some applications, trace elements are preferable to be less than 1.4%, more preferable less than 0.9% and sometimes even more preferable to be less than 0.78%. Possible elements considered to be trace elements are H, Li, Na, K, Rb, Fr, Be, Mg, Ca, Sr, Ba, Ra, Ac, Tc, Re, Ru, Os, Rh, Ir, Pd, Pt, Ag, Au, Zn, Cd, Hg, B, Ga, In, Tl, Ge, Sn, Pb, P, As, Sb, Bi, O, S, Se, Te, Po, F, Cl, Br, I, At, He, Ne, Ar, Kr, Xe, Rn, Th, Pa, U, Np, Pu, Am, Cm, Bk, Cf, Es, Fm, Md, No and Lr alone and/or in combination. For some applications, some trace elements or even trace elements in general can be quite detrimental for a particular relevant property (like it can be the case sometimes for thermal conductivity and toughness). For such applications it is desirable to keep trace elements below a 0.4%, preferably below a 0.2%, more preferably below 0.14% or even below 0.06%. Needless to say being below a certain quantity includes also the absence of the element. In many applications, the absence of most of the trace elements or even all of them is obvious and/or desirable. As mentioned every trace element is considered a single entity and thus very often for a given application different trace elements will have different maximum weight percent admissible values. Trace elements can be added intentionally to search for a particular functionality including also cost reduction or its presence (when present) can be unintentional and related mostly to impurity of the alloying elements and scraps used for the production of the alloy. The reason for the presence of different trace elements can be different for one same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

Inventor has found that for certain applications it is desired several trace elements being absent from the composition, such any of Ca, P and/or S. For certain applications Ca is preferred not being present in the steel composition as a trace element. For certain applications P is preferred not being present in the steel composition as a trace element. For certain applications S is preferred not being present in the steel composition as a trace element.

For some embodiments, inventor has found that Ti, Ta, Zr, Hf, Nb, La, Ce, Cs are optional elements in the composition of the steel, and in some embodiments any of them and/or all of them may be absent from the composition.

Inventor has found that for several applications, it may be desired having % Ti+% Ta+% Zr+% Hf+% Nb+% La+% Ce+% Cs=0-4.2%.

Inventor has found that for several applications, it may be desired having % Ti+% Ta+% Zr+% Hf+% Nb+% La+% Ce+% Cs=0-3.7%.

Inventor has found that for several applications, it may be desired having % Ta+% Zr+% Hf+% Nb+% La+% Ce+% Cs=0-2.2%.

Inventor has found that for several applications, it may be desired having % Ta+% Zr+% Hf+% Nb+% La+% Ce+% Cs=0.001-2.2%.

Carbon equivalent is important and of great importance in determining the majority of relevant properties. When high mechanical resistance at high temperatures is required the % Ceq cannot be too low. For some applications of the present invention, the inventor has found that it is desirable % Ceq greater than 0.36%. For some applications of the present invention, the inventor has found that it is desirable % Ceq greater than 0.38%. For some applications of the present invention, the inventor has found that it is desirable % Ceq greater than 0.41%. When high toughness and/or elongation is required It is often desirable % Ceq not being too high. For some applications of the present invention the inventor has found that it is desirable % Ceq less than 0.58%. For some applications of the present invention the inventor has found that it is desirable % Ceq less than 0.48%. For some applications of the present invention the inventor has found that it is desirable % Ceq less than 0.44%.

Inventor has found that for several applications it is desired having % Ceq between 0.32 and 0.54%, normally % Ceq between 0.34 and 0.51%, and even % Ceq between 0.35 and 0.48%. Within the carbon equivalent, often the % C has great importance. When mechanical resistance at high temperatures is required, % C cannot be too low. For some applications of the present invention, the inventor has found that it is desirable % C greater than 0.36%. For some applications of the present invention, the inventor has found that it is desirable % C greater than 0.38%. For some applications of the present invention, the inventor has found that it is desirable % C greater than 0.41%. When high toughness and/or elongation is required It is often desirable % C not being too high. For some applications of the present invention the inventor has found that it is desirable % C less than 0.58%. For some applications of the present invention the inventor has found that it is desirable % C less than 0.48%. For some applications of the present invention the inventor has found that it is desirable % Ceq less than 0.44%.

Inventor has found that for several applications it is desired having % C between 0.32 and 0.54%, normally % C between 0.34 and 0.51%, and even % C between 0.35 and 0.48%.

Sometimes within the carbon equivalent, it is desired % N content not being excessive. For some applications of the present invention the inventor has found that it is desirable % N less than 0.09%. For some applications of the present invention the inventor has found that it is desirable % N less than 0.004%. For some applications of the present invention the inventor has found that it is desirable % N being absent. For some applications of the present invention % N can help to improve hardenability. For some applications of the present invention, the inventor has found that it is desirable % N greater than 0.06%. For some applications of the present invention, the inventor has found that it is desirable % N greater than 0.11%.

Sometimes within the carbon equivalent, it is desired % B content not being excessive. For some applications of the present invention the inventor has found that it is desirable % B less than 0.03%. For some applications of the present invention the inventor has found that it is desirable % B less than 0.019%. For some applications of the present invention the inventor has found that it is desirable % B less than 0.009%. For some applications of the present invention the inventor has found that it is desirable % B being absent. For some applications of the present invention % B can help to improve hardenability, especially retarding ferritic transformation. For some applications of the present invention, the inventor has found that it is desirable % B greater than 0.002%. For some applications of the present invention, the inventor has found that it is desirable % B greater than 0.0042%. For some applications of the present invention, the inventor has found that it is desirable % B greater than 0.006%.

Chromium content is important and has a great importance in determining the majority of relevant properties, since its presence in secondary carbides is almost always of great influence. When mechanical resistance at high temperatures is required without excessive sacrifice of toughness, % Cr cannot be too low. For some applications of the present invention, the inventor has found that it is desirable % Cr greater than 3.6%. For some applications of the present invention, the inventor has found that it is desirable % Cr greater than 4.2%. For some applications of the present invention, the inventor has found that it is desirable % Cr greater than 4.6%. When high toughness and/or elongation is required often is desired % Cr not being too high. This is further the case when the presence of other carbide formers like % V, % Mo and/or % W is high. For some applications of the present invention the inventor has found that it is desirable % Cr less than 5.8%. For some applications of the present invention the inventor has found that it is desirable % Cr less than 5.4%. For some applications of the present invention the inventor has found that it is desirable % Cr less than 4.9%.

Inventor has found that for several applications it is desired having % Cr between 2.9 and 5.9%, normally % Cr between 3.6 and 5.9%, and even % Cr between 4.1 and 5.9%.

Inventor has found that for several applications it may be desirable having % Cr-% Mn (the difference between % Cr and % Mn=% Cr-% Mn) above 1.2%, normally for certain applications it is desirable having % Cr-% Mn above 1.6%, for certain applications % Cr-% Mn above 1.9%.

Inventor has found that for several applications it may be desirable having % Cr+% Mn above 2.8%, normally for certain applications it is desirable having % Cr+% Mn above 3.4%, in some other applications % Cr+% Mn above 4.1%. and for certain applications even % Cr+% Mn above 4.9%.

Inventor has found that for certain applications having % C above 0.4 it is desired having % Cr above 3.6%, normally for certain applications it is desirable having % Cr above 3.9%, and even for certain applications % Cr above 4.1%.

Manganese content is important and has a great importance in the present invention. Inventor has found that surprisingly from a specific content of % Mn the materials of the present invention have high toughness even when pieces of high thickness are treated. This is not a gradual effect, but for % Mn too low is not given, and is given from a certain content in % Mn. The critical content depends on the specific quantities of the other elements in the alloy. For some applications of the present invention, the inventor has found that it is desirable % Mn greater than 0.8%. For some applications of the present invention, the inventor has found that it is desirable % Mn greater than 1.10%. For some applications of the present invention, the inventor has found that it is desirable % Mn greater than 1.6%. For some applications of the present invention, the inventor has found that it is desirable % Mn greater than 2.1%. For some applications of the present invention, the inventor has found that it is desirable % Mn greater than 2.6%. For some applications of the present invention, the inventor has found that it is desirable % Mn greater than 3.1%. An excessive content of % Mn, and depending on the quantities of other elements in the alloy, has been found that can negatively affect the ease of machining of the steel. For some applications of the present invention the inventor has found that it is desirable % Mn less than 4.8%. For some applications of the present invention the inventor has found that it is desirable % Mn less than 4.4%. For some applications of the present invention the inventor has found that it is desirable % Mn less than 3.9%. For some applications of the present invention the inventor has found that it is desirable % Mn being absent from the composition.

Inventor has found that for several applications it is desired having % Mn between 0.1 and 5.8%, normally % Mn between 2.1 and 4.9%, for some applications % Mn between 2.2 and 4.9%, in other applications % Mn between 2.3 and 4.9% and even % Mn between 3.1 and 4.6%.

Inventor has found that for several applications, when % C is above 0.38%, it is desired % Mn above 1.1%, normally for some applications % Mn above 1.6%, and even in certain applications % Mn above 2.1%.

Inventor has found that for several applications, when % C is below 0.55%, it is desired % Mn above 1.6%, normally for some applications % Mn above 2.1%, and even in certain applications % Mn above 2.2%.

Inventor has found that for several applications, when % C is between 0.45 and 0.55, and % Cr is between 4.4 and 4.6% it is desired % Mn above 0.3, normally for some applications % Mn above 1.1, and even in certain applications % Mn above 2.1%.

Inventor has found that for several applications, when % C is above 0.45%, and % Cr is lower than 3.9% it is desired % Mn above 0.5%, normally for some applications % Mn above 1.3%, and even in certain applications % Mn above 2.1%.

Inventor has found that for several applications, when % C is lower than 0.45%, it is desired % Mn above 0.6%, normally for some applications % Mn above 0.8%, and even in certain applications % Mn above 2.1%.

Inventor has found that for several applications, when % C is below 0.45%, and % Cr is lower than 3.6% it is desired % Mn above 0.7%, normally for some applications % Mn above 1.3%, and even in certain applications % Mn above 2.1%.

Inventor has found that for several applications, when % C is below 0.65%, it is desired % Mn above 1.1%, normally for some applications % Mn above 1.3%, and even in certain applications % Mn above 2.1%.

Inventor has found that for several applications, when % C is above 0.45%, and % Cr is above 2.8% it is desired % Mn above 0.8%, normally for some applications % Mn above 1.3%, and even in certain applications % Mn above 2.1%.

Inventor has found that the particular effect of % Mn can be partially replaced by % B and/or % Ni. For some applications of the present invention the inventor has found that it is desirable the simultaneous presence of % Mn and % Ni in the in the amounts described in the present invention. For some applications of the present invention the inventor has found that it is desirable the simultaneous presence of % Mn, % B and % Ni in the amounts described in the present invention. In fact, inventor has found that if % B is not present in sufficient amount (values reported in this document) and % Ni either, then the presence of % Mn is mandatory.

Nickel content is important and has a great importance, in particular its influence in hardenability and also its substitutive effect of % Mn on their peculiar effect identified in the present invention. For some applications of the present invention, the inventor has found that it is desirable % Ni greater than 0.25%. For some applications of the present invention, the inventor has found that it is desirable % Ni greater than 0.32%. For some applications of the present invention, the inventor has found that it is desirable % Ni greater than 0.52%.

When high toughness is required, especially at high temperature, often it is desired % Ni not being too high. For some applications of the present invention the inventor has found that it is desirable % Ni less than 1.8%. For some applications of the present invention the inventor has found that it is desirable % Ni less than 0.78%. For some applications of the present invention the inventor has found that it is desirable % Ni less than 0.49%.

For some applications of the present invention the inventor has found that it is desirable % Ni being absent from the composition. Inventor has found that for several applications, when % Ni and % B are absent from the composition it is desired having % Mn>0.1%. For certain applications when % Ni and % B are absent from the composition it is desired having % Mn>1.6% and even in some applications % Mn>2.6%.

Inventor has found that for several applications it is desired having % Ni between 0 and 2.8%, normally % Ni between 0 and 2.4%, and even % Ni between 0.1 and 2.6%.

Inventor has found that for several applications, when % C is below 0.36%, and % Cr is lower than 3.6% it is desired % Ni below 2.4%, normally for some applications % Ni below 2.3%, and even in certain applications % Ni below 2.2%.

Inventor has found than for some compositions, % Si neutralizes the surprising and positive effect of the present invention, negatively affecting the obtainable values of toughness for high thicknesses. For some applications of the present invention the inventor has found that it is desirable % Si less than 0.4%. For some applications of the present invention the inventor has found that it is desirable % Si less than 0.18%. For some applications of the present invention the inventor has found that it is desirable % Si less than 0.08%. For some applications of the present invention the inventor has found that it is desirable % Si less than 0.04%. For some applications of the present invention the inventor has found that it is desirable % Si being absent from the composition.

Inventor has found that for several applications it is desired having % Si between 0 and 1.2%, normally % Si between 0 and 1.2%, and even % Si between 0 and 0.4%.

Inventor has found that for several applications, when % C is below 0.55%, it is desired % Si below 0.95%, normally for some applications % Si below 0.8%, and even in certain applications % Si below 0.6%.

Inventor has found that for several applications, when % C is below 0.55%, and % Cr below 4.6% it is desired % Si below 1.4%, normally for some applications % Si below 0.95%, and even in certain applications % Si below 0.7%.

Inventor has found that for several applications, when % C is below 0.36%, and % Cr below 3.1% it is desired % Si above 0.6%, normally for some applications % Si above 0.7%, and even in certain applications % Si above 0.8%.

Inventor has found that for several applications, when % C is below 0.4%, and % Cr between 4.9 and 5.4% it is desired % Si above 0.25%, normally for some applications % Si above 0.3%, and even in certain applications % Si above 0.35%.

Inventor has found that for several applications, when % C is below 0.4%, and % Cr between 4.9 and 5.5% it is desired % Si below 1%, normally for some applications % Si below 0.9%, and even in certain applications % Si below 0.75%.

Inventor has found that for certain applications having % C lower than 0.48, and % Cr between 4 and 5.7%, it is desired having % Si lower than 0.75%, normally lower than 0.65% and even lower than 0.55%.

Inventor has found that for some applications the sum % Si+% Mn+% V is desired to be above 0.10%, sometimes above 0.26%, and even above 0.4%.

Inventor has found that for some compositions the sum of % Se+% Te+% As+% Pb+% Sb+% Sn can favor machining. For some applications of the present invention, the inventor has found that it is desirable further include in the steel composition % Se+% Te+% As+% Pb+% Sb+% Sn greater than 0.052%. But often the sum % Se+% Te+% As+% Pb+% Sb+% Sn has a negative effect on the steels of the present invention especially when % Mn is high and can disrupt the positive effect of a high % Mn. For some applications of the present invention, the inventor has found that it is desirable % Se+% Te+% As+% Pb+% Sb+% Sn less than 0.19%. For some applications of the present invention, the inventor has found that it is desirable % Se+% Te+% As+% Pb+% Sb+% Sn less than 0.09%. For some applications of the present invention, the inventor has found that it is desirable % Se+% Te+% As+% Pb+% Sb+% Sn less than 0.04%. For some applications of the present invention, the inventor has found that it is desirable % Se+% Te+% As+% Pb+% Sb+% Sn less than 0.008%. For some applications of the present invention, the inventor has found that it is desirable % Se+% Te+% As+% Pb+% Sb+% Sn being absent.

Inventor has found that for some compositions the sum of % As+% Sb+% Sn can favor machining. For some applications of the present invention, the inventor has found that it is desirable further include in the steel composition % As+% % Sb+% Sn greater than 0.052%.

But often the sum % As+% Sb+% Sn has a negative effect on the steels of the present invention especially when % Mn is high and can disrupt the positive effect of a high % Mn.

For some applications of the present invention, the inventor has found that it is desirable % As+% Sb+% Sn less than 0.19%. For some applications of the present invention, the inventor has found that it is desirable % As+% Sb+% Sn less than 0.09%. For some applications of the present invention, the inventor has found that it is desirable % As+% Sb+% Sn less than 0.04%. For some applications of the present invention, the inventor has found that it is desirable % As+% Sb+% Sn less than 0.008%. For some applications of the present invention, the inventor has found that it is desirable % As+% Sb+% Sn being absent.

Inventor has found that for some compositions the sum of % Se+% Te can favor machining.

For some applications of the present invention, the inventor has found that it is desirable further include in the steel composition % Se+% Te greater than 0.052%. But often the sum % Se+% Te has a negative effect on the steels of the present invention especially when % Mn is high and can disrupt the positive effect of a high % Mn. For some applications of the present invention, the inventor has found that it is desirable % Se+% Te less than 0.19%.

For some applications of the present invention, the inventor has found that it is desirable % Se+% Te less than 0.09%. For some applications of the present invention, the inventor has found that it is desirable % Se+% Te less than 0.04%. For some applications of the present invention, the inventor has found that it is desirable % Se+% Te less than 0.008%.

For some applications of the present invention, the inventor has found that it is desirable % Se+% Te being absent.

For some applications of the present invention, the inventor has found that % P+% S are further contained in the steel composition. Inventor has found that for some compositions % P+% S have a negative effect on the steels of the present invention especially when % Mn is high and can disrupt the positive effect of a high % Mn. For some applications of the present invention the inventor has found that it is desirable % P+% S less than 0.028%. For some applications of the present invention the inventor has found that it is desirable % P+% S less than 0.018%. For some applications of the present invention the inventor has found that it is desirable % P+% S less than 0.008%. For some applications of the present invention the inventor has found that it is desirable % P+% S less than 0.0004%. For some applications of the present invention the inventor has found that it is desirable % P+% S being absent from the composition.

For some applications of the present invention, the inventor has found that P is further contained in the steel composition. Inventor has found that for some compositions % P has a negative effect on the steels of the present invention especially when % Mn is high and can disrupt the positive effect of a high % Mn. For some applications of the present invention the inventor has found that it is desirable % P less than 0.028%. For some applications of the present invention the inventor has found that it is desirable % P less than 0.018%. For some applications of the present invention the inventor has found that it is desirable % P less than 0.008%. For some applications of the present invention the inventor has found that it is desirable % P less than 0.0008%. For some applications of the present invention the inventor has found that it is desirable % P being absent from the composition.

For some applications of the present invention, the inventor has found that S is further contained in the steel composition. Inventor has found that for some compositions % S has a negative effect on the steels of the present invention especially when % Mn is high and can disrupt the positive effect of a high % Mn. For some applications of the present invention the inventor has found that it is desirable % S less than 0.018%. For some applications of the present invention the inventor has found that it is desirable % S less than 0.008%. For some applications of the present invention the inventor has found that it is desirable % S less than 0.0008%. For some applications of the present invention the inventor has found that it is desirable % S less than 0.0004%. For some applications of the present invention the inventor has found that it is desirable % S being absent from the composition.

For some applications of the present invention, the inventor has found that O is further contained in the steel composition. Inventor has found that for some compositions % O has a negative effect on the steels of the present invention especially when % Mn is high and can disrupt the positive effect of a high % Mn. For some applications of the present invention the inventor has found that it is desirable % O less than 14 ppm. For some applications of the present invention the inventor has found that it is desirable % O less than 9 ppm. For some applications of the present invention the inventor has found that it is desirable % O less than 6 ppm. For some applications of the present invention the inventor has found that it is desirable % O less than 4 ppm. For some applications of the present invention the inventor has found that it is desirable % O being absent from the composition.

For some applications of the present invention, the inventor has found that H2 is further contained in the steel composition. Inventor has found that for some compositions % H₂ has a negative effect on toughness. For some applications of the present invention the inventor has found that it is desirable % H₂ less than 1.8 ppm. For some applications of the present invention the inventor has found that it is desirable % H₂ less than 0.9 ppm. For some applications of the present invention the inventor has found that it is desirable % H₂ less than 0.4 ppm. For some applications of the present invention the inventor has found that it is desirable % H₂ less than 0.08 ppm. For some applications of the present invention the inventor has found that it is desirable % H₂ being absent from the composition.

Molybdenum content is important and has a great importance in determination of the majority of relevant properties, since its presence in secondary carbides is almost always of great influence. When resistance to temper is required molybdenum cannot be too low.

For some applications of the present invention, the inventor has found that it is desirable % Mo greater than 0.6%. For some applications of the present invention, the inventor has found that it is desirable % Mo greater than 1.1%. For some applications of the present invention, the inventor has found that it is desirable % Mo greater than 1.6%. When high toughness and/or elongation is required often is desired % Mo not too high. This is also the case when the presence of other carbide builders like % V, % Cr, and/or % W is high. For some applications of the present invention the inventor has found that it is desirable % Mo less than 2.8%. For some applications of the present invention the inventor has found that it is desirable % Mo less than 1.9%. For some applications of the present invention the inventor has found that it is desirable % Mo less than 1.4%. For some applications of the present invention the inventor has found that it is desirable % Mo less than 0.8%. For some applications of the present invention the inventor has found that it is desirable % Mo being absent.

Inventor has found that for several applications it is desired having % Mo between 0.01 and 4.1%, normally % Mo between 0.5 and 3.9%, and even % Mo between 0.8 and 2.8%.

Inventor has found that for several applications, when % C is below 0.45%, and % Cr between 4.9 and 5.5% it is desired % Mo above 1.6%, normally for some applications % Mo above 1.7%, and even in certain applications % Mo above 1.8%.

Inventor has found that for several applications, when % C is between 0.45% and 0.55%, and % Cr between 4.4 and 4.6% it is desired % Mo below 2.9%, normally for some applications % Mo below 2.8%, and even in certain applications % Mo below 2.6%.

Inventor has found that for several applications, when % C is below 0.44%, and % Cr below 3.3% it is desired % Mo above 0.6%, normally for some applications % Mo above 0.7%, and even in certain applications % Mo above 0.8%.

Inventor has found that for several applications, when % C is below 0.55%, and % Cr below 3.3% it is desired % Mo above 0.6%, normally for some applications % Mo above 1.6%, and even in certain applications % Mo above 1.8%.

Inventor has found that for some applications of the present invention % Mo can be partially replaced by double the amount, in weight of % W. Also for some applications, what is described for % Mo in the preceding paragraph applies for % W but the contents expressed must be double. In this sense it is also interesting the % Moeq concept, for the cases of partial substitution, wherein % Moeq=% Mo+½% W. The desired contents for % Moeq follow the above about % Mo.

Inventor has found that for several applications it is desired having % W between 0.01 and 6.1%, normally % W between 0.5 and 4.1%, and even % W between 0.8 and 3.6%.

Inventor has found that for several applications it is desired having % Moeq between 0.1 and 3.9%, normally % Moeq between 0.18 and 3.9%, and even % Moeq between 0.8 and 2.8%.

Vanadium content is important and has a great importance in determination of the majority of relevant properties, since its presence in secondary carbides is almost always of great influence. When hot hardness is required % V cannot be too low. For some applications of the present invention, the inventor has found that it is desirable % V greater than 0.22%.

For some applications of the present invention, the inventor has found that it is desirable % V greater than 0.32%. For some applications of the present invention, the inventor has found that it is desirable % V greater than 0.55%. For some applications of the present invention, the inventor has found that it is desirable % V greater than 0.85%. When high toughness and/or elongation is required often it is desired % V not being too high. This is also the case when the presence of other carbide formers like % Mo, % Cr and/or % W is high. For some applications of the present invention the inventor has found that it is desirable % V less than 1.8%. For some applications of the present invention the inventor has found that it is desirable % V less than 1.2%. For some applications of the present invention the inventor has found that it is desirable % V less than 0.8%. For some applications of the present invention the inventor has found that it is desirable % V less than 0.4%. For some applications of the present invention the inventor has found that it is desirable % V being absent.

Inventor has found that for several applications it is desired having % V between 0 and 2.4%, normally % V between 0 and 1.3%, and even % V between 0.3 and 0.9%.

Inventor has found that for certain applications having % C above 0.4% it is desired having % V above 0.35%.

Inventor has found that for certain applications having % C above 0.38%, it is desired having % V lower than 0.45%, normally lower than 0.4% and even lower than 0.35%.

Inventor has found that for certain applications having % C below 0.4%, and % Cr between 4.9 and 5.4%, it is desired having % V lower than 0.9%, normally lower than 0.8% and even lower than 0.7%.

Inventor has found that for certain applications having % C below 0.4%, it is desired having % V lower than 0.8%, normally lower than 0.7% and even lower than 0.65%.

Inventor has found that for certain applications having % C below 0.55%, and % Cr below 4.6% it is desired having % V lower than 0.45%, normally for some applications lower than 0.4%.

Inventor has found that for certain applications having % C below 0.65%, and % Cr above 5.6% it is desired having % V lower than 0.55%, normally for some applications lower than 0.5%, and even for certain applications % V lower than 0.45%.

Inventor has found that for certain applications having % C above 0.4% it is desired having % V+% Mo above 1.6%, normally for certain applications above 1.7%, and even for certain applications above 1.8%.

Inventor has found that for certain applications having % C above 0.38% it is desired having % V+% Nb below 0.45%, normally for certain applications below 0.4%.

Inventor has found that for certain applications having % C lower than 0.48, and % Cr between 4 and 5.7%, it is desired having % V lower than 0.75%, normally lower than 0.65%.

Inventor has found that for several applications it is desired having % V+% Mo+% W>0.010% normally % V+% Mo+% W>0.1% and even % V+% Mo+% W>1.6%.

Sometimes it is desired % Ti content not being excessive. For some applications of the present invention the inventor has found that it is desirable % Ti less than 1.8%. For some applications of the present invention the inventor has found that it is desirable % Ti less than 1.3%. For some applications of the present invention the inventor has found that it is desirable % Ti being absent. For some applications of the present invention % Ti can help to improve the properties of the steel. For some applications of the present invention, the inventor has found that it is desirable % Ti greater than 0.001%. For some applications of the present invention, the inventor has found that it is desirable % Ti greater than 0.1%.

Inventor has found that for several applications it is desired having % Ti between 0 and 1.6%, normally % Ti between 0 and 0.9%, and even % Ti between 0.3 and 0.1%.

Sometimes it is desired % Co content not being excessive. For some applications of the present invention the inventor has found that it is desirable % Co less than 2.3%. For some applications of the present invention the inventor has found that it is desirable % Co less than 1.2%. For some applications of the present invention the inventor has found that it is desirable % Co being absent. For some applications of the present invention % Co can help to improve the properties of the steel. For some applications of the present invention, the inventor has found that it is desirable % Co greater than 0.001%. For some applications of the present invention, the inventor has found that it is desirable % Co greater than 0.1%.

Inventor has found that for several applications it is desired having % Co between 0 and 2.1%, normally % Co between 0 and 1.7%, and even % Co between 0.01 and 1.3%.

Sometimes it is desired % Cu content not being excessive. For some applications of the present invention the inventor has found that it is desirable % Cu less than 1.1%. For some applications of the present invention the inventor has found that it is desirable % Cu less than 0.4%. For some applications of the present invention the inventor has found that it is desirable % Cu being absent. For some applications of the present invention % Cu can help to improve the properties of the steel. For some applications of the present invention, the inventor has found that it is desirable % Cu greater than 0.001%. For some applications of the present invention, the inventor has found that it is desirable % Cu greater than 0.1%.

Inventor has found that for several applications it is desired having % Cu between 0 and 0.9%, normally % Cu between 0 and 0.7%, and even % Cu between 0.01 and 0.6%.

Inventor has found that for certain applications having % C below 0.46%, and % Cr between 4.65 and 5.6%, it is desired having % Cu below 0.28%, normally for certain applications below 0.2%, and even for certain applications below 0.1%.

Sometimes it is desired % Al content not being excessive. For some applications of the present invention the inventor has found that it is desirable % Al less than 0.35%. For some applications of the present invention the inventor has found that it is desirable % Al less than 0.2%. For some applications of the present invention the inventor has found that it is desirable % Al being absent. For some applications of the present invention % Al can help to improve the properties of the steel. For some applications of the present invention, the inventor has found that it is desirable % Al greater than 0.001%. For some applications of the present invention, the inventor has found that it is desirable % Al greater than 0.10%.

Inventor has found that for several applications it is desired having % Al between 0 and 0.35%, normally % Al between 0 and 0.25%, and even % Al between 0.01 and 0.25%.

Inventor has found that for several applications it is desired having % Cu+% Co+% Al+% Ti>0.010%, normally for some applications % Cu+% Co+% Al+% Ti>0.1% and even for some applications % Cu+% Co+% Al+% Ti>0.2%.

Inventor has found that for several applications it is desired having % Cu+% Co+% Al+% Ti between 0.01 and 4%, normally for some applications % Cu+% Co+% Al+% Ti between 0.1 and 3% and even for some applications % Cu+% Co+% Al+% Ti between 0.2 and 3%.

Inventor has found that several applications beneficiates from having % V+% Al+% Ti>0.001%, normally for some applications % V+% Al+% Ti>0.01 and even for some applications % V+% Al+% Ti>0.1.

Inventor has found that several applications beneficiates from having % V+% Al+% Ti between 0.001 and 4%, normally for some applications % V+% Al+% Ti between 0.01 and 3% and even for some applications % V+% Al+% Ti between 0.1 and 3%.

Inventor has found that for some compositions the sum of % Gd+% Nd+% Sm+% Y+% Pr+% Sc+% Pm+% Eu+% Tb+% Dy+% Ho+% Er+% Tm+% Yb+% Lu can favor morphology of certain inclusions. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu greater than 0.2%. But often the sum of % Gd+% Nd+% Sm+% Y+% Pr+% Sc+% Pm+% Eu+% Tb+% Dy+% Ho+% Er+% Tm+% Yb+% Lu has a negative effect on toughness. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu less than 0.04%. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu less than 0.008%. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu being absent.

Inventor has found that for some applications of the present invention % Al, % Ti, % Ta, % Zr, % Hf, % Nb, % Cu, % Co, % La, % Ce, and % Cs has a negative impact on toughness.

For some applications of the present invention the inventor has found that it is desirable % Al, % Ti, % Ta, % Zr, % Hf, % Nb, % Cu, % Co, % La, % Ce, and % Cs less than 0.38%. For some applications of the present invention the inventor has found that it is desirable % Al, % Ti, % Ta, % Zr, % Hf, % Nb, % Cu, % Co, % La, % Ce, and % Cs less than 0.18%. For some applications of the present invention the inventor has found that it is desirable % Al, % Ti, % Ta, % Zr, % Hf, % Nb, % Cu, % Co, % La, % Ce, and % Cs less than 0.08%. For some applications of the present invention the inventor has found that it is desirable any of % Al, % Ti, % Ta, % Zr, % Hf, % Nb, % Cu, % Co, % La, % Ce, and % Cs being absent and even all of them absent from the steel composition.

Inventor has found that several applications beneficiates from having % Zr+% Hf+% Ta+% Nb>0.001%, normally for some applications % Zr+% Hf+% Ta+% Nb>0.010% and even for some applications % Zr+% Hf+% Ta+% Nb>0.1%.

Inventor has found that several applications beneficiates from having % Zr+% Hf+% Ta+% Nb between 0.001 and 4%, normally for some applications % Zr+% Hf+% Ta+% Nb between 0.01 and 3% and even for some applications % Zr+% Hf+% Ta+% Nb between 0.1 and 3%.

The steels of the above composition have a fracture toughness at room temperature greater than 51 MPa·√m after applying to a piece with a thickness of 350 mm, a heat treatment comprising austenizing at a temperature above 1020° C., then applying a minimum of three tempering cycles to the piece, wherein at least one tempering is made at a temperature above 520° C., wherein the steels obtained have a hardness of 42-44 HRc.

The inventor has found, that in an embodiment of the present aspect of the invention it is possible to select the validity composition within the range for some applications involving heavy sections with a simple dilatometric experiment. A dilatometer with a reproducibility and accuracy better than 0.005% and a length increase resolution of 5 nm or better and capable of implementing a constant cooling with temperature deviations not surpassing 5° C. is desirable. The experiment consists on austenitizing a sample of the candidate material at 1030° C. for at least 20 minutes and cooling at a constant cooling rate of 3K/min to 100° C.

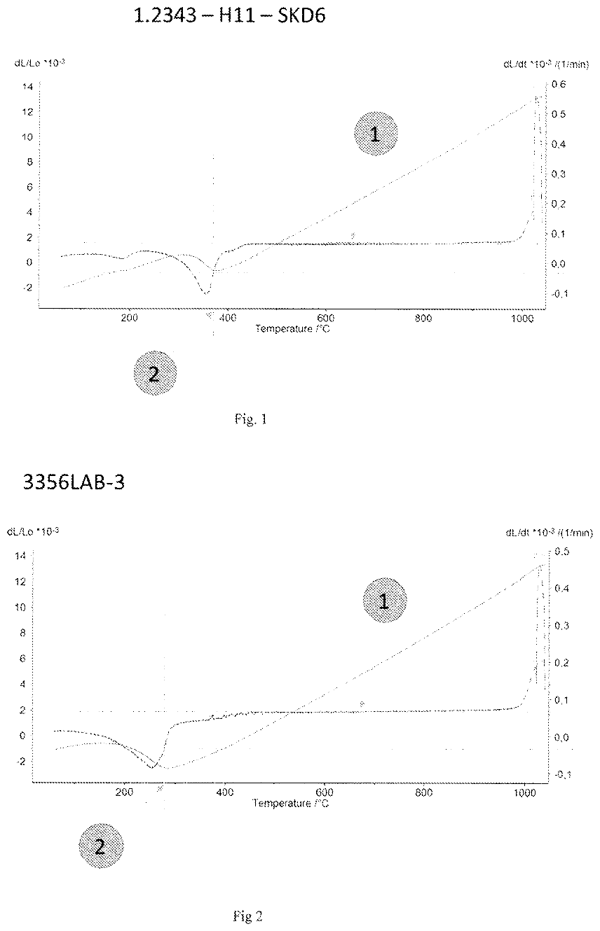

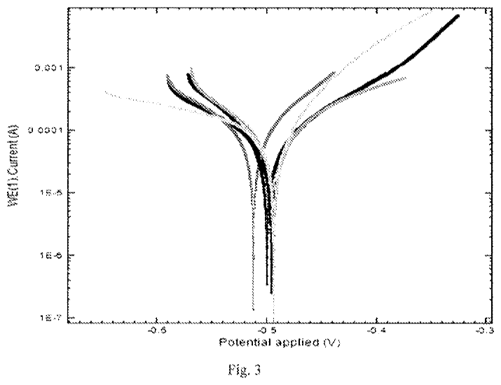

A plot is made of the d(dL/L)/dt (increment of length increase normalized with length divided by increment of time) vs. temperature during cooling and looking at temperatures below 600° C. the curve is quite horizontal and suffers a sudden drop at a certain temperature TD. (see FIGS. 1-2: 1—curve plot and 2—example of TD value) For some embodiments TD is the temperature at which a drop of 0.5*10⁻⁴ min⁻¹ takes place. For some embodiments TD is the temperature at which a drop of 1*10⁻⁴ min⁻¹ takes place. For some embodiments TD is the temperature at which a drop of 1.5*10⁻⁴ min⁻¹ takes place. For some embodiments TD is the temperature at which a drop of 2*10⁻⁴ min⁻¹ takes place. For some embodiments the steel composition and thermomechanical treatment is valid if TD is 360° C. or less. For some embodiments the steel composition and thermomechanical treatment is valid if TD is 340° C. or less. For some embodiments the steel composition and thermomechanical treatment is valid if TD is 318° C. or less. For some embodiments the steel composition and thermomechanical treatment is valid if TD is 290° C. or less. For some embodiments the steel composition and thermomechanical treatment is valid if TD is 2740° C. or less. For some embodiments the steel composition and thermomechanical treatment is valid if TD is 260° C. or less. For some embodiments the steel composition and thermomechanical treatment is valid if TD is 230° C. or less.

Any of the above-described applications corresponds with different embodiments of the steel composition and can be combined with any other embodiment herein described in any combination, to the extent that the respective features are not incompatible.

Another aspect of the present invention refers to steels having high toughness and high thermal conductivity even for high thickness

As mentioned, to achieve high hardenability on hot work tool materials is possible, but achieving high toughness when high thicknesses are hardened is another history. When besides high thermal conductivity is required, the concern may seems impossible. Inventor has found that it is surprisingly possible if the correct alloying strategy and thermos-mechanical treatment is chosen. This is possible in the following compositional range:

| | | | |
|---|---|---|---|
| % Ceq = 0.18-1.9 | % C = 0.18-1.9 | % N = 0-0.1 | % B = 0-0.1 |
| % Cr < 2.6% | % Ni = 0-3 | % Si < 0.48% | % Mn = 1.2-5.8 |
| % Al = 0-0.4 | % Mo = 1.2-6.4 | % W = 0-7.8 | % Ti = 0-2 |
| % Ta = 0-0.3 | % Zr = 0-0.4 | % Hf = 0-0.3 | % V = 0-1.4 |
| % Nb = 0-0.6 | % Cu = 0-1.2 | % Co = 0-2.9 | % Moeq = 1.2-6.4 |
| % La = 0-0.2 | % Ce = 0-0.2 | % Cs = 0-0.2 | |

the rest consisting of iron and trace elements, wherein,

% Ceq=% C+0.86*% N+1.2*% B, and

% Moeq=% Mo+2. % W,

wherein

% Se+% Te+% S+% P+% As+% Pb+% Sb+% Sn=0-0.1%; and

% Gd+% Nd+% Sm+% Y+% Pr+% Sc+% Pm+% Eu+% Tb+% Dy+% Ho++% Er+% Tm+% Yb+% Lu=0-0.5%

In another aspect, the invention refers to a steel having the above composition having high levels of toughness properties even for large cross-sections. In an embodiment the steel of the above composition is a hot work steel. In an embodiment the steel of the above composition is a hot work tool steel. In an embodiment the steel of the above composition is at least partially martensitic. In another embodiment the steel of the above composition is at least partially bainitic.

In the meaning of this text, trace elements refer to any element, otherwise indicated, in a quantity less than 2%. For some applications, trace elements are preferable to be less than 1.4%, more preferable less than 0.9% and sometimes even more preferable to be less than 0.78%. Possible elements considered to be trace elements are H, Li, Na, K, Rb, Fr, Be, Mg, Ca, Sr, Ba, Ra, Ac, Tc, Re, Ru, Os, Rh, Ir, Pd, Pt, Ag, Au, Zn, Cd, Hg, B, Ga, In, Tl, Ge, Sn, Pb, P, As, Sb, Bi, O, S, Se, Te, Po, F, Cl, Br, I, At, He, Ne, Ar, Kr, Xe, Rn, Th, Pa, U, Np, Pu, Am, Cm, Bk, Cf, Es, Fm, Md, No and Lr alone and/or in combination. For some applications, some trace elements or even trace elements in general can be quite detrimental for a particular relevant property (like it can be the case sometimes for thermal conductivity and toughness). For such applications it is desirable to keep trace elements below a 0.4%, preferably below a 0.2%, more preferably below 0.14% or even below 0.06%. Needless to say being below a certain quantity includes also the absence of the element. In many applications, the absence of most of the trace elements or even all of them is obvious and/or desirable. As mentioned every trace element is considered a single entity and thus very often for a given application different trace elements will have different maximum weight percent admissible values. Trace elements can be added intentionally to search for a particular functionality including also cost reduction or its presence (when present) can be unintentional and related mostly to impurity of the alloying elements and scraps used for the production of the alloy. The reason for the presence of different trace elements can be different for one same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

Inventor has found that for certain applications it is desired several trace elements being absent from the composition, such any of Ca, P and/or S. For certain applications Ca is preferred not being present in the steel composition as a trace element. For certain applications P is preferred not being present in the steel composition as a trace element. For certain applications S is preferred not being present in the steel composition as a trace element.

For some applications, inventor has found that Ti, Ta, Zr, Hf, Nb, La, Ce, Cs are optional elements in the composition of the steel, and in some applications any of them and/or all of them may be absent from the composition.

Inventor has found that for several applications, it may be desired having % Ti+% Ta+% Zr+% Hf+% Nb+% La+% Ce+% Cs=0-4.2%.

Inventor has found that for several applications, it may be desired having % Ti+% Ta+% Zr+% Hf+% Nb+% La+% Ce+% Cs=0-3.7%.

Inventor has found that for several applications, it may be desired having % Ta+% Zr+% Hf+% Nb+% La+% Ce+% Cs=0-2.2.

Inventor has found that for several applications, it may be desired having % Ti+% Ta+% Zr+% Hf+% Nb+% La+% Ce+% Cs above 0.001%, normally for some applications % Ti+% Ta+% Zr+% Hf+% Nb+% La+% Ce+% Cs above 0.01%, and even for some applications % Ti+% Ta+% Zr+% Hf+% Nb+% La+% Ce+% Cs above 0.10%.

Inventor has found that for several applications, it may be desired having % Ta+% Zr+% Hf+% Nb+% La+% Ce+% Cs=0.001-2.2%.

Carbon equivalent is important and of great importance in determining the majority of relevant properties. When high mechanical resistance at high temperatures is required the % Ceq cannot be too low. For some applications of the present invention, the inventor has found that it is desirable % Ceq greater than 0.26%. For some applications of the present invention, the inventor has found that it is desirable % Ceq greater than 0.31%. For some applications of the present invention, the inventor has found that it is desirable % Ceq greater than 0.41%. When high toughness and/or elongation is required It is often desirable % Ceq not being too high. For some applications of the present invention the inventor has found that it is desirable % Ceq less than 1.4%. For some applications of the present invention the inventor has found that it is desirable % Ceq less than 0.8%. For some applications of the present invention the inventor has found that it is desirable % Ceq less than 0.44%. For some applications of the present invention the inventor has found that it is desirable % Ceq less than 0.39%. For some applications of the present invention the inventor has found that it is desirable % Ceq less than 0.34%.

Inventor has found that for several applications it is desired having % Ceq between 0.31 and 0.59%, normally % Ceq between 0.28 and 0.59%, and even % Ceq between 0.31 and 0.39%.

Within the carbon equivalent, often the % C has great importance. When mechanical resistance at high temperatures is required, % C cannot be too low. For some applications of the present invention, the inventor has found that it is desirable % C greater than 0.26%.

For some applications of the present invention, the inventor has found that it is desirable % C greater than 0.31%. For some applications of the present invention, the inventor has found that it is desirable % C greater than 0.41%. When high toughness and/or elongation is required It is often desirable % C not being too high. For some applications of the present invention the inventor has found that it is desirable % C less than 1.4%. For some applications of the present invention the inventor has found that it is desirable % C less than 0.8%. For some applications of the present invention the inventor has found that it is desirable % Ceq less than 0.44%. For some applications of the present invention the inventor has found that it is desirable % C less than 0.39%. For some applications of the present invention the inventor has found that it is desirable % Ceq less than 0.34%.

Inventor has found that for several applications it is desired having % C between 0.31 and 0.59%, normally % C between 0.28 and 0.59%, and even % C between 0.31 and 0.39%.

Sometimes within the carbon equivalent, it is desired % N content not being excessive. For some applications of the present invention the inventor has found that it is desirable % N less than 0.09%. For some applications of the present invention the inventor has found that it is desirable % N less than 0.004%. For some applications of the present invention the inventor has found that it is desirable % N being absent. For some applications of the present invention % N can help to improve hardenability. For some applications of the present invention, the inventor has found that it is desirable % N greater than 0.06%. For some applications of the present invention, the inventor has found that it is desirable % N greater than 0.11%.

Sometimes within the carbon equivalent, it is desired % B content not being excessive. For some applications of the present invention the inventor has found that it is desirable % B less than 0.03%. For some applications of the present invention the inventor has found that it is desirable % B less than 0.019%. For some applications of the present invention the inventor has found that it is desirable % B less than 0.009%. For some applications of the present invention the inventor has found that it is desirable % B being absent. For some applications of the present invention % B can help to improve hardenability, especially retarding ferritic transformation. For some applications of the present invention, the inventor has found that it is desirable % B greater than 0.002%. For some applications of the present invention, the inventor has found that it is desirable % B greater than 0.0042%.

For some applications of the present invention, the inventor has found that it is desirable % B greater than 0.006%.

Chromium content is important and has a great importance in determining the majority of relevant properties. When corrosion resistance is required % Cr cannot be too low. For some applications of the present invention, the inventor has found that it is desirable % Cr greater than 0.6%. For some applications of the present invention, the inventor has found that it is desirable % Cr greater than 1.2%. For some applications of the present invention, the inventor has found that it is desirable % Cr greater than 2.10%. When high toughness and/or elongation and/or resistance to temper and/or high thermal conductivity is required often is desired % Cr not being too high. This is further the case when the presence of other carbide formers like % V, % Mo and/or % W is high. For some applications of the present invention the inventor has found that it is desirable % Cr less than 1.9%. For some applications of the present invention the inventor has found that it is desirable % Cr less than 0.9%. For some applications of the present invention the inventor has found that it is desirable % Cr less than 0.78%. For some applications of the present invention the inventor has found that it is desirable % Cr less than 0.4%. For some applications of the present invention the inventor has found that it is desirable % Cr less than 0.09%. For some applications of the present invention the inventor has found that it is desirable % Cr being absent from the composition.

Inventor has found that for several applications it is desired having % Cr between 0 and 1.9%, normally % Cr between 0 and 0.9%, and even % Cr between 0.01 and 0.4%.

Manganese content is essential in this section of the present invention. Inventor has found that surprisingly from a specific content of % Mn the materials of the present invention have high toughness even when pieces of high thickness are treated. This is not a gradual effect, but for % Mn too low is not given, and is given from certain % Mn content. The critical content depends on the specific quantities of the other elements in the alloy. For some applications of the present invention, the inventor has found that it is desirable % Mn greater than 1.4%. For some applications of the present invention, the inventor has found that it is desirable % Mn greater than 1.8%. For some applications of the present invention, the inventor has found that it is desirable % Mn greater than 2.10%. For some applications of the present invention, the inventor has found that it is desirable % Mn greater than 2.6%. For some applications of the present invention, the inventor has found that it is desirable % Mn greater than 3.1%. For some applications of the present invention, the inventor has found that it is desirable % Mn greater than 3.6%. An excessive content of % Mn, and depending on the quantities of other elements in the alloy, has been found that can negatively affect the ease of machining of the steel. For some applications of the present invention the inventor has found that it is desirable % Mn less than 4.8%. For some applications of the present invention the inventor has found that it is desirable % Mn less than 4.4%. For some applications of the present invention the inventor has found that it is desirable % Mn less than 3.9%.

Inventor has found that for several applications it is desired having a minimum % Mn of 1.7%, in some application it is desired having % Mn between 2.2 and 4.9%, normally for some application % Mn between 2.9 and 4.1%, and even % Mn between 3.1 and 3.9%.

Inventor has found that the particular effect of % Mn can be partially replaced by % B and/or % Ni. For some applications of the present invention the inventor has found that it is desirable the simultaneous presence of % Mn and % Ni in the in the amounts described in the present invention. For some applications of the present invention the inventor has found that it is desirable the simultaneous presence of % Mn, % B and % Ni in the amounts described in the present invention. In fact, inventor has found that if % B is not present in sufficient amount (values reported in this document) and % Ni either, then the presence of % Mn is mandatory.

Nickel content is important and has a great importance, in particular its influence in hardenability and also its substitutive effect of % Mn on their peculiar effect identified in the present invention. For some applications of the present invention, the inventor has found that it is desirable % Ni greater than 0.25%. For some applications of the present invention, the inventor has found that it is desirable % Ni greater than 0.32%. For some applications of the present invention, the inventor has found that it is desirable % Ni greater than 0.52%.

When high toughness is required, especially at high temperature, often it is desired % Ni not being too high. For some applications of the present invention the inventor has found that it is desirable % Ni less than 1.8%. For some applications of the present invention the inventor has found that it is desirable % Ni less than 0.78%. For some applications of the present invention the inventor has found that it is desirable % Ni less than 0.49%. For some applications of the present invention the inventor has found that it is desirable % Ni being absent from the composition.

For some applications of the present invention the inventor has found that it is desirable % Ni being absent from the composition. Inventor has found that for several applications, when % Ni and % B are absent from the composition it is desired having % Mn>0.1. For certain applications when % Ni and % B are absent from the composition it is desired having % Mn>1.6 and even in some applications % Mn>2.6.

Inventor has found that for several applications it is desired having % Ni between 0 and 2.8%, normally % Ni between 0 and 2.6%, and even % Ni between 0.1 and 2.6%.

Inventor has found that if the contain in % Cr+% B+% Ni is too low, then % Mo contain may be absent. For some applications of the present invention, the inventor has found that it is desirable that if % Cr+% B+% Ni<0.7, then % Mn>2.2. For some applications of the present invention, the inventor has found that it is desirable that if % Cr+% B+% Ni<0.6, then % Mn>2.3. For some applications of the present invention, the inventor has found that it is desirable that if % Cr+% B+% Ni<0.7, then % Mn>2.1.

Inventor has found than for some compositions, % Si neutralizes the surprising and positive effect of the present invention, negatively affecting the obtainable values of toughness for high thicknesses. For some applications of the present invention the inventor has found that it is desirable % Si less than 0.4%. For some applications of the present invention the inventor has found that it is desirable % Si less than 0.18%. For some applications of the present invention the inventor has found that it is desirable % Si less than 0.08%. For some applications of the present invention the inventor has found that it is desirable % Si less than 0.04%. For some applications of the present invention the inventor has found that it is desirable % Si being absent from the composition.

Inventor has found that for several applications a low Si content is preferred, for these applications it is desired having % Si between 0 and 0.39%, normally % Si between 0.001 and 0.23%, and even % Si between 0.001 and 0.1%.

Inventor has found that for some compositions the sum of % Se+% Te+% As+% Pb+% Sb+% Sn can favor machining. For some applications of the present invention, the inventor has found that it is desirable further include in the steel composition % Se+% Te+% As+% Pb+% Sb+% Sn greater than 0.052%. But often the sum % Se+% Te+% As+% Pb+% Sb+% Sn has a negative effect on the steels of the present invention especially when % Mn is high and can disrupt the positive effect of a high % Mn. For some applications of the present invention, the inventor has found that it is desirable % Se+% Te+% As+% Pb+% Sb+% Sn less than 0.19%. For some applications of the present invention, the inventor has found that it is desirable % Se+% Te+% As+% Pb+% Sb+% Sn less than 0.09%. For some applications of the present invention, the inventor has found that it is desirable % Se+% Te+% As+% Pb+% Sb+% Sn less than 0.04%. For some applications of the present invention, the inventor has found that it is desirable % Se+% Te+% As+% Pb+% Sb+% Sn less than 0.008%. For some applications of the present invention, the inventor has found that it is desirable % Se+% Te+% As+% Pb+% Sb+% Sn being absent.

Inventor has found that for some compositions the sum of % As+% Sb+% Sn can favor machining. For some applications of the present invention, the inventor has found that it is desirable further include in the steel composition % As+% % Sb+% Sn greater than 0.052%.

But often the sum % As+% Sb+% Sn has a negative effect on the steels of the present invention especially when % Mn is high and can disrupt the positive effect of a high % Mn.

For some applications of the present invention, the inventor has found that it is desirable % As+% Sb+% Sn less than 0.19%. For some applications of the present invention, the inventor has found that it is desirable % As+% Sb+% Sn less than 0.09%. For some applications of the present invention, the inventor has found that it is desirable % As+% Sb+% Sn less than 0.04%. For some applications of the present invention, the inventor has found that it is desirable % As+% Sb+% Sn less than 0.008%. For some applications of the present invention, the inventor has found that it is desirable % As+% Sb+% Sn being absent.

Inventor has found that for some compositions the sum of % Se+% Te can favor machining.

For some applications of the present invention, the inventor has found that it is desirable further include in the steel composition % Se+% Te greater than 0.052%. But often the sum % Se+% Te has a negative effect on the steels of the present invention especially when % Mn is high and can disrupt the positive effect of a high % Mn. For some applications of the present invention, the inventor has found that it is desirable % Se+% Te less than 0.19%.

For some applications of the present invention, the inventor has found that it is desirable % Se+% Te less than 0.09%. For some applications of the present invention, the inventor has found that it is desirable % Se+% Te less than 0.04%. For some applications of the present invention, the inventor has found that it is desirable % Se+% Te less than 0.008%.

For some applications of the present invention, the inventor has found that it is desirable % Se+% Te being absent.

For some applications of the present invention, the inventor has found that % P+% S are further contained in the steel composition. Inventor has found that for some compositions % P+% S have a negative effect on the steels of the present invention especially when % Mn is high and can disrupt the positive effect of a high % Mn. For some applications of the present invention the inventor has found that it is desirable % P+% S less than 0.028%. For some applications of the present invention the inventor has found that it is desirable % P+% S less than 0.018%. For some applications of the present invention the inventor has found that it is desirable % P+% S less than 0.008%. For some applications of the present invention the inventor has found that it is desirable % P+% S less than 0.0004%. For some applications of the present invention the inventor has found that it is desirable % P+% S being absent from the composition.

For some applications of the present invention, the inventor has found that P is further contained in the steel composition. Inventor has found that for some compositions % P has a negative effect on the steels of the present invention especially when % Mn is high and can disrupt the positive effect of a high % Mn. For some applications of the present invention the inventor has found that it is desirable % P less than 0.028%. For some applications of the present invention the inventor has found that it is desirable % P less than 0.018%. For some applications of the present invention the inventor has found that it is desirable % P less than 0.008%. For some applications of the present invention the inventor has found that it is desirable % P less than 0.0008%. For some applications of the present invention the inventor has found that it is desirable % P being absent from the composition.

For some applications of the present invention, the inventor has found that S is further contained in the steel composition. Inventor has found that for some compositions % S has a negative effect on the steels of the present invention especially when % Mn is high and can disrupt the positive effect of a high % Mn. For some applications of the present invention the inventor has found that it is desirable % S less than 0.018%. For some applications of the present invention the inventor has found that it is desirable % S less than 0.008%. For some applications of the present invention the inventor has found that it is desirable % S less than 0.0008%. For some applications of the present invention the inventor has found that it is desirable % S less than 0.0004%. For some applications of the present invention the inventor has found that it is desirable % S being absent from the composition.

For some applications of the present invention, the inventor has found that O is further contained in the steel composition. Inventor has found that for some compositions % O has a negative effect on toughness. For some applications of the present invention the inventor has found that it is desirable % O less than 14 ppm. For some applications of the present invention the inventor has found that it is desirable % O less than 9 ppm. For some applications of the present invention the inventor has found that it is desirable % O less than 6 ppm. For some applications of the present invention the inventor has found that it is desirable % O less than 4 ppm. For some applications of the present invention the inventor has found that it is desirable % O being absent from the composition.

For some applications of the present invention, the inventor has found that H2 is further contained in the steel composition. Inventor has found that for some compositions % H2 has a negative effect on toughness. For some applications of the present invention the inventor has found that it is desirable % H2 less than 1.8 ppm. For some applications of the present invention the inventor has found that it is desirable % H2 less than 0.9 ppm. For some applications of the present invention the inventor has found that it is desirable % H2 less than 0.4 ppm. For some applications of the present invention the inventor has found that it is desirable % H2 less than 0.08 ppm. For some applications of the present invention the inventor has found that it is desirable % H₂ being absent from the composition.

Molybdenum content is important and has a great importance in determination of the majority of relevant properties, since its presence in secondary carbides is almost always of great influence. When resistance to temper is required molybdenum cannot be too low.

For some applications of the present invention, the inventor has found that it is desirable % Mo greater than 1.6%. For some applications of the present invention, the inventor has found that it is desirable % Mo greater than 2.1%. For some applications of the present invention, the inventor has found that it is desirable % Mo greater than 3.1%. When high wear resistance is required even higher % Mo contents are desired. For some applications of the present invention, the inventor has found that it is desirable % Mo greater than 3.6%.

For some applications of the present invention, the inventor has found that it is desirable % Mo greater than 4.1%. For some applications of the present invention, the inventor has found that it is desirable % Mo greater than 4.6%. When high toughness and/or elongation is required often is desired % Mo not too high. This is also the case when the presence of other carbide builders like % V, % Cr, and/or % W is high. For some applications of the present invention the inventor has found that it is desirable % Mo less than 5.4%. For some applications of the present invention the inventor has found that it is desirable % Mo less than 4.8%. For some applications of the present invention the inventor has found that it is desirable % Mo less than 4.4%. For some applications of the present invention the inventor has found that it is desirable % Mo less than 3.9%. For some applications of the present invention the inventor has found that it is desirable % Mo less than 2.9%.

Inventor has found that for several applications it is desired having a minimum % Mo of 1.4%, in some application it is desired having % Mo between 1.6 and 5.3%, normally for some application % Mn between 2.2 and 4.8%, and even % Mo between 3.1 and 3.9%.

Inventor has found that for some applications of the present invention % Mo can be partially replaced by double the amount, in weight of % W. Also for some applications, what is described for % Mo in the preceding paragraph applies for % W but the contents expressed must be double. In this sense it is also interesting the % Moeq concept, for the cases of partial substitution, wherein % Moeq=% Mo+½% W. The desired contents for % Moeq follow the above about % Mo. For some applications the replacement of % Mo by % W is not desirable. For some applications of the present invention inventor has found that is desired % W less than 0.8%. For some applications of the present invention inventor has found that is desired % W being absent.

Inventor has found that for several applications it is desired having % W between 0 and 4.1%, normally % W between 0 and 2.9%, and even % W between 0.001 and 2.9%.

Inventor has found that for several applications it is desired having % Moeq between 0.1 and 3.9%, normally % Moeq between 0.18 and 3.9%, and even % Moeq between 0.8 and 2.8%.

Vanadium content is important and has a great importance in determination of the majority of relevant properties, since its presence in secondary carbides is almost always of great influence. When hot hardness is required % V cannot be too low. For some applications of the present invention, the inventor has found that it is desirable % V greater than 0.22%.

For some applications of the present invention, the inventor has found that it is desirable % V greater than 0.32%. For some applications of the present invention, the inventor has found that it is desirable % V greater than 0.55%. For some applications of the present invention, the inventor has found that it is desirable % V greater than 0.85%. When high toughness and/or elongation is required often it is desired % V not being too high. This is also the case when the presence of other carbide formers like % Mo, % Cr and/or % W is high. For some applications of the present invention the inventor has found that it is desirable % V less than 1.8%. For some applications of the present invention the inventor has found that it is desirable % V less than 1.2%. For some applications of the present invention the inventor has found that it is desirable % V less than 0.8%. For some applications of the present invention the inventor has found that it is desirable % V less than 0.4%. For some applications of the present invention the inventor has found that it is desirable % V less than 0.09%. For some applications of the present invention the inventor has found that it is desirable % V being absent.

In some application it is desired having % V between 0 and 1.2%, normally for some application % V between 0 and 0.49%, and even % V between 0 and 0.1%. Inventor has found that for several applications it is desired having a minimum % V of 0.01%.

Sometimes it is desired % Ti content not being excessive. For some applications of the present invention the inventor has found that it is desirable % Ti less than 1.8%. For some applications of the present invention the inventor has found that it is desirable % Ti less than 1.3%. For some applications of the present invention the inventor has found that it is desirable % Ti being absent. For some applications of the present invention % Ti can help to improve the properties of the steel. For some applications of the present invention, the inventor has found that it is desirable % Ti greater than 0.001%. For some applications of the present invention, the inventor has found that it is desirable % Ti greater than 0.1%.

Inventor has found that for several applications it is desired having % Ti between 0 and 1.6%, normally % Ti between 0 and 0.9%, and even % Ti between 0.3 and 0.1%.

Sometimes it is desired % Co content not being excessive. For some applications of the present invention the inventor has found that it is desirable % Co less than 2.3%. For some applications of the present invention the inventor has found that it is desirable % Co less than 1.2%. For some applications of the present invention the inventor has found that it is desirable % Co being absent. For some applications of the present invention % Co can help to improve the properties of the steel. For some applications of the present invention, the inventor has found that it is desirable % Co greater than 0.001%. For some applications of the present invention, the inventor has found that it is desirable % Co greater than 0.1%.

Inventor has found that for several applications it is desired having % Co between 0 and 2.1%, normally % Co between 0 and 1.7%, and even % Co between 0.01 and 1.3%.

Sometimes it is desired % Cu content not being excessive. For some applications of the present invention the inventor has found that it is desirable % Cu less than 1.1%. For some applications of the present invention the inventor has found that it is desirable % Cu less than 0.4%. For some applications of the present invention the inventor has found that it is desirable % Cu being absent. For some applications of the present invention % Cu can help to improve the properties of the steel. For some applications of the present invention, the inventor has found that it is desirable % Cu greater than 0.001%. For some applications of the present invention, the inventor has found that it is desirable % Cu greater than 0.1%.

Inventor has found that for several applications it is desired having % Cu between 0 and 0.9%, normally % Cu between 0 and 0.7%, and even % Cu between 0.01 and 0.6%.

Sometimes it is desired % Al content not being excessive. For some applications of the present invention the inventor has found that it is desirable % Al less than 0.35%. For some applications of the present invention the inventor has found that it is desirable % Al less than 0.2%. For some applications of the present invention the inventor has found that it is desirable % Al being absent. For some applications of the present invention % Al can help to improve the properties of the steel. For some applications of the present invention, the inventor has found that it is desirable % Al greater than 0.001%. For some applications of the present invention, the inventor has found that it is desirable % Al greater than 0.10%.

Inventor has found that for several applications it is desired having % Al between 0 and 0.35%, normally % Al between 0 and 0.25%, and even % Al between 0.01 and 0.25%.

Inventor has found that for several applications it is desired having % Cu+% Co+% Al+% Ti>0.010%, normally for some applications % Cu+% Co+% Al+% Ti>0.1% and even for some applications % Cu+% Co+% Al+% Ti>0.2%.

Inventor has found that several applications beneficiates from having % V+% Al+% Ti>0.0010%, normally for some applications % V+% Al+% Ti>0.010% and even for some applications % V+% Al+% Ti>0.1%.

Inventor has found that for some compositions the sum of % Gd+% Nd+% Sm+% Y+% Pr+% Sc+% Pm+% Eu+% Tb+% Dy+% Ho+% Er+% Tm+% Yb+% Lu can favor morphology of certain inclusions. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu greater than 0.2%. But often the sum of % Gd+% Nd+% Sm+% Y+% Pr+% Sc+% Pm+% Eu+% Tb+% Dy+% Ho+% Er+% Tm+% Yb+% Lu has a negative effect on toughness. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu less than 0.04%. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu less than 0.008%. For some applications of the present invention the inventor has found that it is desirable % Gd+% Nd+% Sm+% Y+% Pr+% Sc+% Pm+% Eu+% Tb+% Dy+% Ho+% Er+% Tm+% Yb+% Lu being absent.

Inventor has found that for some applications of the present invention % Al, % Ti, % Ta, % Zr, % Hf, % Nb, % Cu, % Co, % La, % Ce, and % Cs has a negative impact on toughness.

For some applications of the present invention the inventor has found that it is desirable % Al, % Ti, % Ta, % Zr, % Hf, % Nb, % Cu, % Co, % La, % Ce, and % Cs less than 0.38%. For some applications of the present invention the inventor has found that it is desirable % Al, % Ti, % Ta, % Zr, % Hf, % Nb, % Cu, % Co, % La, % Ce, and % Cs less than 0.18%. For some applications of the present invention the inventor has found that it is desirable % Al, % Ti, % Ta, % Zr, % Hf, % Nb, % Cu, % Co, % La, % Ce, and % Cs less than 0.08%. For some applications of the present invention the inventor has found that it is desirable % Al, % Ti, % Ta, % Zr, % Hf, % Nb, % Cu, % Co, % La, % Ce, and % Cs being absent.

The inventor has found, that in an embodiment of the present aspect of the invention it is possible to select the validity composition within the range for some applications involving heavy sections with a simple dilatometric experiment. A dilatometer with a reproducibility and accuracy better than 0.005% and a length increase resolution of 5 nm or better and capable of implementing a constant cooling with temperature deviations not surpassing 5° C. is desirable. The experiment consists on austenitizing a sample of the candidate material at 1030° C. for at least 20 minutes and cooling at a constant cooling rate of 3K/min to 100° C.

A plot is made of the d(dL/L)/dt (increment of length increase normalized with length divided by increment of time) vs. temperature during cooling and looking at temperatures below 600° C. the curve is quite horizontal and suffers a sudden drop at a certain temperature TD. (see FIGS. 1 and 2: 1—curve plot and 2—example of TD value) For some embodiments TD is the temperature at which a drop of 0.5*10⁻⁴ min⁻¹ takes place. For some embodiments TD is the temperature at which a drop of 1*10⁻⁴ min⁻¹ takes place. For some embodiments TD is the temperature at which a drop of 1.5*10⁻⁴ min⁻¹ takes place. For some embodiments TD is the temperature at which a drop of 2*10⁻⁴ min⁻¹ takes place. For some embodiments the steel composition and thermomechanical treatment is valid if TD is 460° C. or less. For some embodiments the steel composition and thermomechanical treatment is valid if TD is 419° C. or less. For some embodiments the steel composition and thermomechanical treatment is valid if TD is 360° C. or less. For some embodiments the steel composition and thermomechanical treatment is valid if TD is 340° C. or less. For some embodiments the steel composition and thermomechanical treatment is valid if TD is 318° C. or less. For some embodiments the steel composition and thermomechanical treatment is valid if TD is 290° C. or less. For some embodiments the steel composition and thermomechanical treatment is valid if TD is 2740° C. or less. For some embodiments the steel composition and thermomechanical treatment is valid if TD is 260° C. or less. For some embodiments the steel composition and thermomechanical treatment is valid if TD is 230° C. or less.

Inventor has found that the effect is even more surprising than it seems at first glance, since for some steels of the invention It is no longer even essential the microstructure being martensitic (tempered martensite) and in fact, not martensitic structures having very high toughness properties can be reached even for high thicknesses. Mainly bainitic structures may result very interesting, especially if hardness after quenching is at least 8 HRc less than the hardness after the tempering of interest. Surprisingly then, bainitic microstructures are very interesting for some embodiments of the present invention (being understood by bainite, any microstructure formed under the traditional ferrite or perlite forming temperature and above traditional martensitic formation temperature. As example, Whitmanstatten ferrite would be considered in this document as bainite).

Tool steels of the present invention may be submitted to any superficial heat treatment (superficial temper, carburation, nitruration, boruration, etc) or a covering (PVD, CVD, TD, thermal spray, cold spray, ionic implantation, liquid batch, electro-chemical, etc) applicable to a AISI H13 steel.

The steels of the above composition have a fracture toughness at room temperature greater than 51 MPa·√m after applying to a piece with a thickness of 350 mm, a heat treatment comprising austenizing at a temperature above 1020° C., then applying a minimum of three tempering cycles to the piece, wherein at least one tempering is made at a temperature above 520° C., wherein the steels obtained have a hardness of 42-44 HRc.

Steels of the present invention are especially beneficial for additive manufacturing of pieces. In this sense, it is often interesting the manufacturing of the steel of the present invention in powder form.

Steels of the present invention are especially interesting for the manufacture of big tools or dies for applications having high thermos-mechanical solicitations. Traditional applications are: aluminium die casting (by gravity on the shell, at low pressure, at high pressure, in presence of solid phase (thixo)), heavy alloy injection like cooper, brass or bronze.

Extrusion of any kind if alloy. Forge in open die or close die. Further polymer former (either thermo plastic or thermos stable). Hot stamping. Sheet hot stamping. Super plastic deformation of sheets or other components of small thicknesses. And much more.

Another aspect of the invention refers to a method for the manufacture of a hot work tool, In a embodiment the invention refers to a method for the manufacture of a hot work tool having a thickness exceeding 303 mm.

The method comprising the following steps: Selecting a hot work tool steel of any of the above disclosed compositions.

Optionally apply one or several machining steps and/or heat treatments below the austenization temperature of the material. (also including cryogenic treatments) Apply a temper consisting on at least a partial austenization at a temperature above 980° C.

Optionally apply one or several machining steps and/or heat treatments below the austenization temperature of the material. (also including cryogenic treatments)

Tempering the material at least once at a temperature above 520° C.

Optionally apply one or several machining steps and/or heat treatments below the austenization temperature of the material. (also including cryogenic treatments) and/or apply surface treatments or coatings.

obtaining a hardness greater than 40 HRc and a fracture toughness at room temperature greater than 51 MPa·√m.

In another aspect, the invention relates to a method for the manufacture of a hot working tool comprising the following steps:
a) providing a tool steel according to any one of previous claims 1 to 6;
b) applying to the tool steel a tempering treatment consisting on at least a partial austenization at a temperature above 980° C.; and
c) tempering the material at least once at a temperature above 520° C.,
   thereby obtaining a hot working tool having a hardness greater than 40 HRc and a fracture toughness at room temperature greater than 51 MPa·√m

Optionally after step b) and before step c) apply one or several machining steps and/or heat treatments below the austenization temperature of the material. (also including cryogenic treatments) Optionally after step c) apply one or several machining steps and/or heat treatments below the austenization temperature of the material. (also including cryogenic treatments) Degradation and failure of structures, machine parts tools and others represent a huge cost.

Materials have been playing a determinant role in the durability of many structures and components for machines tools or others for a long time. Many investigations and inventions have been made of improved materials for certain applications.

In many applications only a few specific property demands are high. Many applications where mechanical requirements are high the environmental, tribological and thermal requirements are easily met. Even within mechanical requirements often when high mechanical strength is required lower levels of fracture toughness are acceptable. With the advancement of technology in the last decades more and more applications require materials which can simultaneously withstand a combination of high mechanical, tribological, environmental and/or thermal loads. For some of those applications also cost should be included as a further fundamental demand on the material, since it is decisive on the applicability.

Iron based alloys or steels exist with very high wear resistance, like the so called High Speed Steels and Supercarburated steels but they often lack the capability of withstanding high thermal and environmental loadings, since they have limited thermal conductivity, quite low tempering resistance and poor environmental resistance to most oxidative and corrosive environments. Hard metal or other metal matrix carbide composites can present better thermal loading capabilities given the higher thermal conductivity and tempering resistance attainable within this family of material but environmental resistance remains poor for many corrosive and oxidative environments and cost make them also not applicable in many instances.

Iron based alloys with very high mechanical strength exist, like the so called Maraging steels, but they have poor wear resistance, limited environmental resistance and limited thermal conductivity.

Several materials have been developed with high environmental resistance against particular environments, examples could be the monel alloys and the stainless steels. In this case the difficulties arise when high tribological loadings are present, and when high thermal conductivity is required. Often enough cost is also a matter for their unsuitability.

Sometimes the thermal loading requires as low a thermal conductivity as possible in a metallic material, for such applications often Ti based alloys are used. They lack wear resistance, oxidation resistance at high temperature and are often disregarded due to the implicated cost.

In the last decades a strong developing effort has taken place in the area of multi-materials to provide for systems that can withstand such complex combinations of simultaneous high demands. But many applications require bulk materials to be the ones presenting such characteristics.

When looking for environmental resistance in steels, there exist a strong tendency to rely on chromium oxide regenerable protective films which imply a high content of chromium (generally above 10% in weight). Unfortunately high chromium contents in steels often mean a drop in the attainable best compromise between mechanical strength and toughness.

Also high chromium contents are often associated to low electrical conductivities and also low thermal conductivities. Also high chromium contents often provide a sticky behavior to the steel which is not very appreciated when metal to metal sliding takes place. Also many interesting magnetic, electric, mechanic and tribological behaviors amongst others cannot be attained when high chromium contents are present in the steel.

Very often the problem is that while the resistance of the material for one of the given high demands is not only satisfactory but well above satisfactory (the excess could be considered superfluous), there are clear short-comings in the other relevant properties for the application.

For this reason bulk materials are needed to withstand high levels of solicitation in a complex loading system comprising at least two of the following: mechanical (mechanical strength, yield strength, fracture toughness . . . ), tribological (adhesive, abrasive, erosive . . . wear), thermal (high thermal conductivity, low thermal conductivity, resistance to softening at high temperatures . . . ) and/or environmental, and especially when the environmental solicitation is significant.

The authors have discovered that the problem to attain steels presenting resistance to certain aggressive environments with the usage of low chromium contents or even no intentional chromium can be attained through a combination of effects, first by providing an iron oxide stabilizer, preferably phosphorus in a high enough amount, and second by providing at least one element capable of developing a strong insoluble oxide. The preferred element to provide the hard oxide are Ti and Al, but it can be partially or totally replaced by Cr, Zr, Ta or even Hf. The choice of the insoluble oxide will normally be performed on the basis of the media to be resisted, since different oxides have different behaviors in different media. The inventor has found that particular good results can be achieved with mixtures of hard insoluble oxide formers to obtain complex oxides. Often a third critical element will be added to control the microstructure . . . like Cu, Ni and/or Mn. The present invention provides resistance against certain aggressive environments to almost any type of steel and steel microstructure, thus very often several other critical elements will be added in the composition to provide for certain characteristics (like for example mechanic, tribologic, electric, magnetic, thermic, nuclear . . . properties). When % C is added in the alloy (same applies for % N and % B) the affinity of this elements for Ti is very strong and once bound, the Ti is not able to form protecting titanium oxide, thus either the level of % Ti has to be increased to take account for this effect or a stronger carbide builder has to be provided to account for the binding % C. Stronger carbide builders than Ti are Zr, Hf and Ta.

In other aspect of the present invention lower levels of % Cr are required or even the absence of Cr is possible while maintaining the environmental resistance against certain atmospheres and medium. This has not only very dramatic cost implications but also very strong effect on the properties attainable together with this environmental resistance. Most state of the art combination of properties are not attainable at the highest level if corrosion resistance has to be provided simultaneously. As a first example, many developments have been taking place in the last years regarding bainitic structures and the outstanding property combinations that are possible with this microstructures. A high level of % Cr eliminates or makes industrially impracticable the bainitic domain in the TTT diagrams.

To attain corrosion resistance with Cr addition, and maintain good mechanical properties, the most widely used solution are the austenitic stainless steels with roughly 18% Cr, 8% Ni and low % C and other interstitials. Such alloying implies a cost which is one order of magnitude higher than the remaining iron. The same or even superior properties can be attained with high strength sheets where the associated alloying cost is often not even as high as the remaining iron. Within the present invention the minimum alloying cost to attain the environmental resistance can be kept within the same order of magnitude as the remaining iron.

The evaluation of the resistance to certain environments is made through electrochemistry.

In the present invention, it has been used a cell of a solution at 5% NaCl, a reference electrode of Ag/AgCl and a scanning rate of 0.16 mV/s. Table 4 of the examples show the different compositions evaluated in comparison with a conventional stainless steel AISI 316 (ex 3.3). FIG. 1 shows the Taffel plot results and Table 5 shows the corrosion rate for the compositions analysed. As it can be seen, all compositions of the present invention attain a similar behavior of corrosion resistance as conventional stainless steel and some of them (examples 3.1 and 3.5) even better. The corrosion resistance has been evaluated by means of a Taffel Plot where the combination of the anodic and cathodic plots permits the direct evaluation of the corrosion rate.

The inventor has made the observation that stabilization of the iron oxide can be used in combination with other harder more stable oxides to provide environmental resistance to several different environments. The key issue of this invention is to make sure that the desired protective oxides form in the surface in the desired manner, for this purpose is of capital importance that the critical elements are present in the desirable form and not another. To illustrate this a counter example can be provided, if % Ti and % Al are present as main protective oxide formers, and the alloy also contents % C and % Ni, and when placed in the aggressive media most % Ti has combined with % C to form Titanium carbides and most % Al has combined with % Ni to form interstitials (NiAl or Ni3Al) and thus are not readily incorporable in the protective oxide film, the alloy will not present the environmental protection characteristics objective of the present invention, despite having an overall composition that would allow to have such protection characteristics due to the natural misplacement of the alloying elements if no special care is taken.

The inventors have made the surprising observation, that once the iron oxide is stabilized a protective oxide layer with another harder more stable oxide is much easier to be build. Starting with the most economic candidates, namely Cr, Al and Ti the inventors have made the following observations: When % C is required for the desired properties to be attained, the inventor has found that special care has to be taken to make sure the available for oxidation Ti is not affected.

Sheets, tubes, bars, parts of any shape, profiles, blocs, tubes, powders, wires, rods . . . .

The inventors have performed immersion tests in deionized water as well as in tap water from Rubi in Spain. Resistance to oxidation at high temperature and resistance to different acid and basic aqueous solutions have also been evaluated,

According to the literature, combining % Ti and % P on a steel is not a very good idea in terms of ductility and toughness. % P is a strong solid solution strength promoter but as efficient in degradation of elongation, especially if other elements are present amongst which % C and % Ti are amongst the most reported ones. So in the present invention it would be directly assumed that elongation and toughness should be a real challenge, and that the alloys of the present invention could only be applied for usages where elongation requirements are exceptionally low. The inventors have made the surprising observation that if certain rules are observed, this is not necessarily the case and even very surprisingly high elongation and toughness values can be attained.

Both % Ti and % P are strong ferrite stabilizing elements; other austenite stabilizers need to be used when austenitic microstructures or microstructures resulting from the decomposition of austenite are desired. As is often the case % C is a strong agent in this purpose, but its presence and concentration will often be fixed by other criteria (like is the case for % N and % B also), so adjustments will often need to be made with other gamma stabilizing elements.

Depending on the nature of the aggressive environment, different oxide formers will be preferred for the formation of the protective layer. The inventor has observed that the preferred oxides are Titanium oxide, Aluminium oxide, Zirconium oxide, Molybdenum/Tungsten oxide, and Chromium oxide. Mixed oxides are also very effective helping overcome some of the particular shortcomings of each of the simple oxides.

Also the colors attainable with each one of the oxides trough anodization or simple passivation (whether trough natural weathering or artificially attained) can be the reason to choose the oxide forming elements.

For applications where the appearance and shine of stainless steel are to be replicated the addition of chromium for the protective oxide formation is desirable. While no practical limitation for the addition of Chromium in the present invention has been observed, obviously the more interesting implementations are those with rather small additions of Chromium.

The inventor has observed that for a sufficient amount of oxide formers, obviously it is the amount that is capable of forming a protective oxide layer, and not the total weight percent, the stabilization of the iron oxide is no longer required. Which quantity is the minimum required so that no iron oxide stabilization is required, depends on the nature of the oxide formers. Not requiring an iron oxide stabilization means far lower amounts of phosphor required, even in some instances its absence or presence at impurity level are feasible. In the cases where Chromium is the main oxide former.

Most tooling applications require high hardness and wear resistance, the main drawback of the Al/Mn alloys. The authors have found that this can be solved by applying some compositional rules and heat treatments. In some cases the applicable heat treatments cannot concisely be described so it is preferable to use compositional rules and microstructural characteristics to define the solution, since luckily the microstructural features are at a microscopic scale. In general high levels of % Ceq are required to provide for the desired hardness and volume fraction of hard particles.

While some applications can do with the ambient resistance of this alloys without the addition of % Al and even % Si, several applications require superior oxidation resistance.

Some applications require a non-magnetic behaviour, such is the case of plastic injection molding where the injected polymer contains magnetic particles. For this applications it is desirable to have at least a 55% of austenite in the “ready to use” microstructure, preferably more than 82% austenite, more preferably more than 93% or even more than 99% (even better the case when 100% is austenite).

For some applications at high temperature it is not only important to avoid deterioration due to ambiental attack but it is also desirable to minimize heat loss. One such application are the so called hot zones in Hot Stamping. In such cases if the tool is made with a material of the present invention, it is very desirable that such material has low thermal conductivity to avoid excessive heat extraction from the manufactured component. To attain low thermal conductivity it is desirable to have low thermal diffusivity, low density and low specific heat. One very interesting alloying element in this respect is Al due to its considerably effect on density. For such purpose % Al above 6.2%, preferably above 7.3%, more preferably above 8.3%, even more preferably above 9.3% or even above 10.4% should be used to have a significant effect on density. To lower the thermal diffusivity it is desirable to avoid high density of states for both phonons and electrons in the carbides and even more important it is necessary to maximize the scattering effects in all phases present. As explained in the referred document, scattering can be increased significantly by the obtaining of structures with defects at the atomic level. Unfortunately such microstructural features are at the sub-nanometric scale (atomic arrangement, regarding the optimization of density of states and mobility of carriers in all phases) and thus when writing the application, the applicant referring to the Guidelines C-11, 4.11 (nowadays Guidelines 2012, Part F, Chapter IV, point 4.11, “Parameters”) realized that almost all parameters (available) to describe this structural feature in the sub-nanometric scale are unusual parameters and that would be prima facie objectionable on grounds of lack of clarity. The sole exception for unequivocally describe mentioned structural feature in the sub-nanometric scale is thermal conductivity and therefore this parameter is chosen to reasonably describe the structural feature. In the present invention, and for the applications yet described, the inventor has found that it is necessary to use structures characterized by a thermal conductivity of 10 W/mK or less, preferably 7.34 W/mK or less, more preferably 6.81 W/Mk or les and even more preferably 5.4 W/Mk or less. The inventor has found that the key for a low thermal conductivity in these kind of alloys is to have a low thermal diffusivity, and in a second instance a low density. The heat capacity has the same influence and although it is recommendable to minimize it as much as possible, the significance for the alloys of the present invention has been seen as much less. For the present invention thermal diffusivities of 3.5 mm2/s or less, preferably 2.6 mm2/s, more preferably less than 1.74 mm2/s and even more preferably less than 1.46 mm2/s; for some applications even less than 0.98 mm2/s. When it comes to density, values of 6.47 gr/cm or less, preferably 5.21 gr/cm3 or less, more preferably 4.41 gr/cm3 or less and even more preferably 3.74 gr/cm3 or less. With such great amounts of % Al and % C attaining a sufficient toughness is quite a challenge. Some applications are possible with even very low levels of toughness and thus no special care has to be taken. Other applications require higher levels of toughness; here the inventor has found two possible approaches that can be used simultaneously or independently: composition strategy and microstructural strategy. The composition strategy consists on limiting the amounts of certain elements. Thus when % C is more than 0.74%, preferably more than 0.85%, preferably more than 0.93%, more preferably more than 0.96% and even more preferably more than 1.15% then % Al should be kept at 10.11%, preferably below 9.01%, preferably below 8.34%, more preferably below 7.64% and even more preferably below 6.54% for such kind of applications.

The microstructural strategy consists on minimizing or preferably avoiding the formation of brittle microstructures. Brittle microstructures should be kept below 38%, preferably below 24%, more preferably below 13% and even more preferably below 8%. For very demanding applications brittle microstructures should be present below 5% and even absence of it if possible.

When designing an alloy, several considerations and alloying rules have to be taken into account. The most relevant to solve the technical problem have been described in the immediate paragraphs. But normally this characteristic has to be balanced with other properties also important for the good performance of the material. The inventor has surprisingly se found en that if some rules are considered, it is possible to obtain for the present invention a compromise with some other properties if the final application requires so.

Fortunately, for the alloys described in the immediately above paragraphs, it is possible to find a generalized heat treatment that covers the most interesting compromise of properties, mainly resistance to ambient attack, hardness, wear resistance and low thermal conductivity. This type of heat treatment is not the only one that can be applied, especially when one of the relevant properties is considerably more desirable than the others. That is to say, if low thermal conductivity were much more relevant than hardness and wear resistance, then a completely different heat treatment would be employed, and it would be one that would in each case depend on the selected chemical composition within the range.

The heat treatment preferred consists on a precipitation in at a temperature at, depending on the final application, at least 500° C., preferably more than 550° C., more preferably more than 600° C. and even more preferably more than 675° C. but it is recommendable that this temperature is kept below 850° C., preferably below 750° C., more preferably below 725° C. and even more preferably below 700° C. To further increase hardness it is very interesting to make a second precipitation in at a temperature above 300° C., preferably above 350° C. more preferably above 400° C. and even more preferably above 450° C. but it is recommendable that this temperature is kept below 700° C., preferably below 650° C., more preferably below 600° C. and in some instances even below 575° C. Depending on the manufacturing route selected for the material it might be advisable to make an annealing treatment after milling, forging or whichever thermo-mechanical processing route that has been applied. For certain applications it is desirable to have a high temperature holding step, with temperatures in the above 850° C., preferably above 900° C., more preferably above 960° C. and even more preferably above 980° C. but below 1200° C., preferably below 1175° C., more preferably below 1120° C. and even more preferably below 1080° C.

Any of the above-described applications corresponds with different embodiments of the steel composition and can be combined with any other embodiment herein described in any combination, to the extent that the respective features are not incompatible.

Hence, according to a preferred embodiment of the present invention the steels can have the following composition, all percentages being indicated in weight percent:

| | | | |
|---|---|---|---|
| % C_{eq} = 0.4-4 | % C = 0.4-4 | % N = 0-0.6 | % B = 0-4 |
| % Cr = 0-11 | % Ni = 0-9.5 | % Si = 0-4 | % Mn = 10-40 |
| % Al = 0-17 | % Mo = 0-10 | % W = 0-6.2 | % Ti = 0-6.4 |
| % Ta = 0-3 | % Zr = 0-3 | % Hf = 0-3 | % V = 0-12 |
| % Nb = 0-3 | % Cu = 0-6 | % Co = 0-7 | % Lu = 0-2 |
| % La = 0-2 | % Ce = 0-2 | % Nd = 0-2 | % Gd = 0-2 |
| % Sm = 0-2 | % Y = 0-2 | % Pr = 0-2 | % Sc = 0-2 |
| % Pm = 0-2 | % Eu = 0-2 | % Tb = 0-2 | % Dy = 0-2 |
| % Ho = 0-2 | % Er = 0-2 | % Tm = 0-2 | % Yb = 0-2 |
| % P = 0-2 | % S = 0-2 | | |

the rest consisting of iron and trace elements wherein,

% Ceq=% C+0.86*% N+1.2*% B,

where % Al+% Si+% Cr+% V>2%; and

if % C>0.9% then % Al<10%

In another aspect, the invention refers to a steel having the above composition having high levels of toughness properties even for large cross-sections. In an embodiment the steel of the above composition is a hot work steel. In an embodiment the steel of the above composition is a hot work tool steel. In an embodiment the steel of the above composition is at least partially martensitic. In another embodiment the steel of the above composition is at least partially bainitic.

Note that in metallurgical terms, composition of steels is normally given in terms of Ceq, which is defined as carbon upon the structure considering not only carbon itself, or nominal carbon, but also all elements which have a similar effect on the cubic structure of the steel, normally being B and/or N.

In the meaning of this text, other elements refer to any element that can be added to the base composition of the invention to provide for any relevant functionality while capitalizing the resistance to certain aggressive environments provided by the present invention. Normally other elements will not exceed a 49% of the weight percent of the alloy alone or in combination, preferably they will be kept below a 38%, more preferably below 24% and even more preferably below 10%. Other elements can also be trace elements.

In the meaning of this text, trace elements refer to any element, otherwise indicated, in a quantity less than 2%. For some applications, trace elements are preferable to be less than 1.4%, more preferable less than 0.9% and sometimes even more preferable to be less than 0.78%. Possible elements considered to be trace elements are H, Li, Na, K, Rb, Cs, Fr, Be, Mg, Ca, Sr, Ba, Ra, Ac, Tc, Re, Ru, Os, Rh, Ir, Pd, Pt, Ag, Au, Zn, Cd, Hg, Ga, In, Tl, Ge, Sn, Pb, As, Sb, Bi, O, Se, Te, Po, F, Cl, Br, I, At, He, Ne, Ar, Kr, Xe, Rn, Th, Pa, U, Np, Pu, Am, Cm, Bk, Cf, Es, Fm, Md, No, Lr alone and/or in combination. For some applications, some trace elements or even trace elements in general can be quite detrimental for a particular relevant property (like it can be the case sometimes for thermal conductivity and toughness). For such applications it is desirable to keep trace elements below a 0.4%, preferably below a 0.2%, more preferably below 0.14% or even below 0.06%. Needless to say being below a certain quantity includes also the absence of the element. In many applications, the absence of most of the trace elements or even all of them is obvious and/or desirable. As mentioned every trace element is considered a single entity and thus very often for a given application different trace elements will have different maximum weight percent admissible values. Trace elements can be added intentionally to search for a particular functionality including also cost reduction or its presence (when present) can be unintentional and related mostly to impurity of the alloying elements and scraps used for the production of the alloy. The reason for the presence of different trace elements can be different for one same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

For some applications, there are elements which are optional in the composition such as Nb, Co, Lu, La, Ce, Nd, Gd, Sm, Y, Pr, Sc, Pm, Eu, Tb, Dy, Ho, Er, Tm and/or Yb, this means that these elements may be present or not in the composition, and that they may not be present at the same time. For several applications in order to improve certain properties, one of more of these optional elements may be added to the steel in different weight percentages, but it is not mandatory to have all of them in the steel composition at the same time and it is not mandatory to combine them in their maximum indicated content. In any case the sum of all the elements in the steel composition, shall be 100%.

In general the inventor has found that for the steels of the present invention in some applications, % C will be desired at levels above 0.41%, preferably higher than 0.51%, more preferably higher than 0.59% and even more preferably higher than 0.72%. Depending on the final application, it will be desirable for some applications that % C is at the levels above 0.82%, preferably higher than 0.95%, more preferably higher than 1.12% and even more preferably higher than 1.20%. For applications requiring higher levels of % C, for example applications where high resistance to wear is necessary amongst others, it will be desirable to have % C higher than 1.26%, preferably higher than 1.41,%, more preferably higher than 1.62,% and even more preferably higher than 1.72%. On the other hand too high % C contents have other drawbacks, which have to be balanced depending on the final requirements, for example, % C too high lead to impossibility to attain the required nature and perfection of carbides (nitrides, borides, oxides or combinations) regardless of the heat treatment applied. Therefore in some cases % C is desirable to be maintained below 4.10%, preferably lower than 3.74%, more preferably lower than 3.12% and even more preferably lower than 2.41%. For other application, it will be desirable that % C is at the levels below 2.28%, preferably lower than 2.02%, more preferably lower than 1.93% and even more preferably lower than 1.87%. If high demanding applications in this sense are required, applications very sensible to % C content, for example applications requiring good levels of toughness, it will be desirable to have % C lower than 1.81%, preferably lower than 1.79%, more preferably lower than 1.63% and even more preferably lower than 0.52%.

For many applications the tolerated amount of % C substitution is rather small so that they require % C by itself to be greater than 0.62%, preferably greater than 0.76%, more preferably greater than 1.02 and even greater than 1.23%. The general maximum levels for % C and % Ceq expressed before are directly applicable here.

Inventor has found that for several applications it is desired having % Ceq between 0.42 and 3.6%, normally % Ceq between 0.42 and 2.9%, and even % Ceq between 0.52 and 2.48%.

Inventor has found that for several applications it is desired having % C between 0.42 and 3.6%, normally % C between 0.42 and 2.9%, and even % C between 0.52 and 2.48%.

In this sense, the inventor has found that for the steels of the present invention for some applications, % N will be desired at levels above 0.008%, preferably higher than 0.08%, more preferably higher than 0.1% and even more preferably higher than 0.3% depending on the final application, On the other hand for other applications too high levels of % N may not be desirable. Therefore for the present invention % N has to be lower than 0.45%, preferably lower than 0.3%, more preferably lower than 0.1% and even more preferably lower than 0.010%. For some embodiments of the present invention the inventor has found that it is desirable % N being absent from the composition.

In this sense, the inventor has found that for some applications the steels of the present invention, % B will be desired at levels above 0.08%, preferably higher than 0.3%, more preferably higher than 1.2% and even more preferably higher than 2.10% depending on the final application, On the other hand for other applications too high levels of % N may not be desirable. Therefore for the present invention % B has to be lower than 2.8%, preferably lower than 1.7%, more preferably lower than 0.8% and even more preferably lower than 0.1%. For some embodiments of the present invention the inventor has found that it is desirable % B being absent from the composition.

Another important element to control for these applications is % Mn. The inventor has found that for the steels of the present invention, % Mn will be desired at levels above 10.1%, preferably higher than 12.22%, more preferably higher than 13.68% and even more preferably higher than 14.35%. Depending on the final application, it will be desirable that % Mn is at the levels above 15.2%, preferably higher than 17.01%, more preferably higher than 1 8.35% and even more preferably higher than 1 9.71%. For other applications, for example applications which require the austenite domain to be stable at a wide range of temperatures, then it will be desirable to have % Mn higher than 20.31%, preferably higher than 2.9%, more preferably higher than 22.3,% and even more preferably higher than 24.9%. On the other hand excessive high levels of % Mn have a strong influence on the steel making process and may require special measures. Therefore for the present invention % Mn has to be lower than 4.5%, preferably lower than 398%, more preferably lower than 37.6% and even more preferably lower than 36.1%. Depending on the final application, it will be desirable that % Mn is at the levels below 35.3%, preferably lower than 32.8%, more preferably lower than 3.2% and even more preferably lower than 29.3%. For even lower contents, it will be desirable to have % Mn lower than 28.01%, preferably lower than 27.7%, more preferably lower than 26.9% and even more preferably lower than 26.0%.

Inventor has found that for several applications it is desired having % Mn between 10.1 and 36.4%, in other applications it is desired a higher minimum % Mn content, for these applications is desired normally % Mn between 10.6 and 36.4%, and even % Mn between 10.6 and 34.6%.

For some applications when % C is less than 1.1%, inventor has found that it is desirable having % Mn lower than 34%, and even for some applications having % C lower than 0.8%, the % Mn is desired lower than 16.5% if Cr and/or Ni are absent from the steel composition.

In this sense, the inventor has found that for the steels of the present invention, % Ni will be desired at levels above 0.18%, preferably higher than 0.59%, more preferably higher than 1.01% and even more preferably higher than 1.53%. Depending on the final application, if high hardenability for example is sought, it will be desirable that % Ni is at the levels above 3.2%, preferably higher than 3.55%, more preferably higher than 4.87% and even more preferably higher than 5.46%. For some applications it will be desirable to have % Ni even higher than 5.88%, preferably higher than 6.23%, more preferably higher than 6.79% and even more preferably higher than 7.49%. On the other hand too high levels of % Ni may not be desirable. Therefore for the present invention % Ni has to be lower than 9.5%, preferably lower than 8.8%, more preferably lower than 7.6% and even more preferably lower than 7.1%. Depending on the final application, it will be desirable that % Ni is at the levels below 6.3%, preferably lower than 5.8%, more preferably lower than 4.3% and even more preferably lower than 2.3%. For some application, for example if requiring some thermal conductivity, it will be desirable to have % Ni lower than 2.1%, preferably lower than 1.41%, more preferably lower than 0.47% and even more preferably lower than 0.12%.

For some embodiments of the present invention the inventor has found that it is desirable % Ni being absent from the composition.

Inventor has found that for several applications it is desired having % Ni between 0 and 9.3%, for other certain applications it is desired having a minimum content of % Ni in the composition of at least 0.1%, for these applications is desired normally % Ni between 0.1 and 9.3%, and even % Ni between 0.1 and 8%.

Inventor has found that for some applications it is desired % Ni above 0.01%, in certain applications, inventor has found that for % C lower than 1.65%, and % Al between 0.4 and 6.1%, it is desired % Ni>0.1, in other applications inventor has found that for % C above 1% and % Si lower than 0.45%, then % Ni is desired above 0.1%.

Inventor has found that for some applications where % C is lower than 1.55 and % Al above 2%, then % Ni is desired above 0.1%. In other applications when having % C lower than 0.65% and % V above 1.1, then % Ni is desired above 2.1%. For certain applications where % C is lower than 1.65 and % Al lower than 6.1%, then % Ni is desired above 4.1%. Another element that can be used as carbide former is % Cr. If used depending on the final aim, in some embodiments it will be desirable at least more than 0.85% more preferably more than 2.4% and even more preferably more than 3.6%. For superior levels, is some embodiments it will be desirable at least 5.57%, preferably more than 6.79%, more preferably more than 6.87% and even more preferably more than 7.34%. For other cases more than 8.47%, preferably more than 9.4 and even more preferably more than 9.76%. On the other hand, for the present invention, in some embodiments % Cr is desirable below 9.4%, preferably less than 8.6%, more preferably less than 8.76% and even more preferably less than 6.7%. For some embodiments of the present invention the inventor has found that it is desirable % Cr being absent from the composition.

Inventor has found that for several applications it is desired having a minimum content of % Cr in the composition of at least 0.10%, for certain applications it is desired having % Cr between 0.1 and 9.7%, in other applications a minimum lower % Cr content is preferred being higher, for these applications is desired normally % Cr between 2.3 and 9.3%, and even in other applications is desired a % Cr between 4.1 and 9.1%. Inventor has found that in certain applications, especially when having % Mn>23% and/or % C<1.3 is desired having at least 0.01% Cr, for certain applications normally % Cr>0.1, and even for some applications % Cr>1.2. In other applications, for these high manganese contents, % Mn>23%, and/or % C<1.3 is desired having at least 0.01% Ni, for certain applications normally 0% Ni>0.1, and even for some applications % Ni>1.2%.

Inventor has found that for several applications, especially when % Cr>4.95%, and % C<0.5% it is desired having a low % V content, for certain applications is desired % V<1.16%, normally % V<0.9 and even % V<0.7% may suffice.

Inventor has found that for some applications it is desired having % Cr+% Ni being above 0.1%, normally for some applications it is desired having % Cr+% Ni>1.3%, in some other applications it is desired having % Ni+% Cr>3.8%, and even in certain applications it is desired having % Ni+% Cr>7.3%.

Inventor has found that for certain applications, depending on % C in the steel composition different contains of % Ni and % Cr may be desired. For some applications having % C below 1%, it is desired having % Cr+% Ni above 7.4%, normally for some applications above 7.8%. In some other applications having % C between 1 and 2.2%, it may be desirable having % Ni+% Cr above 0.1%, normally for certain applications above 0.3%, and even for certain applications above 1.3%.

Regarding carbide formers, % W can be used, amongst many other uses, against wear; in such cases % W will be desirable at least 0.55%, preferably more than 0.89%, more preferably more than 1.23% and even more preferably more than 1.88%. In some other cases, % W will be desirable at least 2.22%, preferably more than 3.01%, more preferably more than 3.73% and even more preferably more than 4.1%. Depending on the final application, % W will be desirable to be below 5.2%, preferably below 4.6%, more preferably below 4.1% and even more preferably below 3.5%. For some embodiments of the present invention the inventor has found that it is desirable % W being absent from the composition.

Inventor has found that for several applications it is desired having % W between 0 and 5.9%, in other applications it is desired a higher minimum % W content, for these applications is desired normally % W between 0.01 and 4.6%, and even % W between 0.1 and 3.9%. % Mo can also be used as carbide former. Then it will be desirable at least 0.35%, preferably more than 0.48%, more preferably more than 0.99% and even more preferably more than 1.3%. In some other cases, % Mo will be desirable at least 1.8%, preferably more than 2.4%, more preferably more than 2.87% and even more preferably more than 3.6%. Depending on the final application, % Mo will be desirable to be below 6.2%, preferably below 5.7%, more preferably below 4.3% and even more preferably below 3.3%. For some embodiments of the present invention the inventor has found that it is desirable % Mo being absent from the composition.

Inventor has found that for several applications it is desired having % Mo between 0 and 8.4%, in other applications it is desired a higher minimum % Mo content, for these applications is desired normally % Mo between 0.01 and 7.6%, and even % Mo between 0.1 and 6.3%.

The inventor has found that for the steels of the present invention, % Co can be desired in some occasions. For applications when for example, some tempering resistance at high temperature is required, % Co will be desired to be at least 0.14%, preferably more than 0.29%, more preferably more than 0.54% and even more preferably more than 0.68%.

Depending on the final application, it can be desirable that % Co is at the levels above 0.87%, preferably higher than 0.97%, more preferably higher than 1.26% and even more preferably higher than 1.57%. For other applications, it will be desirable to have % Co higher than 1.9%, preferably higher than 2.7%, more preferably higher than 3.2% and even more preferably higher than 4.4%. On the other hand, % Co increases the critical cooling rate of steel and accelerates pearlitic transformation thus reducing hardenability of the steel, therefore, depending on the application too high levels of % Co may not be desirable.

Therefore for the present application % Co will be desirable to be lower than 7%, preferably lower than 5.9%, more preferably lower than 4.7% and even more preferably lower than 3.4%. Depending on the final application, it will be desirable that % Co is at the levels below 2.8%, preferably lower than 1.9%, more preferably lower than 1.4% and even more preferably lower than 1.10%. If even lower levels are required, then it will be desirable to have % Co lower than 0.89%, preferably lower than 0.6%, more preferably lower than 0.44% and even more preferably lower than 0.12% and even absence of it.

Inventor has found that for several applications it is desired having % Co between 0 and 6.4%, in other applications it is desired a higher minimum % Co content, for these applications is desired normally % Co between 0.01 and 5.3%, and even % Co between 0.1 and 4.6%.

Inventor has found that for several applications, it may be desired having % Cr+% Cu+% Co higher than 0.01%, normally % Cr+% Cu+% Co>0.1%, in other applications is preferred having % Cr+% Cu+% Co>1.2% and even for certain applications is preferred % Cr+% Cu+% Co>3.1%.

The inventor has found that for the steels of the present invention, % Ti can be desired depending on final application. In such cases, % Ti will be desired at least 0.49%, preferably more than 0.68%, more preferably more than 0.82% and even more preferably more than 0.99%. In some instances it may be desirable to have at least 1.32%, preferably more than 1.67%, more preferably more than 2.11% and even more preferably more than 2.86%. For more sophisticated applications, it will be desirable to have more than 3.5%, preferably more than 3.75%, more preferably more than 4.33% and even more preferably more than 4.8%. When % Ti is not desired, then is preferable to be less than 6.4%, preferably less than 5.47%, more preferably less than 4.66% and even more preferably less than 3.4%. For high demanding applications, it will be desirable to be less than 2.4%, preferably less than 1.87%, more preferably less than 0.87% and even more preferably less than 0.24%. For some applications the inventor has found that it is desirable % Ti being absent from the composition.

Inventor has found that for several applications it is desired having % Ti between 0 and 5.9%, in other applications it is desired a higher minimum % Ti content, for these applications is desired normally % Ti between 0.01 and 5.1%, and even % Ti between 0.1 and 3.6%. % Al can be used with different aims. The inventor has found that for the steels of the present invention, depending on the final application % Al can be desirable. For applications requiring low levels of % Al, for example for applications where % Al is used for example as a precipitating element for i.e increasing hardness, among many other intends, % Al will be desirable at levels not very high, at least 0.26%, preferably more than 0.33%, more preferably more than 0.43% and even more preferably more than 0.53%. For applications requiring low to intermediate levels of % Al, such as for example applications where % Al is used as a protective film against oxidation and decarburation at high temperatures, then % Al is desirable around 0.78%, preferably higher than 1.22%, more preferably higher than 1.54% and even more preferably higher than 2.03%. For applications requiring intermediate % Al levels, it will be desirable at least 2.94%, preferably more than 3.47%, more preferably more than 4.37% and even more preferably more than 5.39%. Some applications require high levels of % Al; one example is when low conductivity is sought; a way of attaining this could be by means of reducing its density; for such kind of level applications, % Al will be desirable above 6.2%, preferably above 7.3%, more preferably above 8.3%, even more preferably above 9.3% or even above 10.4%. For certain other applications, for example in some instances where Cr is present, % Al is desirable to be at the levels of 5.4%, preferably more than 6.7%, more preferably more than 7.88% and even more than 9.01%. Other examples for intermediate levels of % Al are for example applications where the oxidation resistance at high temperatures is one of the main environmental resistance requisites, higher levels of Al will be required and also the presence of other elements like Si and some transition metals will be appreciated. For such cases, % Al will be preferable to be more than 7.64%, preferably more than 8.27%, more preferably more than 8.87% and even more preferably more than 9.8%. For applications requiring high levels of % Al it will be desirable that % Al is more than 9.51%, preferably more than 1 2.44%, more preferably more than 1 4.7% and even more preferably more than 16%. On the contrary, there are some applications which suffer from high values of % Al.

If that is the case and other aspects have to be considered, then % Al should be below 1 7.5%, preferably below 1 4.36%, more preferably below 10.47% and even more preferably below 9.31%. As for the intermediate range of % Al, for example applications where relative good toughness is sought amongst others, then % Al will be desirable below 7%, preferably below 5.4%, more preferably below 4.12% and even more preferably below 2.8%. For other demanding applications, then % Al should be lower than 1.5%, preferably below than 0.89%, more preferably below 0.43% and even more preferably below 0.1%. For some applications it may also be desirable to have absence of % Al.

In some applications the proviso if % C>0.9% then % Al<10% may be substituted by: if % C>0.7% then % Al<10%.

Inventor has found that for some applications having % C between 0.5 and 1.1 and % Al above 7%, it is desired having % Mn lower than 24.8%. Inventor has found that for some applications having % C between 0.5 and 1.1 and % Al above 7% and % Mn above 23% it is desired having % B above 0.001%.

Inventor has found that for several applications it is desired having a minimum content of % Al in the composition of at least 0.10%, for these applications it is desired having % Al between 0.1 and 1 6.7%, normally % Al between 0.1 and 1 6.3%, and even % Al between 0.1 and 15.9%. Inventor has found that for several applications, especially when % C<1.52%, and % Mn>14.9 it is desired having at least % Al>3.1, for certain applications normally % Al>3.4 may suffice.

Inventor has found that for several applications, it is desirable having more % Mn than % Al, for some applications is also desirable, when % C is lower than 1.65 is desired % Mn-% Al<10.05%, normally % Mn-% Al<9.7, and even for certain applications % Mn-% Al<9.3.

For certain applications it is desired having % Cr+% Ni+% Al above 0.1%, normally for certain applications % Cr+% Ni+% Al above 6%, in certain applications % Cr+% Ni+% Al above 11%, and even in some applications % Cr+% Ni+% Al above 13%.

For certain applications it is desired having % Cr+% Ni-% Al above 0.01%, normally for certain applications % Cr+% Ni-% Al above 0.1%.

For certain applications it is desirable having % Ni+% Cr+% Al-% Mn above 0.01%, normally for certain applications it is desired having % Ni+% Cr+% Al-% Mn above 0.1%.

For the steels of the present invention, depending on the final application, if % Si needs to be present for the seek of a special property, then % Si will be desirable to be at least 0.34%, preferably more than 0.87%, more preferably more than 1.06% and even more preferably more than 1.57%. For high levels of % Si, it will be desirable at least 1.99% Si, preferably more than 2.47%, more preferably more than 3.43% and even more preferably more than 3.87%. For applications where % Si is detrimental, then % Si is desirable below 4%, preferably below 3.4%, more preferably less than 2.4% and even more preferably below 1.8%. For highly demanding applications, for example if cleanliness of the steel is to be optimized or toughness is to be increased, amongst many other cases, then % Si is desirable to be below 1.05%, preferably below 0.73%, more preferably below 0.54% and even more preferably below 0.22%. For some embodiments of the present invention the inventor has found that it is desirable % Si being absent from the composition.

Inventor has found that for several applications it is desired having % Si between 0 and 3.4%, in other applications it is desired a higher minimum % Si content, for these applications is desired normally % Si between 0.01 and 2.8%, and even % Si between 0.1 and 1.8%.

Inventor has found that for certain applications having % C above 1%, and % Si above 0.45% it is desired having % Mn-% Al<10.

The inventor has found that for the steels of the present invention, % Cu can be desired in certain applications, for some applications, % Cu will be desired to be at least 0.14%, preferably more than 0.29%, more preferably more than 0.54% and even more preferably more than 0.68%. Depending on the final application, in some applications it can be desirable that % Cu is at the levels above 0.87%, preferably higher than 0.97%, more preferably higher than 1.26% and even more preferably higher than 1.57%. For other applications, it will be desirable to have % Cu higher than 1.9%, preferably higher than 2.7%, more preferably higher than 3.2% and even more preferably higher than 4.4%. On the other hand, depending on the application too high levels of % Cu may not be desirable.

Therefore in some applications % Cu will be desirable to be lower than 5.9%, preferably lower than 4.7% and even more preferably lower than 3.4%. Depending on the final application, in some applications it will be desirable that % Cu is at the levels below 2.8%, preferably lower than 1.9%, more preferably lower than 1.4% and even more preferably lower than 1.1%. If even lower levels are required, then in some applications it will be desirable to have % Cu lower than 0.89%, preferably lower than 0.6%, more preferably lower than 0.44% and even more preferably lower than 0.12% and even absence of it.

Inventor has found that for several applications it is desired having % Cu between 0 and 4.8%, in other applications it is desired a lower % Cu content, for these applications is desired normally % Cu between 0 and 3.1%, and even % Cu between 0 and 2%.

Inventor has found that for several applications, it may be desired having % Cr+% Cu+% Si higher than 0.01%, normally % Cr+% Cu+% Si>0.1, in other applications is preferred having % Cr+% Cu+% Si>1.2 and even for certain applications is preferred % Cr+% Cu+% Si>3.1.

Regarding % V, in some applications for low levels it will be desirable at least 0.14%, preferably more than 0.57%, more preferably more than 0.61% and even more preferably more than 0.69%. For intermediate levels, in some embodiments it will be desirable at least 0.72%, preferably more than 0.83%, more preferably more than 1.34% and even more preferably more than 2.46%. For high levels of % V in some applications, it will be desirable to at least 4.11%, preferably more than 4.8%, more preferably more than 5.68% and even more preferably more than 7.61%. For the upper limits, is some embodiments it will be desirable less than 12%, preferably less than 10.98%, more preferably less than 8.74% and even more preferably less than 7.36%. Other preferred ranges for some embodiments will be less than 5.74%, preferably less than 3.68%, more preferably less than 2.28% and even more preferably less than 1.32%. For low levels of % V then in some embodiments it will be desirable less than 0.87%, preferably less than 0.63%, more preferably less than 0.47% and even more preferably less than 0.24%. For special cases, it will be desirable even less than 0.14% or even less than 0.05%. Other preferred embodiments where the % C is high (above 0.45%, preferably above 0.46% and even more preferably above 0.57%), % V is preferred to be somehow high, at least % V more than 0.62%, preferably more than 0.69%, more preferably more than 0.72% and even more preferably more than 0.83%. On the other hand, less than 12.3%, preferably less than 11.4%, more preferably less than 9.47% and even more preferably less than 7.68%. If relative high levels of % Cr are also present, for example higher than 2.71%, preferably higher than 3.15%, more preferably higher than 3.87% and even more preferably higher than 4.99% and even more higher than 5.210%, then in an another embodiment it might be preferable % V is low, preferably below 0.58%, more preferably below 0.47%, more preferably below 0.34% and even more preferably below 0.21% and in some instances even absent.

For the steels of the present invention it is desirable that % Al+% Si+% Cr+% V is at least 2%, preferably more than 2.31%, more preferably more than 2.54% and even more preferably more than 2.87%. If % Al is present, then % Al+% Si+% Cr+% V is desirable at least more than 3.1%, preferably more than 1.4%, more preferably more than 3.67% and even more preferably more than 4%.

For some embodiments, inventor has found that Ta, Zr, Hf, Nb, La, Ce are optional elements in the composition of the steel, and in some embodiments any of them and/or all of them may be absent from the composition.

Inventor has found that for several applications, it may be desired having % Ta+% Zr+% Hf+% Nb+% La+% Ce=0-4.2%.

Inventor has found that for several applications, it may be desired having % Ta+% Zr+% Hf+% Nb+% La+% Ce=0-4.2=0-3.7%.

Inventor has found that for several applications, it may be desired having % Ta+% Zr+% Hf+% Nb+% La+% Ce=0-4.2=0-2.2%.

Inventor has found that for several applications, it may be desired having % Ta+% Zr+% Hf+% Nb+% La+% Ce above 0.001%, normally for certain applications % Ta+% Zr+% Hf+% Nb+% La+% Ce above 0.01%, and even for certain applications % Ta+% Zr+% Hf+% Nb+% La+% Ce is above 0.1%.

Inventor has found that for several applications, it may be desired having % Ta+% Zr+% Hf+% Nb+% La+% Ce=0.001-2.2%.

In this sense, the inventor has found that for some applications, % P will be desired at levels above 0.0010%, preferably higher than 0.010%, more preferably higher than 0.10% and even more preferably higher than 0.3% depending on the final application, On the other hand for other applications too high levels of % P may not be desirable. Therefore for the present invention % P has to be lower than 1.6%, preferably lower than 1.3%, more preferably lower than 0.8% and even more preferably lower than 0.1%. For some embodiments of the present invention the inventor has found that it is desirable % P being absent from the composition.

In this sense, the inventor has found that for some applications, % S will be desired at levels above 0.001%, preferably higher than 0.01%, more preferably higher than 0.1% and even more preferably higher than 0.2% depending on the final application, On the other hand for other applications too high levels of % S may not be desirable. Therefore for the present invention % S has to be lower than 1.6%, preferably lower than 1.3%, more preferably lower than 0.8% and even more preferably lower than 0.1%. For some embodiments of the present invention the inventor has found that it is desirable % S being absent from the composition.

For certain applications, inventor has found that it is desired having one of the following: % Nb+% Co+% Lu+% La+% Ce+% Nd+% Gd+% Sm+% Y+% Pr+% Sc+% Pm+% Eu+% Tb+% Dy+% Ho+% Er+% Tm+% Yb=0-10% % Nb+% Co+% Lu+% La+% Ce+% Nd+% Gd+% Sm+% Y+% Pr+% Sc+% Pm+% Eu+% Tb+% Dy+% Ho+% Er+% Tm+% Yb=0-8% % Nb+% Co+% Lu+% La+% Ce+% Nd+% Gd+% Sm+% Y+% Pr+% Sc+% Pm+% Eu+% Tb+% Dy+% Ho+% Er+% Tm+% Yb=0-6%

For certain applications, inventor has found that it is desired having: % V+% Nb+% Sn+% Si+% Ti+% Co+% W+% Mo=0-9.8%

There are also other applications, wherein a minimum content of the following elements is desired, for these applications: % V+% Nb+% Sn+% Si+% Ti+% Co+% W+% Mo=0.1-9.8%

It happens often that two steels representing two very different technological advances, and therefore aiming at very different applications, moreover each being absolutely useless for the objective application of the other, can coincide in the compositional range. In most cases the actual composition will never coincide even if the compositional ranges do more or less interfere, in other cases the actual composition could even coincide and the difference would come from the thermo-mechanical treatments applied.

The steels described above are especially suited for applications requiring low thermal conductivity for minimizing heat loss and avoid hot zones, together with good resistance to certain aggressive environments.

Some applications require also High thermal conductivity. The present invention is especially favorable in those cases since obtaining high thermal conductivity in regular stainless steels is quite challenging. In the present invention since much lower levels of % Cr than 10% can be used different strategies can be used to attain a high thermal conductivity. Unfortunately % Al which is a very interesting oxide former has a strong negative effect on the thermal conductivity, and thus should be avoided as much as possible when trying to maximize thermal conductivity. The inventor has found that one possible way to proceed is to restrict the main oxide formers used, to Zr, alternatively Zr and Nb or even Zr, Nb and Ti. While other oxide formers can be used they should be used in smaller amounts. The main most important aspect when it comes to thermal conductivity is the microstructure at the atomic level. The inventor has also found that for the alloys of the present invention when it comes to ambient resistance combined with high thermal conductivity it is the thermal diffusivity that should be taken care of and density and heat capacity can almost be neglected.

Some other applications require exactly the contrary, namely low thermal conductivity.

Levels even below 15 W/mK are attainable with conventional stainless steels, but levels around and below 10 W/mK are far more challenging.

There are several applications requiring low thermal conductivity with high oxidation resistance at high temperatures, for those cases higher % Al contents will be preferred, and for the case of low thermal conductivity, the additions of % Si highly appreciated.

Another typical shortcoming of conventional stainless steels that can be more easily solved with the present invention is the case in which environmental resistance is desired together with wear resistance and/or high hardness. Typically, conventional stainless steels have difficulties to attain high levels of wear resistance and hardness in excess of 60HRc. With the present invention it is possible to combine such properties, attaining hardness above 47HRc, preferably above 52HRc, more preferably above 58HRc and even more preferably above 62HRc.

Also, high % Cr levels as required for conventional stainless steels make the achievement of Bainitic microstructures almost impossible. In recent years very interesting advances have been made with this type of microstructures that can be capitalized in the present invention.

In another embodiment of the present invention the resistance to certain aggressive environments is combined with other mechanical properties, for example the capability of obtaining high harness levels, i.e more than 48HRC, preferably more than 52HRc, more preferably more than 54HRc and even more preferably more than 58HRc combined with high toughness and good wear resistance but with low C contents, comparatively with the state of the art. To obtain the desired properties different strengthening mechanisms are combined, such as for example the use of primary carbides and/or, substitutional solid solution and/or intermetallic precipitation. Given that the presence of primary carbides is required to supply wear resistance, but we want to benefit from the increase in toughness that a precipitation strengthened matrix can bring and we want to keep the % C as low as possible, we want to use the carbon present to form the primary carbides and those with best compromise of hardness and toughness. In this regard, those carbides with stronger carbide former metals will be selected to leave a tougher matrix, and harder carbides, in this case Ti carbides or Ti mixed carbides (primarily with V, W and/or Mo) will be the preferred ones, alternatively Zr and Hf mixed carbides can be used. It is also beneficial to have as little as possible secondary carbides in the matrix, given that precipitates provide a better compromise between hardness and toughness and do not increase % Ceq, so strong carbide formers will be preferred to weaker ones.

When it comes to intermetallic precipitates several could be used, to mention the most well known: Ni₃Ti, Ni₃Mo, Ni₃Al, NiTi, NiMo and/or NiAl, amongst others. If Ti or Mo are wanted for this purpose, then stronger carbide formers than they have to be used so that they do not bond with carbide. Below are strong carbide formers ordered in increasing strength, so that it is clear which elements can be used to fix carbon if either Ti or Mo are wanted to combine with Ni: Cr, W, Mo, V, Ti, Nb, Ta, Zr, Hf.

Therefore the alloys of the present invention may always have some carbide formers of the group: Cr, V, Mo and W.

Any of the above-described applications corresponds with different embodiments of the steel composition and can be combined with any other embodiment herein described in any combination, to the extent that the respective features are not incompatible.

Hence, according to another preferred embodiment of the present invention the steels can have the following composition, all percentages being indicated in weight percent:

| | | | |
|---|---|---|---|
| % Ceq = 0.25-2.5 | % C = 0.25-2.5 | % N = 0-2 | % B = 0-2 |
| % Cr = 2.5-12 | % Ni = 3-12 | % Si = 0-2 | % Mn = 0-3 |
| % Al = 0.5-5 | % Mo = 0-10 | % W = 0-15 | % Ti = 0-3.8 |
| % Ta = 0-2 | % Zr = 0-4 | % Hf = 0-3 | % V = 0-1 |
| % Nb = 0-2.9 | % Cu = 0-4 | % Co = 0-7 | % S = 0-2 |
| % Se = 0-1 | % Te = 0-1 | % Bi = 0-1 | % As = 0-1 |
| % Sb = 0-1 | % Ca = 0-1 | % P = 0-2 | % Pb = 0-2 |
| % Cs = 0-2 | % Sn = 0-2 | | |

the rest consisting of iron and trace elements, wherein

% Ceq=% C+0.86*% N+1.2*% B,

With the proviso that:

when % Ceq=0.25-0.44%, then % V<0.85% and % Ti+% Hf+% Zr+% Ta<0.1%

when % Ceq=0.45-2.5%, then % V<0.6%;

In another aspect, the invention refers to a steel having the above composition having high levels of toughness properties even for large cross-sections. In an embodiment the steel of the above composition is a hot work steel. In an embodiment the steel of the above composition is a hot work tool steel. In an embodiment the steel of the above composition is at least partially martensitic. In another embodiment the steel of the above composition is at least partially bainitic.

As previously explained in the meaning of this text, trace elements refer to any element, otherwise indicated, in a quantity less than 2%. For some applications, trace elements are preferable to be less than 1.4%, more preferable less than 0.9% and sometimes even more preferable to be less than 0.78%. Possible elements considered to be trace elements are H, Li, Na, K, Rb, Fr, Be, Mg, Sr, Ba, Ra, Sc, Y, La, Ac, Tc, Re, Ru, Os, Rh, Ir, Pd, Pt, Ag, Au, Zn, Cd, Hg, Ga, In, Tl, Ge, O, Po, F, Cl, Br, I, At, He, Ne, Ar, Kr, Xe, Rn, Ce, Pr, Nd, Pm, Sm, Eu, Gd, Tb, Dy, Ho, Er, Tm, Yb, Lu, Th, Pa, U, Np, Pu, Am, Cm, Bk, Cf, Es, Fm, Md, No, Lr alone and/or in combination. For some applications, some trace elements or even trace elements in general can be quite detrimental for a particular relevant property (like it can be the case sometimes for thermal conductivity and toughness). For such applications it is desirable to keep trace elements below a 0.4%, preferably below a 0.2%, more preferably below 0.14% or even below 0.06%. Needless to say being below a certain quantity includes also the absence of the element. In many applications, the absence of most of the trace elements or even all of them is obvious and/or desirable. As mentioned every trace element is considered a single entity and thus very often for a given application different trace elements will have different maximum weight percent admissible values.

Trace elements can be added intentionally to search for a particular functionality including also cost reduction or its presence (when present) can be unintentional and related mostly to impurity of the alloying elements and scraps used for the production of the alloy. The reason for the presence of different trace elements can be different for one same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

For some applications, there are elements which are optional in the composition such as Ta, Zr, Hf, S, Se, Te, Bi, As, Sb, Ca, P, Pb, Cs, Sn or Cu, this means that these elements may be present or not in the composition, and that they may not be present at the same time.

For several applications in order to improve certain properties, one of more of these optional elements may be added to the steel in different weight percentages, but it is not mandatory to have all of them in the steel composition at the same time and it is not mandatory to combine them in their maximum indicated content. In any case the sum of all the elements in the steel composition, shall be 100%.

Hence, preferred ranges for the different elements are further described. When it comes to % C the inventor has found that for low carbon embodiments % C will be desired around 0.245%, preferably higher than 0.272%, more preferably higher than 0.301% and even more preferably higher than 0.359. As for the upper limit, % C will be desirable less than 0.449%, preferably less than 0.43%, more preferably less than 0.397% and even more preferably less than 0.356%. On the other hand for applications requiring a higher level of % C it is recommended at least 0.451%, preferably more than 0.47%, more preferably more than 0.54% and even more preferably more than 0.64%. For other application, it will be desirable that % C is at least more than 0.72%, preferably more than 0.89%, more preferably more than 1.21% and even more preferably more than 1.55%. As for the upper limit, it will be desirable to have % C lower than 2.52%, preferably less than 2.40%, more preferably less than 2.273% and even more preferably less than 2.04%. For special cases it will be even desirable that % C is less than 1.87%, preferably less than 1.67% and even more preferably less than 1.52%.

Inventor has found that for several applications it is desired having % C between 0.26 and 2.5%, normally % C between 0.31 and 2.5%, and even % C between 0.35 and 2.5%.

For % Ceq in some applications it will be desired around 0.245%, preferably higher than 0.272%, more preferably higher than 0.301% and even more preferably higher than 0.359.

As for the upper limit, in some embodiments % Ceq will be desirable less than 0.449%, preferably less than 0.43%, more preferably less than 0.397% and even more preferably less than 0.356%. On the other hand for applications requiring a higher level of % Ceq it is recommended in some applications having at least 0.451%, preferably more than 0.47%, more preferably more than 0.54% and even more preferably more than 0.64%. For other application, it will be desirable that % Ceq is at least more than 0.72%, preferably more than 0.89%, more preferably more than 1.21% and even more preferably more than 1.55%. As for the upper limit, it will be desirable to have % C lower than 2.52%, preferably less than 2.40%, more preferably less than 2.273% and even more preferably less than 2.04%. For special cases it will be even desirable that % Ceq is less than 1.87%, preferably less than 1.67% and even more preferably less than 1.52%.

Inventor has found that for several applications it is desired having % Ceq between 0.26 and 2.5%, normally % Ceq between 0.31 and 2.5%, and even % Ceq between 0.35 and 2.5%.

Other preferred embodiment of the invention for the above applications are steels with the following features:

when % Ceq=0.45-2.5, then % V<0.6;

Other preferred embodiment of the invention for the above applications are steels with the following features:

when % Ceq=0.45-2.5, then % V=0.01-0.57;

For this rather high levels of % C, the inventor has found that % V should be kept below some certain values for a better performance, normally below 0.84%, preferably below 0.83%, more preferably below 0.81% and even more preferably below 0.8%.

For the very low carbon embodiments of the present invention, depending on the desired carbides to be formed according to the final property to be improved, the inventor has found additional preferred embodiments with the following features:

when % Ceq=0.25-0.44, then % Cr=2.1-10; or

when % Ceq=0.25-0.44%, then % Cr=5-10%; or

when % Ceq=0.25-0.44% and % Cr=0.5-5, then % Ni>4%; or

when % Ceq=0.25-0.45%, then % Ti+% Hf+% Zr+% Ta+% Al=0.1-4%.

Following this compositional rules, for this % Ceq between 0.25 and 0.44%, in some applications the lower limit of % V is desirable to be higher than 0.18%, preferably higher than 0.26%, more preferably higher than 0.43% and even more preferably higher than 0.53%, in some of these applications it is further desirable having a content of the sum % Ti+% Hf+% Zr+% Ta+% Al lower than 0.1%, normally lower than 0.08%. For other embodiments and for this levels of % Ceq, between 0.25 and 0.44 it will be preferable that % Cr is higher than 5.1%, preferably higher than 5.49%, more preferably more than 6.43% and even more preferably more than 6.77%. For other embodiments where, on the contrary % Cr may be kept low, between 2.5% and 5%, the inventor has found that % Ni may be kept higher than 3.54%, preferably higher than 3.87%, more preferably higher than 4.03% an even more preferably higher than 4.67%. In other cases, the sum of % Ti+% Hf+% Zr+% Ta+% Al should be controlled and therefore in such cases it will be desirable to be a bit higher than 0.1%, preferably higher than 0.34%, more preferably higher than 0.69% and even more preferably higher than 0.95%.

Regarding carbide formers, % W can be used and will be desirable at least 0.15%, preferably more than 0.24%, more preferably more than 0.52% and even more preferably more than 0.78%. In some other cases, % W will be desirable at least 0.99%, preferably more than 1.47%, more preferably more than 1.96% and even more preferably more than 2.73%. For applications demanding high levels of % W, it will be desirable to have at least 3.47%, preferably more than 4.53%, more preferably more than 6.03% and even more preferably more than 7.44%. As per the upper limit, % W will be desirable to be below 14.99%, preferably below 1 3.74%, more preferably below 1 2.44% and even more preferably below 11.5%. For intermediate levels of % W, it will be desirable less than 9.7%, preferably less than 8.64%, more preferably less than 7.34% and even more preferably less than 6.28%.

For low levels of % W, it will be desirable less than 4.3%, preferably below 2.7%, more preferably less than 1.22% and even more preferably less than 0.43%. In some cases even less than 0.2% or even absence of it.

Inventor has found that for several applications it is desired having % W between 0 and 6.8%, normally % W between 0.01 and 6.8%, and even % W between 0.01 and 5.8%. % Mo can also be used as carbide former. For applications requiring low limits of % Mo, it will be desirable at least 0.14%, preferably more than 0.23%, more preferably more than 0.43% and even more preferably more than 0.71%. In some other cases, % Mo will be desirable at least 1.13%, preferably more than 1.26%, more preferably more than 1.87% and even more preferably more than 2.46%. When high values of % Mo are required, then it will be desirable at least 3.22%, preferably more than 4.34%, more preferably more than 5.23% and even more preferably more than 6.77%. As for the upper limit, for high levels of % Mo, it will be desirable less than 10%, preferably less than 7.8%, preferably less than 6.2%, more preferably less than 4.9% and even more preferably less than 3.31%. For low levels of % Mo, it will be desirable less than 2.8%, preferably less than 1.43%, more preferably less than 0.66% and even more preferably less than 0.43%. In some cases even less than 0.24% or even absence of it.

Inventor has found that for several applications it is desired having it is desired having a at least 0.1% % Mo in the composition, for some application is desired % Mo between 0.1 and 10%, for other applications normally % Mo between 0.3 and 6.4%, and even % Mo between 0.8 and 2.9%.

Another element that can be used as carbide former is % Cr. If used depending on the final aim, it will be desirable at least more than 2.85% more preferably more than 3.4% and even more preferably more than 5.1%. For superior levels, it will be desirable at least 5.57%, preferably more than 6.79%, more preferably more than 6.87% and even more preferably more than 7.34%. For other cases more than 8.47%, preferably more than 9.24% and even more preferably more than 9.76%. On the other hand, for the present invention, % Cr is desirable below 1 3.2%, preferably less than 9.76%, more preferably less than 8.76% and even more preferably less than 7.44%. For intermediate ranges it will be desirable less than 6.41%, preferably less than 5.24%, more preferably less than 4.63% and even more preferably less than 3.47%.

Inventor has found that for several applications it is desired having a minimum content of % Cr in the composition of at least 2.5%, for certain applications it is desired having % Cr between 2.5 and 9.7%, in other applications a minimum lower % Cr content is preferred being higher, for these applications is desired normally % Cr between 3.6 and 9.3%, for other applications is desired % Cr between 5.1 and 9.1%. and even in other applications is desired a % Cr between 6.2 and 8.8%.

Regarding % Co, the inventor has found that it will be desired to be at least 0.13%, preferably more than 0.37%, more preferably more than 0.59% and even more preferably more than 0.87%. Depending on the final application, it can be desirable that % Co is at the levels above 1.33%, preferably higher than 1.57%, more preferably higher than 1.72% and even more preferably higher than 1.92%. For other applications, it will be desirable to have % Co higher than 2.39%, preferably higher than 3.41%, more preferably higher than 4.22% and even more preferably higher than 5.43%. On the other hand, for the present application % Co will be desirable to be lower than 7.89%, preferably lower than 6.4%, more preferably lower than 4.92% and even more preferably lower than 3.82%. Depending on the final application, it will be desirable that % Co is at the levels below 2.43%, preferably lower than 1.94%, more preferably lower than 1.53% and even more preferably lower than 1.07%.

If even lower levels are required, then it will be desirable to have % Co lower than 0.54%, preferably lower than 0.43%, more preferably lower than 0.24% and even more preferably lower than 0.11% and even absence of it. For some instances for low carbon limits, it will be desired that % Co is present and apply to the following rule:

when % Ceq=0.25-0.44, then % Co=0.1-4.

In some applications having low carbon limits a higher minimum % Co is preferred; in these applications the following compositional rule may be applied:

when % C=0.25-0.44, then % Co>1.1

Inventor has found that in some applications having % C between 0.36 and 0.44%, when % V is greater than 0.6%, it may be preferred having % Co lower than 1.9%.

In some applications, for % C contents between 0.25 and 2.5%, is desirable having % Co higher than 1.3%, normally above 1.40%, and even above 1.45%.

Inventor has found that in some applications having % C between 0.75 and 1.6, when % Cr is greater than 4.8%, it may be preferred having % Co above 0.1%.

The inventor has found that for the steels of the present invention, % Ti can be desired depending on final application. In such cases, % Ti will be desired at least 0.08%, preferably more than 0.68%, more preferably more than 0.82% and even more preferably more than 0.9%. In some applications it may be desirable to have at least 1.3%, preferably more than 1.6%, more preferably more than 2.1% and even more preferably more than 2.8%. For more sophisticated applications, it will be desirable to have more than 3.5%, preferably more than 3.7%, more preferably more than 4.3% and even more preferably more than 4.8%. In some applications having too high concentrations of % Ti is not desired, then is preferable to be less than 6.4%, preferably less than 5.4%, more preferably less than 4.6% and even more preferably less than 3.4%. For high demanding applications, it will be desirable % Ti to be less than 2.4%, preferably less than 1.87%, more preferably less than 0.8% and even more preferably less than 0.24%. For some embodiments of the present invention the inventor has found that it is desirable % Ti being absent from the composition.

Inventor has found that for several applications it is desired having % Ti between 0 and 2.6%, in other applications it is desired a higher minimum % Ti content, for these applications is desired normally % Ti between 0 and 1.9%, and even % Ti between 0.1 and 1.6%.

Regarding % Al, for some applications it will be desirable at least 0.16%, preferably more than 0.24%, more preferably more than 0.42% and even more preferably more than 0.9%.

For higher levels of % Al is desirable around 0.93%, preferably higher than 1.2%, more preferably higher than 1.6% and even more preferably higher than 1.8%. For applications demanding even higher levels of % Al it will be desirable to have at least 2.10%, preferably more than 2.9%, more preferably more than 3.53% and even more preferably more than 4.10%. On the other hand, according to the present invention % Al will be desirable below 5%, preferably below 4.3%, more preferably below 3.1% and even more preferably below 2.63%. For other applications, then % Al will be desirable lower than 1.3%, preferably below 0.9%, more preferably below 0.8% and even more preferably below 0.6%.

Inventor has found that for several applications it is desired having % Al between 0.5 and 4.8%, normally % Al between 0.6 and 4.8%, and even % Al between 0.7 and 3.8%.

Inventor has found that for several applications it is desired having % Cr-% Al higher than 3.8% and even % Cr-% Al greater than 4.1%.

Inventor has found that for some applications it is desired having % Co-% Al above 0.001, normally for certain applications it is desired having % Co-% Al above 0.01%.

For some instances for certain applications, it will be desired the appliance of the following rule:

when % Ceq=0.45-2.5 then % Ti+% Hf+% Zr+% Ta+% Al=0.1-4.

In some applications the sum % Ti+% Hf+% Zr+% Ta is maintained between 0.1 and 4%, for % Ceq contents between 0.25 and 0.45%, as explained above.

In contrast for some instances for low carbon limits, it will be desired the appliance of the following rule:

when % Ceq=0.25-0.44, then % Ti+% Hf+% Zr+% Ta<0.1%

In some applications the sum % Ti+% Hf+% Zr+% Ta is maintained bellow 0.1% normally below 0.08%, for % Ceq contents between 0.25 and 0.45%, as explained above, when having a vanadium content lower than 0.84%, normally lower than 0.8%, preferably lower than 0.77%, and even lower than 0.74%.

The inventor has found that for the steels of the present invention having the above composition in some applications, % Ni will be desired at levels above 0.21%, preferably higher than 0.48%, more preferably higher than 0.87% and even more preferably higher than 1.28%. Depending on the final application, it will be desirable that % Ni is at the levels above 2.57%, preferably higher than 3.85%, more preferably higher than 4.43% and even more preferably higher than 5.13%. For some applications it will be desirable to have % Ni even higher than 5.97%, preferably higher than 6.43%, more preferably higher than 6.93% and even more preferably higher than 7.28%. On the other hand, for some applications it will be desirable that % Ni is at the levels below 6.3%, and even more preferably lower than 4.7%.

Inventor has found that for several applications it is desired having % Ni between 3.2 and 12%, normally % Ni between 3.7 and 10.3%, and even % Ni between 4.2 and 9.5%.

For the steels of the present invention, % Si will be desirable at least 0.01%, preferably more than 0.13%, more preferably more than 0.22% and even more preferably more than 0.38%.

For higher levels of % Si, it will be desirable at least 0.67%, preferably more than 0.87%, more preferably more than 12% and even more preferably more than 1.51%. Sometimes even more than 1.63%. For applications where % Si is detrimental, then % Si is desirable below 2%, preferably less than 1.67%, more preferably less than 1.34% and even more preferably below 0.99%. For highly demanding applications where % Si needs to be kept as low as possible, then % Si is desirable to be below 0.53%, preferably below 0.33%, more preferably below 0.24% and even more preferably below 0.12%. For some applications the inventor has found that it is desirable % Si being absent from the composition.

Inventor has found that for several applications it is desired having % Si between 0 and 1.8%, normally % Si between 0 and 1.6%, and even % Si between 0 and 1.4%.

Inventor has found that for several applications it is desired having % Si in the composition, for these applications is desired % Si between 0.001 and 2%, normally % Si between 0.001 and 1.9%, and even % Si between 0.01 and 1.7%.

Regarding % Mn, the inventor has found that for the steels of the present invention, % Mn will be desired at least 0.12%, preferably more than 0.27%, more preferably more than 0.46% and even more preferably more than 0.71%. For higher levels it will be desirable at least 0.92%, preferably more than 1.41%, more preferably more than 1.63% and even more preferably more than 2.57%. For other applications, for the present invention % Mn will be desired to be lower than 3.01%, preferably lower than 2.43%, more preferably lower than 1.97% and even more preferably lower than 1.110%. Depending on the final application, it will be desirable that % Mn is at the levels below 0.94%, preferably lower than 0.73%, more preferably lower than 0.62% and even more preferably lower than 0.48%. For even lower contents, as for example for having a detrimental effect, it will be desirable to have % Mn lower than 0.37%, preferably lower than 0.29%, more preferably lower than 0.17% and even more preferably lower than 0.14% and even % Mn absent from the composition for some applications.

Inventor has found that for several applications it is desired having % Mn between 0.001 and 3%, normally % Mn between 0.0015 and 2.7%, and even % Mn between 0.01 and 2.4%.

Inventor has found that for several applications, when having % C<0.3 it is desired the sum % Mn+% Si being above 0.2%, normally above 0.25%, and even for some applications above 0.3%.

Regarding % V, for low levels in some applications it will be desirable at least 0.14%, preferably more than 0.57%, more preferably more than 0.61% and even more preferably more than 0.69%. For intermediate levels, it will be desirable at least 0.72%, Inventor has found that in some applications when % C is lower than 0.3%, it may be preferred having % Ti lower than 0.09%.

Inventor has found that in some applications having % C between 0.75 and 1.6, when % Cr is higher than 4.8%, it may be preferred having % Ni higher than 5.1%.

Inventor has found that in some applications it is desired having a sum of % Cr+% V+% Mo+% W above 2.6%, normally above 3%, and even above 4.1%.

Inventor has found that in some applications it is desired having a sum of % Al+% Mo+% Ti above 0.7%, normally above 0.9%, in other applications above 1.1% and even above 1.5%.

Hence, preferred embodiments of the invention for the above applications are steels with the following features:

% Cr+% V+% Mo+% W>3% and

% Al+% Mo+% Ti>0.7%

Other preferred embodiments of the invention for the above applications are steels wherein:

% Cr+% V+% Mo+% W>3% and

% Al+% Mo+% Ti>0.9%

Other preferred embodiments of the invention for the above applications are steels wherein:

% Cr+% V+% Mo+% W>3% and

% Al+% Mo+% Ti>1.10%

Other preferred embodiments of the invention for the above applications are steels wherein:

% Cr+% V+% Mo+% W>3% and

% Al+% Mo+% Ti>1.50%

For some applications inventor has found that when S and/or Te are present in the composition it is desired Te/S being less than 0.04%, even for some applications it is desired Te/S being less than 0.02%.

Inventor has found that some applications beneficiates from having:

% Si+% Ti+% P+% S+% Mn+% W+% Hf+% Ti+% Cu+% Sn+% Nb+% Pb+% Cs+% Ta=0-9.8%

In some applications the proviso when % Ceq=0.25-0.44, and % Ti+% Hf+% Zr+% Ta<0.1 then % V<0.85 may be substituted by any of:

when % Ceq=0.25-0.44, and % Ti+% Hf+% Zr+% Ta<0.08 then % V<0.80%;

when % Ceq=0.25-0.44, and % Ti+% Hf+% Zr+% Ta<0.08 then % V<0.78%;

when % Ceq=0.25-0.44, and % Ti+% Hf+% Zr+% Ta<0.08 then % V=0.01-0.80%;

when % Ceq=0.25-0.44, and % Ti+% Hf+% Zr+% Ta<0.08 then % V=0.01-0.78%;

Some applications may beneficiate from having % Cu above 0.01%, in some applications it will be desirable % Cu at least 0.1%, preferably more than 0.2%, more preferably more than 0.4% and even more preferably more than 0.6%. Other applications may beneficiate from having higher levels of % Cu higher than 0.8%, more preferably higher than 0.9% and even more preferably higher than 1.1%. For applications demanding even higher levels of % Cu it will be desirable to have at least 1.6%, preferably more than 2.4%, more preferably more than 2.9% and even more preferably more than 3.1%. On the other hand, according to the present invention in some applications % Cu will be desirable below 3.7%, preferably below 3.1%, more preferably below 2.6% and even more preferably below 1.9%. For other applications, then % Cu will be desirable lower than 1.4%, preferably below 0.8%, more preferably below 0.6% and even more preferably below 0.2%. For some applications the inventor has found that it is desirable % Cu being absent from the composition.

Inventor has found that for several applications it is desired having % Cu between 0 and 3.4%, normally % Cu between 0 and 1.8%, and even % Cu between 0.01 and 1.6%.

Inventor has found that some applications beneficiates from having % Cu+% Co+% Al+% Ti>0.6, normally in some applications % Cu+% Co+% Al+% Ti>0.8, and even for some applications % Cu+% Co+% Al+% Ti>1.1.

Any of the above-described applications corresponds with different embodiments of the steel composition and can be combined with any other embodiment herein described in any combination, to the extent that the respective features are not incompatible.

Another preferred embodiment of the invention refers to a steel according to any one of having the following composition, all percentages being indicated in weight percent:

| | | | |
|---|---|---|---|
| % C_{eq} = 0.4-4 | % C = 0.4-4 | % N = 0-1 | % B = 0-4 |
| % Cr = 0-11 | % Ni = 0-12 | % Si = 0-2.5 | % Mn = 0-6 |
| % A1 = 0-2.5 | % Mo = 0-10 | % W = 0-6 | % Ti = 0-2 |
| % Ta = 0-3 | % Zr = 0-4 | % Hf = 0-3 | % V = 0-12 |
| % Nb = 0-3 | % Cu = 0-2 | % Co = 0-12 | % P = 1.5-10 |

the rest consisting of iron and trace elements, wherein

% Ceq=% C+0.86*% N+1.2*% B,

In another aspect, the invention refers to a steel having the above composition having high levels of toughness properties even for large cross-sections. In an embodiment the steel of the above composition is a hot work steel. In an embodiment the steel of the above composition is a hot work tool steel. In an embodiment the steel of the above composition is at least partially martensitic. In another embodiment the steel of the above composition is at least partially bainitic.

As previously explained in the meaning of this text, trace elements refer to any element, otherwise indicated, in a quantity less than 2%. For some applications, trace elements are preferable to be less than 1.4%, more preferable less than 0.9% and sometimes even more preferable to be less than 0.78%. Possible elements considered to be trace elements are H, Li, Na, K, Rb, Cs, Fr, Be, Mg, Ca, Sr, Ba, Ra, Sc, Y, La, Ac, Tc, Re, Ru, Os, Rh, Ir, Pd, Pt, Ag, Au, Zn, Cd, Hg, Ga, In, Tl, Ge, Sn, Pb, As, Sb, Bi, O, S, Se, Te, Po, F, Cl, Br, I, At, He, Ne, Ar, Kr, Xe, Rn, Ce, Pr, Nd, Pm, Sm, Eu, Gd, Tb, Dy, Ho, Er, Tm, Yb, Lu, Th, Pa, U, Np, Pu, Am, Cm, Bk, Cf, Es, Fm, Md, No, Lr alone and/or in combination. For some applications, some trace elements or even trace elements in general can be quite detrimental for a particular relevant property (like it can be the case sometimes for thermal conductivity and toughness). For such applications it is desirable to keep trace elements below a 0.4%, preferably below a 0.2%, more preferably below 0.14% or even below 0.06%. Needless to say being below a certain quantity includes also the absence of the element. In many applications, the absence of most of the trace elements or even all of them is obvious and/or desirable. As mentioned every trace element is considered a single entity and thus very often for a given application different trace elements will have different maximum weight percent admissible values. Trace elements can be added intentionally to search for a particular functionality including also cost reduction or its presence (when present) can be unintentional and related mostly to impurity of the alloying elements and scraps used for the production of the alloy. The reason for the presence of different trace elements can be different for one same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

In general the inventor has found that for some applications in the steels of the above composition, % C will be desired at levels above 0.21%, preferably higher than 0.51%, more preferably higher than 0.6% and even more preferably higher than 0.72%. Depending on the final application, for some applications it will be desirable that % C is at the levels above 0.82%, preferably higher than 0.9%, more preferably higher than 1.12% and even more preferably higher than 1.20%. For applications requiring higher levels of % C, for example for some applications where high resistance to wear is necessary amongst others, it will be desirable to have % C higher than 1.6%, preferably higher than 2.1%, more preferably higher than 2.8% and even more preferably higher than 3.2%. On the other hand too high % C contents have other drawbacks, which have to be balanced depending on the final requirements, for example, % C too high lead to impossibility to attain the required nature and perfection of carbides (nitrides, borides, oxides or combinations) regardless of the heat treatment applied. Therefore in some applications % C is desirable to be maintained below 3.4%, preferably lower than 2.9%, more preferably lower than 2.3% and even more preferably lower than 1.9%. If high demanding applications in this sense are required, applications very sensible to % C content, for example applications requiring good levels of toughness, it will be desirable for some applications to have % C lower than 1.8%, preferably lower than 1.6%, more preferably lower than 1.2% and even more preferably lower than 0.9%.

In general the inventor has found that for the steels of the above composition, in some applications % Ceq will be desired at levels above 0.21%, preferably higher than 0.51%, more preferably higher than 0.59% and even more preferably higher than 0.7%. Depending on the final application, for some applications it will be desirable that % Ceq is at the levels above 0.8%, preferably higher than 0.9%, more preferably higher than 1.10% and even more preferably higher than 1.2%. For applications requiring higher levels of % Ceq, it will be desirable to have % Ceq higher than 1.6%, preferably higher than 2.1%, more preferably higher than 2.8% and even more preferably higher than 3.2%. On the other hand too high % Ceq contents have other drawbacks, which have to be balanced depending on the final requirements. Therefore in some applications % Ceq is desirable to be maintained below 3.4%, preferably lower than 2.9%, more preferably lower than 1.9% and even more preferably lower than 2.3%. If high demanding applications in this sense are required, applications very sensible to % Ceq content, for example applications requiring good levels of toughness, it will be desirable for some applications to have % Ceq lower than 1.8%, preferably lower than 1.6%, more preferably lower than 1.2% and even more preferably lower than 0.9%.

In this sense, the inventor has found that in some applications of the steels of the above composition % N will be desired at levels above 0.008%, preferably higher than 0.08%, more preferably higher than 0.1% and even more preferably higher than 0.3% depending on the final application, On the other hand for other applications too high levels of % N may not be desirable. Therefore in some applications % N has to be lower than 0.6%, preferably lower than 0.35%, more preferably lower than 0.1% and even more preferably lower than 0.01%. For some embodiments of the present invention the inventor has found that it is desirable % N being absent from the composition.

In this sense, the inventor has found that in some applications of the steels of the above composition % B will be desired at levels above 0.08%, preferably higher than 0.3%, more preferably higher than 1.2% and even more preferably higher than 2.10% depending on the final application, On the other hand for other applications too high levels of % N may not be desirable. Therefore for the present invention % N has to be lower than 2.8%, preferably lower than 1.7%, more preferably lower than 0.8% and even more preferably lower than 0.1%. For some embodiments of the present invention the inventor has found that it is desirable % B being absent from the composition.

Another element that can be used as carbide former is % Cr. If used depending on the final aim, in some embodiments for the steel of the above composition it will be desirable at least more than 1.3% more preferably more than 2.6% and even more preferably more than 3.4%. For superior levels, in some embodiments it will be desirable at least 4.1%, preferably more than 4.6%, more preferably more than 5.1% and even more preferably more than 5.6%. For other cases in some embodiments is desired more than 6.1%, preferably more than 6.7 and even more preferably more than 7.2%. On the other hand, in some embodiments % Cr is desirable below 9.4%, preferably less than 8.6%, more preferably less than 7.9% and even more preferably less than 6.4%. In some embodiments a lower chromium content is desired, in some embodiments % Cr is desired bellow 4.4, in some embodiments preferably bellow 2.7, in some embodiments preferably bellow 1.9 and even for some embodiments % Cr is desirable being too low and even absent from the steel of the above composition.

Inventor has found that for certain applications it is desired having % Cr between 0 and 9.7%, in other applications is desired normally % Cr between 0 and 8.6%, and even in other applications is desired a % Cr between 0 and 7.9%.

In this sense, the inventor has found that for the steels of the above composition in some embodiments, % Ni will be desired at levels above 0.01%, preferably higher than 0.7%, more preferably higher than 1.10% and even more preferably higher than 1.6%. Depending on the final application, if high hardenability for example is sought, in some applications it will be desirable that % Ni is at the levels above 2.6%, preferably higher than 3.1%, more preferably higher than 4.6% and even more preferably higher than 5.3%. For some applications it will be desirable to have % Ni even higher than 6.1%, preferably higher than 6.7%, more preferably higher than 7.1% and even more preferably higher than 7.6%. On the other hand for some applications too high levels of % Ni may not be desirable. Therefore for some applications of the steel of the above composition % Ni has to be lower than 9.8%, preferably lower than 8.4%, more preferably lower than 7.3% and even more preferably lower than 6.9%. Depending on the final application, in some applications it will be desirable that % Ni is at the levels below 6.3%, preferably lower than 5.8%, more preferably lower than 4.3% and even more preferably lower than 2.3%. For some application, for example if requiring some thermal conductivity, it will be desirable to have % Ni lower than 2.1%, preferably lower than 1.4%, more preferably lower than 0.4% and even more preferably lower than 0.1%. For some embodiments of the present invention the inventor has found that it is desirable % Ni being absent from the composition.

Inventor has found that for several applications it is desired having Ni between 0 and 9.6%, in other applications it is desired normally % Ni between 0 and 8.6%, and even % Ni between 0.01 and 7.9%.

For the steels of the above composition, depending on the final application, if % Si needs to be present for the seek of a special property, in some applications then % Si will be desirable to be at least 0.01%, preferably more than 0.1%, more preferably more than 0.3% and even more preferably more than 0.6%. For high levels of % Si, in some applications it will be desirable at least 0.9% Si, preferably more than 1.1%, more preferably more than 1.6% and even more preferably more than 1.8%. For applications where % Si is detrimental, then in some applications % Si is desirable below 2.1%, preferably below 1.6%, more preferably less than 1.2% and even more preferably below 0.9%. For highly demanding applications, for example if cleanliness of the steel is to be optimized or toughness is to be increased, amongst many other cases, in some embodiments then % Si is desirable to be below 0.8%, preferably below 0.6%, more preferably below 0.2% and even more preferably below 0.1%.

For some embodiments of the present invention the inventor has found that it is desirable % Si being absent from the composition.

Inventor has found that for several applications it is desired having % Si between 0 and 1.9%, for some applications normally is desired having % Si between 0 and 1.4 in other applications it is desired a higher minimum % Si content, for these applications is desired normally % Si between 0.01 and 1.4%, and even % Si between 0.1 and 1.2%.

Another important element to control for some applications of the steel of the above composition is % Mn. The inventor has found that in some embodiments, % Mn will be desired at levels above 0.001%, preferably higher than 0.1%, more preferably higher than 0.3% and even more preferably higher than 0.6%. Depending on the final application, it will be desirable in some applications that % Mn is at the levels above 1.2%, preferably higher than 1.6%, more preferably higher than 2.2% and even more preferably higher than 3.1%. Therefore for some applications % Mn has to be lower than 5.6%, preferably lower than 4.9%, more preferably lower than 4.3% and even more preferably lower than 2.6%.

Depending on the final application, for some cases it will be desirable that % Mn is at the levels below 1.9%, preferably lower than 1.4%, more preferably lower than 0.8% and even more preferably lower than 0.3%. For some embodiments of the present invention the inventor has found that it is desirable % Mn being absent from the composition.

Inventor has found that for several applications it is desired having % Mn between 0 and 4.6%, normally for some applications is desired % Mn between 0 and 3.8, in other applications it is desired a higher minimum % Mn content, for these applications is desired normally % Mn between 0.01 and 3.9%, and even % Mn between 0.1 and 3.4%. % Al can be used with different aims. The inventor has found that for the steels of the above composition, depending on the final application % Al can be desirable. For applications requiring low levels of % Al, such as applications where % Al is used for example as a precipitating element for i.e increasing hardness, among many other intends, % Al will be desirable at levels not very high, at least 0.1%, preferably more than 0.3%, more preferably more than 0.4% and even more preferably more than 0.6%. For some applications requiring low to intermediate levels of % Al, such as for example applications where % Al is used as a protective film against oxidation and decarburation at high temperatures, then % Al is desirable around 0.7%, preferably higher than 1.1%, more preferably higher than 1.6% and even more preferably higher than 1.9%. On the contrary, there are some applications which suffer from high values of % Al. If that is the case and other aspects have to be considered, then % Al will be desirable below 2.3%, preferably below 1.9%, more preferably below 1.4% and even more preferably below 0.9%. For other demanding applications, then % Al should be lower than 0.7%, preferably below than 0.4%, more preferably below 0.3% and even more preferably below 0.1%. For some applications it may also be desirable to have absence of % Al.

In some applications it is desired to have % Al between 0 and 1.9%, normally in some application % Al between 0 and 1.6 and even in some applications % Al between 0 and 1.4.

Inventor has found that for several applications it is desired having a minimum content of % Al in the composition of at least 0.01%. for these applications it is desired having % Al between 0.01 and 2.4%, normally % Al between 0.1 and 2.1%, and even % Al between 0.1 and 1.8%.

Regarding carbide formers, % Mo can be used as carbide former. Then for some applications of the steels of the above composition it will be desirable at least 0.1%, preferably more than 0.3%, more preferably more than 0.9% and even more preferably more than 1.3%. In some other cases, % Mo will be desirable et least 1.8%, preferably more than 2.4%, more preferably more than 2.8% and even more preferably more than 3.2%.

Depending on the final application, % Mo will be desirable to be below 8.4%, preferably below 7.6%, more preferably below 6.4% and even more preferably below 4.8%. For some embodiments of the present invention the inventor has found that it is desirable % Mo being absent from the composition.

Inventor has found that for several applications it is desired having % Mo between 0 and 7.6%, normally for some applications % Mo between 0 and 6.4, and even in some applications % Mo between 0 and 5.6% in other applications it is desired a higher minimum % Mo content, for these applications is desired normally % Mo between 0.01 and 4.6%, and even % Mo between 0.1 and 3.7%.

Regarding carbide formers, % W can also be used, amongst many other uses, against wear; in such cases % W will be desirable at least 0.01%, preferably more than 0.3%, more preferably more than 0.8% and even more preferably more than 1.10%. In some other cases, % W will be desirable at least 1.3%, preferably more than 1.6%, more preferably more than 1.9% and even more preferably more than 2.3%. Depending on the final application, in some applications % W will be desirable to be below 4.3%, preferably below 3.6%, more preferably below 2.9% and even more preferably below 2.10%. In some applications lower % W is desired, in some applications below 1.8%, in some applications below 1.3 and even in other applications below 0.8% For some embodiments of the present invention the inventor has found that it is desirable % W being absent from the composition.

Inventor has found that for several applications it is desired having % W between 0 and 4.6%, normally for some applications % W between 0 and 3.7, and even for some application % W between 0 and 2.8 in other applications it is desired a higher minimum % W content, for these applications is desired normally % W between 0.01 and 4.6%, and even % W between 0.1 and 3.7%.

The inventor has found that for the steels of the above composition, % Ti can be desired depending on final application. In such cases, % Ti will be desired at least 0.01%, preferably more than 0.1%, more preferably more than 0.3% and even more preferably more than 0.6%. In some instances for some applications it may be desirable to have at least 0.8%, preferably more than 1.1%, more preferably more than 1.3% and even more preferably more than 1.6%. There are some applications where a low % Ti is desired then % Ti is preferable to be less than 1.8%, preferably less than 1.4%, more preferably less than 1.1% and even more preferably less than 0.8%. For high demanding applications, it will be desirable to be less than 0.6%, preferably less than 0.4%, more preferably less than 0.2% and even more preferably less than 0.01%. For some embodiments of the present invention the inventor has found that it is desirable % Ti being absent from the composition.

Inventor has found that for several applications it is desired having % Ti between 0 and 1.6%, in some applications normally between 0 and 1.3% in other applications it is desired a higher minimum % Ti content, for these applications is desired normally % Ti between 0.1 and 1.3%, and even % Ti between 0.01 and 0.9%.

For some applications it is desired % Ti+% Nb+% Hf+% Zr+% Ta+% Al above 0.001%, normally in some applications % Ti+% Nb+% Hf+% Zr+% Ta+% Al above 0.01%, and even % Ti+% Nb+% Hf+% Zr+% Ta+% Al above 0.10%

For some applications it is desired % Ti+% Nb+% Hf+% Zr+% Ta+% Al=0-4, normally in some applications % Ti+% Nb+% Hf+% Zr+% Ta+% Al=0.01-4, and even % Ti+% Nb+% Hf+% Zr+% Ta+% Al=0.1-3%.

For some embodiments of the present invention the inventor has found that it is desirable any of % Nb, % Hf, % Zr and/or % Ta being absent from the composition.

For some applications it is desired % Nb+% Hf+% Zr+% Ta above 0.001%, normally in some applications % Nb+% Hf+% Zr+% Ta above 0.01%, and even % Nb+% Hf+% Zr+% Ta above 0.10%.

For some applications it is desired % Nb+% Hf+% Zr+% Ta=0-4%, normally in some applications % Nb+% Hf+% Zr+% Ta=0.01-4%, and even % Nb+% Hf+% Zr+% Ta=0.1-3%.

Regarding % V, in some applications it will be desirable at least 0.01%, preferably more than 0.1%, more preferably more than 0.3% and even more preferably more than 0.9%. For some applications intermediate levels, are desired at least 1.3%, preferably more than 1.9%, more preferably more than 2.4% and even more preferably more than 3.1%. For some applications high levels of % V are desired, at least 3.8%, preferably more than 4.3%, more preferably more than 5.1% and even more preferably more than 7.3%. For some applications it will be desirable less than 9.1%, preferably less than 8.4%, more preferably less than 7.6% and even more preferably less than 6.3%. Other preferred ranges for some embodiments will be less than 4.9%, preferably less than 3.7%, more preferably less than 2.8% and even more preferably less than 1.6%. For some applications low levels of % V will be desirable less than 1.2%, preferably less than 0.8%, more preferably less than 0.4% and even more preferably less than 0.2%. For some applications lower % V are desired, preferably below 0.1%, and even below 0.01% and in some instances even absent.

Inventor has found that for several applications it is desired having % V between 0 and 7.9%, in some applications normally between 0 and 6.7% in other applications it is desired a higher minimum % V content, for these applications is desired normally % V between 0.1 and 8.3%, and even % V between 0.01 and 7.2%.

The inventor has found that for the steels of the above composition, % Cu can be desired depending on final application. In such cases, for some applications % Cu will be desired at least 0.0010%, preferably more than 0.010%, more preferably more than 0.10% and even more preferably more than 0.4%. In some instances for some applications it may be desirable to have at least 0.6%, preferably more than 0.9%, more preferably more than 1.10% and even more preferably more than 1.3%. There are some applications where a low % Cu is desired then % Cu is preferable to be less than 1.7%, preferably less than 1.3%, more preferably less than 0.9% and even more preferably less than 0.8%. For high demanding applications, it will be desirable % Cu to be less than 0.6%, preferably less than 0.3%, more preferably less than 0.1% and even more preferably less than 0.09%. For some embodiments of the present invention the inventor has found that it is desirable % Cu being absent from the composition.

Inventor has found that for several applications it is desired having % Cu between 0 and 1.7%, in some applications normally between 0 and 1.2% in other applications it is desired a higher minimum % Cu content, for these applications is desired normally % Cu between 0.01 and 1.4%, and even % Ti between 0.01 and 1.2%.

Inventor has found that for the steels of the present invention, % Co can be desired in some applications. For applications when for example, some tempering resistance at high temperature is required, % Co will be desired to be at least 0.14%, preferably more than 0.29%, more preferably more than 0.54% and even more preferably more than 0.6%.

Depending on the final application, it can be desirable that % Co is at the levels above 0.8%, preferably higher than 0.9%, more preferably higher than 1.2% and even more preferably higher than 1.6%. For other applications, it will be desirable to have % Co higher than 1.9%, preferably higher than 2.7%, more preferably higher than 3.2% and even more preferably higher than 4.4%. On the other hand, % Co increases the critical cooling rate of steel and accelerates pearlitic transformation thus reducing hardenability of the steel, therefore, depending on the application too high levels of % Co may not be desirable. Therefore for the present application % Co will be desirable to be lower than 6.8%, preferably lower than 5.9%, more preferably lower than 4.7% and even more preferably lower than 3.4%.

Depending on the final application, it will be desirable that % Co is at the levels below 2.8%, preferably lower than 1.9%, more preferably lower than 1.4% and even more preferably lower than 1.1%. If even lower levels are required, then it will be desirable to have % Co lower than 0.8%, preferably lower than 0.6%, more preferably lower than 0.44% and even more preferably lower than 0.12% and even absence of it.

Inventor has found that for several applications it is desired having % Co between 0 and 6.4%, in other applications it is desired a higher minimum % Co content, for these applications is desired normally % Co between 0.01 and 5.3%, and even % Co between 0.1 and 4.6%.

In this sense, the inventor has found that for the steels of the above composition in some embodiments, % P will be desired at levels above 1.6%, preferably higher than 1.8%, more preferably higher than 2.1% and even more preferably higher than 2.3%. Depending on the final application, if higher % P are desired, in some applications it will be desirable that % P is at the levels above 2.6%, preferably higher than 3.2%, more preferably higher than 4.3% and even more preferably higher than 5.1%. For some applications it will be desirable to have % P even higher than 5.8%, preferably higher than 6.3%, more preferably higher than 6.9% and even more preferably higher than 7.4%. On the other hand for some applications too high levels of % P may not be desirable. Therefore for some applications of the steel of the above composition % P has to be lower than 9.2%, preferably lower than 8.6%, more preferably lower than 7.4% and even more preferably lower than 6.8%. Depending on the final application, in some applications it will be desirable that % P is at the levels below 6.2%, preferably lower than 5.7%, more preferably lower than 4.4% and even more preferably lower than 3.6%. For some application, it will be desirable to have % P lower than 2.9%, preferably lower than 2.3%, more preferably lower than 2.1% and even more preferably lower than 1.9%.

Inventor has found that for several applications it is desired having % P between 1.7 and 9.4%, in other applications it is desired normally % P between 1.7 and 8.6%, and even % P between 1.9 and 7.9%.

Inventor has found that some applications beneficiates from having % Co+% Cu+% V+% Ti+% P>1.6%, normally for some applications % Co+% Cu+% V+% Ti+% P>1.8%, and even for some applications % Co+% Cu+% V+% Ti+% P>2.10%.

Inventor has found that for several applications it is desired having % Cu+% Co+% Al+% Ti>0.010%, normally for some applications % Cu+% Co+% Al+% Ti>0.1% and even for some applications % Cu+% Co+% Al+% Ti>0.2%.

Inventor has found that several applications beneficiates from having % V+% Al+% Ti>0.0010%, normally for some applications % V+% Al+% Ti>0.010% and even for some applications % V+% Al+% Ti>0.1%.

Inventor has found that in some applications the above steel presents a corrosion resistance equal or higher than conventional stainless steels.

Any of the above-described applications corresponds with different embodiments of the steel composition and can be combined with any other embodiment herein described in any combination, to the extent that the respective features are not incompatible.

Hence, according to another preferred embodiment of the present invention the steels can have the following composition, all percentages being indicated in weight percent:

| | | | |
|---|---|---|---|
| % C_{eq} = 0.4-2.9 | % C = 0.4-2.9 | % N = 0-0.6 | % B = 0-4 |
| % Cr = 2.1-11 | % Ni = 0-9.5 | % Si = 0-4 | % Mn = 0-12 |
| % Al = 0-9 | % Mo = 0-6 | % W = 0-6.2 | % Ti = 0-4.9 |
| % Ta = 0-3 | % Zr = 0-6 | % Hf = 0-3 | % V = 0-12 |
| % Nb = 0-3 | % Cu = 0-6 | % Co = 0-7 | % Lu = 0-2 |
| % La = 0-2 | % Ce = 0-2 | % Nd = 0-2 | % Gd = 0-2 |
| % Sm = 0-2 | % Y = 0-2 | % Pr = 0-2 | % Sc = 0-2 |
| % Pm = 0-2 | % Eu = 0-2 | % Tb = 0-2 | % Dy = 0-2 |
| % Ho = 0-2 | % Er = 0-2 | % Tm = 0-2 | % Yb = 0-2 |

the rest consisting of iron and trace elements wherein,

% Ceq=% C+0.86*% N+1.2*% B,
Wherein % Al+% Si+% Cr+% Ti+% Zr>0.41%

In another aspect, the invention refers to a steel having the above composition having high levels of toughness properties even for large cross-sections. In an embodiment the steel of the above composition is a hot work steel. In an embodiment the steel of the above composition is a hot work tool steel. In an embodiment the steel of the above composition is at least partially martensitic. In another embodiment the steel of the above composition is at least partially bainitic.

In the meaning of this text, trace elements refer to any element, otherwise indicated, in a quantity less than 2%. For some applications, trace elements are preferable to be less than 1.4%, more preferable less than 0.9% and sometimes even more preferable to be less than 0.78%. Possible elements considered to be trace elements are H, Li, Na, K, Rb, Cs, Fr, Be, Mg, Ca, Sr, Ba, Ra, Ac, Tc, Re, Ru, Os, Rh, Ir, Pd, Pt, Ag, Au, Zn, Cd, Hg, Ga, In, Tl, P, S, Ge, Sn, Pb, As, Sb, Bi, O, Se, Te, Po, F, Cl, Br, I, At, He, Ne, Ar, Kr, Xe, Rn, Th, Pa, U, Np, Pu, Am, Cm, Bk, Cf, Es, Fm, Md, No, Lr alone and/or in combination. For some applications, some trace elements or even trace elements in general can be quite detrimental for a particular relevant property (like it can be the case sometimes for thermal conductivity and toughness). For such applications it is desirable to keep trace elements below a 0.4%, preferably below a 0.2%, more preferably below 0.14% or even below 0.06%. Needless to say being below a certain quantity includes also the absence of the element. In many applications, the absence of most of the trace elements or even all of them is obvious and/or desirable. As mentioned every trace element is considered a single entity and thus very often for a given application different trace elements will have different maximum weight percent admissible values. Trace elements can be added intentionally to search for a particular functionality including also cost reduction or its presence (when present) can be unintentional and related mostly to impurity of the alloying elements and scraps used for the production of the alloy. The reason for the presence of different trace elements can be different for one same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

For some applications, there are elements which are optional in the composition such as Nb, Co, Lu, La, Ce, Nd, Gd, Sm, Y, Pr, Sc, Pm, Eu, Tb, Dy, Ho, Er, Tm and/or Yb, this means that these elements may be present or not in the composition, and that they may not be present at the same time. For several applications in order to improve certain properties, one of more of these optional elements may be added to the steel in different weight percentages, but it is not mandatory to have all of them in the steel composition at the same time and it is not mandatory to combine them in their maximum indicated content. In any case the sum of all the elements in the steel composition, shall be 100%.

In general the inventor has found that for the steels of the present invention, % C will be desired at levels above 0.21%, preferably higher than 0.51%, more preferably higher than 0.6% and even more preferably higher than 0.72%. Depending on the final application, it will be desirable that % C is at the levels above 0.82%, preferably higher than 0.95%, more preferably higher than 1.12% and even more preferably higher than 1.20%. For applications requiring higher levels of % C, for example applications where high resistance to wear is necessary amongst others, it will be desirable to have % C higher than 1.26%, preferably higher than 1.41,%, more preferably higher than 1.62,% and even more preferably higher than 1.72%. On the other hand too high % C contents have other drawbacks, which have to be balanced depending on the final requirements, for example, % C too high lead to impossibility to attain the required nature and perfection of carbides (nitrides, borides, oxides or combinations) regardless of the heat treatment applied. Therefore in some cases % C is desirable to be maintained below 2.6%, preferably lower than 2.02%, more preferably lower than 1.93% and even more preferably lower than 1.87%. If high demanding applications in this sense are required, applications very sensible to % C content, for example applications requiring good levels of toughness, it will be desirable to have % C lower than 1.81%, preferably lower than 1.79%, more preferably lower than 1.21% and even more preferably lower than 0.9%.

In general the inventor has found that for the steels of the present invention, % Ceq will be desired at levels above 0.21%, preferably higher than 0.51%, more preferably higher than 0.59% and even more preferably higher than 0.72%. Depending on the final application, it will be desirable that % Ceq is at the levels above 0.82%, preferably higher than 0.95%, more preferably higher than 1.12% and even more preferably higher than 1.20%. For applications requiring higher levels of % Ceq, it will be desirable to have % Ceq higher than 1.26%, preferably higher than 1.41,%, more preferably higher than 1.62,% and even more preferably higher than 1.72%. On the other hand too high % Ceq contents have other drawbacks, which have to be balanced depending on the final requirements. Therefore in some cases % Ceq is desirable to be maintained below 2.6%, preferably lower than 2.02%, more preferably lower than 1.93% and even more preferably lower than 1.87%. If high demanding applications in this sense are required, applications very sensible to % Ceq content, for example applications requiring good levels of toughness, it will be desirable to have % Ceq lower than 1.81%, preferably lower than 1.79%, more preferably lower than 1.21% and even more preferably lower than 0.9%.

For many applications the tolerated amount of % C substitution is rather small so that they require % C by itself to be greater than 0.42%, preferably greater than 0.76, more preferably greater than 1.02 and even greater than 1.23. The general maximum levels for % C and % Ceq expressed before are directly applicable here.

Inventor has found that for several applications it is desired having % Ceq between 0.42 and 2.7%, normally % Ceq between 0.46 and 2.7%, and even % Ceq between 0.53 and 2.4%.

Inventor has found that for several applications it is desired having % C between 0.42 and 2.7%, normally % C between 0.46 and 2.7%, and even % C between 0.53 and 2.4%.

In this sense, the inventor has found that for the steels of the present invention, in some applications % N will be desired at levels above 0.008%, preferably higher than 0.08%, more preferably higher than 0.1% and even more preferably higher than 0.3% depending on the final application, On the other hand for other applications too high levels of % N may not be desirable. Therefore for the present invention % N has to be lower than 0.45%, preferably lower than 0.3%, more preferably lower than 0.1% and even more preferably lower than 0.01%. For some embodiments of the present invention the inventor has found that it is desirable % N being absent from the composition.

In this sense, the inventor has found that for the steels of the present invention, in some applications % B will be desired at levels above 0.08%, preferably higher than 0.3%, more preferably higher than 1.2% and even more preferably higher than 2.10% depending on the final application, On the other hand for other applications too high levels of % N may not be desirable. Therefore for the present invention % N has to be lower than 2.8%, preferably lower than 1.7%, more preferably lower than 0.8% and even more preferably lower than 0.1%. For some embodiments of the present invention the inventor has found that it is desirable % B being absent from the composition.

Another important element to control for these applications is % Mn. The inventor has found that for the steels of the present invention, % Mn will be desired at levels above 0.10%, preferably higher than 1.2%, more preferably higher than 2.8% and even more preferably higher than 3.6%. Depending on the final application, it will be desirable that % Mn is at the levels above 4.8%, preferably higher than 6.4%, more preferably higher than 8.4% and even more preferably higher than 9.3%. Therefore for the present invention % Mn has to be lower than 11.2%, preferably lower than 9.7%, more preferably lower than 8.6% and even more preferably lower than 6.4%. Depending on the final application, it will be desirable that % Mn is at the levels below 5.2%, preferably lower than 4.8%, more preferably lower than 3.6% and even more preferably lower than 2.8%.

Inventor has found that for several applications it is desired having % Mn between 0 and 9.6%, in other applications it is desired a higher minimum % Mn content, for these applications is desired normally % Mn between 0.01 and 8.4%, and even % Mn between 0.1 and 8.4%.

In this sense, the inventor has found that for the steels of the present invention, % Ni will be desired at levels above 0.18%, preferably higher than 0.59%, more preferably higher than 1.1% and even more preferably higher than 1.53%. Depending on the final application, if high hardenability for example is sought, it will be desirable that % Ni is at the levels above 3.2%, preferably higher than 3.6%, more preferably higher than 4.8% and even more preferably higher than 5.46%. For some applications it will be desirable to have % Ni even higher than 5.8%, preferably higher than 6.23%, more preferably higher than 6.79% and even more preferably higher than 7.%. On the other hand too high levels of % Ni may not be desirable. Therefore for the present invention % Ni has to be lower than 9.6%, preferably lower than 8.8%, more preferably lower than 7.6% and even more preferably lower than 7.10%. Depending on the final application, it will be desirable that % Ni is at the levels below 6.3%, preferably lower than 5.8%, more preferably lower than 4.3% and even more preferably lower than 2.3%. For some application, for example if requiring some thermal conductivity, it will be desirable to have % Ni lower than 2.1%, preferably lower than 1.41%, more preferably lower than 0.47% and even more preferably lower than 0.12%. For some embodiments of the present invention the inventor has found that it is desirable % Ni being absent from the composition.

Inventor has found that for several applications it is desired having % Ni between 0 and 9.3%, for other certain applications it is desired having a minimum content of % Ni in the composition of at least 0.1%, for these applications is desired normally % Ni between 0.1 and 9.3%, and even % Ni between 0.1 and 8%.

Another element that can be used as carbide former is % Cr. If used depending on the final aim, in some embodiments it will be desirable at least more than 2.3% more preferably more than 2.8% and even more preferably more than 3.6%. For superior levels, is some embodiments it will be desirable at least 5.6%, preferably more than 6.7%, more preferably more than 6.8% and even more preferably more than 7.34%. For other cases more than 8.4%, preferably more than 9.24 and even more preferably more than 9.76%. On the other hand, for the present invention, in some embodiments % Cr is desirable below 9.4%, preferably less than 8.6%, more preferably less than 8.76% and even more preferably less than 6.7%.

Inventor has found that for certain applications it is desired having % Cr between 2.4 and 9.7%, in other applications a minimum lower % Cr content is preferred being higher, for these applications is desired normally % Cr between 2.8 and 9.3%, and even in other applications is desired a % Cr between 4.1 and 9.1%.

Regarding carbide formers, % W can be used, amongst many other uses, against wear; in such cases % W will be desirable at least 0.55%, preferably more than 0.89%, more preferably more than 1.23% and even more preferably more than 1.8%. In some other cases, % W will be desirable at least 2.22%, preferably more than 3.10%, more preferably more than 3.73% and even more preferably more than 4.1%. Depending on the final application, % W will be desirable to be below 5.2%, preferably below 4.6%, more preferably below 4.1% and even more preferably below 3.5%. For some embodiments of the present invention the inventor has found that it is desirable % W being absent from the composition.

Inventor has found that for several applications it is desired having % W between 0 and 5.9%, in other applications it is desired a higher minimum % W content, for these applications is desired normally % W between 0.01 and 4.6%, and even % W between 0.1 and 3.9%. % Mo can also be used as carbide former. Then it will be desirable at least 0.35%, preferably more than 0.48%, more preferably more than 0.96% and even more preferably more than 1.3%. In some other cases, % Mo will be desirable at least 1.8%, preferably more than 2.4%, more preferably more than 2.87% and even more preferably more than 3.6%. Depending on the final application, % Mo will be desirable to be below 5.2%, preferably below 4.7%, more preferably below 3.6% and even more preferably below 2.8%. For some embodiments of the present invention the inventor has found that it is desirable % Mo being absent from the composition.

Inventor has found that for several applications it is desired having % Mo between 0 and 5.4%, in other applications it is desired a higher minimum % Mo content, for these applications is desired normally % Mo between 0.01 and 4.6%, and even % Mo between 0.1 and 3.7%.

The inventor has found that for the steels of the present invention, % Co can be desired in some occasions. For applications when for example, some tempering resistance at high temperature is required, % Co will be desired to be at least 0.14%, preferably more than 0.29%, more preferably more than 0.54% and even more preferably more than 0.68%.

Depending on the final application, it can be desirable that % Co is at the levels above 0.8%, preferably higher than 0.97%, more preferably higher than 1.26% and even more preferably higher than 1.57%. For other applications, it will be desirable to have % Co higher than 1.9%, preferably higher than 2.7%, more preferably higher than 3.2% and even more preferably higher than 4.4%. On the other hand, % Co increases the critical cooling rate of steel and accelerates pearlitic transformation thus reducing hardenability of the steel, therefore, depending on the application too high levels of % Co may not be desirable.

Therefore for the present application % Co will be desirable to be lower than 7%, preferably lower than 5.9%, more preferably lower than 4.7% and even more preferably lower than 3.4%. Depending on the final application, it will be desirable that % Co is at the levels below 2.8%, preferably lower than 1.9%, more preferably lower than 1.4% and even more preferably lower than 1.10%. If even lower levels are required, then it will be desirable to have % Co lower than 0.89%, preferably lower than 0.6%, more preferably lower than 0.44% and even more preferably lower than 0.12% and even absence of it.

Inventor has found that for several applications it is desired having % Co between 0 and 6.4%, in other applications it is desired a higher minimum % Co content, for these applications is desired normally % Co between 0.01 and 5.3%, and even % Co between 0.1 and 4.6%.

The inventor has found that for the steels of the present invention, % Ti can be desired depending on final application. In such cases, % Ti will be desired at least 0.49%, preferably more than 0.68%, more preferably more than 0.82% and even more preferably more than 0.99%. In some instances it may be desirable to have at least 1.32%, preferably more than 1.67%, more preferably more than 2.11% and even more preferably more than 2.86%. For more sophisticated applications, it will be desirable to have more than 3.5%, preferably more than 3.75%, more preferably more than 4.8%. When % Ti is not desired, then is preferable to be less than 6.4%, preferably less than 5.47%, more preferably less than 4.66% and even more preferably less than 3.4%. For high demanding applications, it will be desirable to be less than 2.4%, preferably less than 1.87%, more preferably less than 0.87% and even more preferably less than 0.24%. For some embodiments of the present invention the inventor has found that it is desirable % Ti being absent from the composition.

Inventor has found that for several applications it is desired having % Ti between 0 and 4.6%, in other applications it is desired a higher minimum % Ti content, for these applications is desired normally % Ti between 0.01 and 4.2%, and even % Ti between 0.1 and 3.6%. % Al can be used with different aims. The inventor has found that for the steels of the present invention, depending on the final application % Al can be desirable. For applications requiring low levels of % Al, for example for applications where % Al is used for example as a precipitating element for i.e increasing hardness, amongst many other intends, % Al will be desirable at levels not very high, at least 0.26%, preferably more than 0.33%, more preferably more than 0.43% and even more preferably more than 0.53%. For applications requiring low to intermediate levels of % Al, such as for example applications where % Al is used as a protective film against oxidation and decarburation at high temperatures, then % Al is desirable around 0.78%, preferably higher than 1.22%, more preferably higher than 1.54% and even more preferably higher than 2.03%. For applications requiring intermediate % Al levels, it will be desirable at least 2.94%, preferably more than 3.47%, more preferably more than 4.37% and even more preferably more than 5.39%. Some applications require high levels of % Al; one example is when low conductivity is sought; a way of attaining this could be by means of reducing its density; for such kind of level applications, % Al will be desirable above 6.2%, and even preferably above 7.3%. On the contrary, there are some applications which suffer from high values of % Al. If that is the case and other aspects have to be considered, then % Al will be desirable below 7%, preferably below 5.4%, more preferably below 4.12% and even more preferably below 2.8%. For other demanding applications, then % Al should be lower than 1.5%, preferably below than 0.89%, more preferably below 0.43% and even more preferably below 0.1%.

For some applications it may also be desirable to have absence of % Al.

Inventor has found that for several applications it is desired having a minimum content of % Al in the composition of at least 0.10%, for these applications it is desired having % Al between 0.1 and 16.7%, normally % Al between 0.1 and 16.3%, and even % Al between 0.1 and 15.9%.

Inventor has found that for several applications, it is desirable having more % Mn than % Al, for some applications is also desirable, when % C is lower than 1.65 is desired % Mn-% Al<10.05%, normally % Mn-% Al<9.7, and even for certain applications % Mn-% Al<9.3.

For the steels of the present invention, depending on the final application, if % Si needs to be present for the seek of a special property, then % Si will be desirable to be at least 0.34%, preferably more than 0.87%, more preferably more than 1.06% and even more preferably more than 1.57%. For high levels of % Si, it will be desirable at least 1.99% Si, preferably more than 2.47%, more preferably more than 3.43% and even more preferably more than 3.87%. For applications where % Si is detrimental, then % Si is desirable below 4%, preferably below 3.4%, more preferably less than 2.4% and even more preferably below 1.8%. For highly demanding applications, for example if cleanliness of the steel is to be optimized or toughness is to be increased, amongst many other cases, then % Si is desirable to be below 1.05%, preferably below 0.73%, more preferably below 0.54% and even more preferably below 0.22%. For some embodiments of the present invention the inventor has found that it is desirable % Si being absent from the composition.

Inventor has found that for several applications it is desired having % Si between 0 and 3.4%, in other applications it is desired a higher minimum % Si content, for these applications is desired normally % Si between 0.01 and 2.8%, and even % Si between 0.1 and 1.8%.

The inventor has found that for the steels of the present invention, % Cu can be desired in certain applications, for some applications, % Cu will be desired to be at least 0.14%, preferably more than 0.29%, more preferably more than 0.54% and even more preferably more than 0.68%. Depending on the final application, in some applications it can be desirable that % Cu is at the levels above 0.87%, preferably higher than 0.97%, more preferably higher than 1.26% and even more preferably higher than 1.57%. For other applications, it will be desirable to have % Cu higher than 1.9%, preferably higher than 2.7%, more preferably higher than 3.2% and even more preferably higher than 4.4%. On the other hand, depending on the application too high levels of % Cu may not be desirable.

Therefore in some applications % Cu will be desirable to be lower than 5.4%, preferably lower than 4.7% and even more preferably lower than 3.4%. Depending on the final application, in some applications it will be desirable that % Cu is at the levels below 2.8%, preferably lower than 1.9%, more preferably lower than 1.4% and even more preferably lower than 1.1%. If even lower levels are required, then in some applications it will be desirable to have % Cu lower than 0.89%, preferably lower than 0.6%, more preferably lower than 0.44% and even more preferably lower than 0.12% and even absence of it.

Inventor has found that for several applications it is desired having % Cu between 0 and 4.8%, in other applications it is desired a lower % Cu content, for these applications is desired normally % Cu between 0 and 3.1%, and even % Cu between 0 and 2%.

Regarding % V, in some applications for low levels it will be desirable at least 0.14%, preferably more than 0.57%, more preferably more than 0.61% and even more preferably more than 0.69%. For intermediate levels, in some embodiments it will be desirable at least 0.72%, preferably more than 0.83%, more preferably more than 1.34% and even more preferably more than 2.46%. For high levels of % V in some applications, it will be desirable to at least 4.11%, preferably more than 4.8%, more preferably more than 5.68% and even more preferably more than 7.61%. For the upper limits, in some embodiments it will be desirable less than 12%, preferably less than 10.98%, more preferably less than 8.74% and even more preferably less than 7.36%. Other preferred ranges for some embodiments will be less than 5.74%, preferably less than 3.68%, more preferably less than 2.28% and even more preferably less than 1.32%. For low levels of % V then in some embodiments it will be desirable less than 0.87%, preferably less than 0.63%, more preferably less than 0.47% and even more preferably less than 0.24%. For special cases, it will be desirable even less than 0.14% or even less than 0.05%. Other preferred embodiments where the % C is high (above 0.45%, preferably above 0.46% and even more preferably above 0.57%), % V is preferred to be somehow high, at least more than 0.62%, preferably more than 0.69%, more preferably more than 0.72% and even more preferably more than 0.83%. On the other hand, less than 1 2.3%, preferably less than 11.4%, more preferably less than 9.47% and even more preferably less than 7.68%. If relative high levels of % Cr are also present, for example higher than 2.71%, preferably higher than 3.15%, more preferably higher than 3.87% and even more preferably higher than 4.99% and even more higher than 5.210%, then in an another embodiment it might be preferable % V is low, preferably below 0.58%, more preferably below 0.47%, more preferably below 0.34% and even more preferably below 0.21% and in some instances even absent.

For some applications it is desirable that % Al+% Si+% Cr+% V is at least 2%, preferably more than 2.31%, more preferably more than 2.54% and even more preferably more than 2.87%. If % Al is present, then % Al+% Si+% Cr+% V is desirable at least more than 3.1%, preferably more than 3.4%, more preferably more than 3.67% and even more preferably more than 4%.

For some applications it is desirable that % Al+% Si+% Cr+% Ti+% Zr is at least 4.1%, preferably more than 5.2%, more preferably more than 6.1% and even more preferably more than 8.2%.

For some embodiments, inventor has found that Ta, Zr, Hf, Nb, La, Ce are optional elements in the composition of the steel, and in some embodiments any of them and/or all of them may be absent from the composition.

Inventor has found that for several applications, it may be desired having % Ta+% Zr+% Hf+% Nb+% La+% Ce=0-4.2%.

Inventor has found that for several applications, it may be desired having % Ta+% Zr+% Hf+% Nb+% La+% Ce=0-4.2=0-3.7%.

Inventor has found that for several applications, it may be desired having % Ta+% Zr+% Hf+% Nb+% La+% Ce=0-4.2=0-2.2%.

Inventor has found that for several applications, it may be desired having % Ta+% Zr+% Hf+% Nb+% La+% Ce being at least 0.001%, normally for some applications Ta+% Zr+% Hf+% Nb+% La+% Ce being at least 0.01%, and even for several applications Ta+% Zr+% Hf+% Nb+% La+% Ce being at least 0.1%.

Inventor has found that for several applications, it may be desired having % Ta+% Zr+% Hf+% Nb+% La+% Ce=0.001-2.2%.

Inventor has found that for several applications, it may be desired having % Cr+% Cu+% Co higher than 0.01%, normally % Cr+% Cu+% Co>0.10%, in other applications is preferred having % Cr+% Cu+% Co>1.2% and even for certain applications is preferred % Cr+% Cu+% Co>3.1%.

For certain applications, inventor has found that it is desired having one of the following:

% Nb+% Co+% Lu+% La+% Ce+% Nd+% Gd+% Sm+% Y+% Pr+% Sc+% Pm+% Eu+% Tb+% Dy+% Ho+% Er+% Tm+% Yb=0-10%

% Nb+% Co+% Lu+% La+% Ce+% Nd+% Gd+% Sm+% Y+% Pr+% Sc+% Pm+% Eu+% Tb+% Dy+% Ho+% Er+% Tm+% Yb=0-8%

% Nb+% Co+% Lu+% La+% Ce+% Nd+% Gd+% Sm+% Y+% Pr+% Sc+% Pm+% Eu+% Tb+% Dy+% Ho+% Er+% Tm+% Yb=0-6%

For certain applications, inventor has found that it is desired having:

% V+% Nb+% Sn+% Si+% Ti+% Co+% W+% Mo=0-9.8%.

Inventor has found that for some applications it is desired having % V+% Nb+% Sn+% Si+% Ti+% Co+% W+% Mo=0-9.8% being at least 0.001%, normally for some applications is desired having % V+% Nb+% Sn+% Si+% Ti+% Co+% W+% Mo=0-90.8% being at least 0.01%, and even for certain applications is desired having % V+% Nb+% Sn+% Si+% Ti+% Co+% W+% Mo=0-9.8% being at least 0.1%.

There are also other applications, wherein a minimum content of the following elements is desired, for these applications: % V+% Nb+% Sn+% Si+% Ti+% Co+% W+% Mo=0.1-9.8%.

Any of the above-described applications corresponds with different embodiments of the steel composition and can be combined with any other embodiment herein described in any combination, to the extent that the respective features are not incompatible.

In an aspect of the present invention, the inventor has found that for some applications it is very interesting to have a material capable of having a big hardness increase with a temperature treatment that does not involve quenching and where all involved temperatures to harden the material after machining or shaping in general (even if the shaping is only a part of the total shaping intended, and part is performed in the hard condition), can remain below the austenitization temperature. The inventor has found that a way to achieve such feature consists on the selection of the right composition within the following range followed by the right thermomechanical processing:

| | | | |
|---|---|---|---|
| % Ceq = 0.41-2.9 | % C = 0.41-2.9 | % N = 0-0.4 | % B = 0-1.3 |
| % Cr = 0-11.9 | % Ni = 0-5.9 | % Si = 0-3.9 | % Mn = 1.6-11.9 |
| % Al = 0-4.9 | % Mo = 0-4.4 | % W = 0-7.8 | % Ti = 0-4.9 |
| % Ta = 0-4.9 | % Zr = 0.6-8.9 | % Hf = 0-14 | % V = 0-9.9 |
| % Nb = 0-2.8 | % Cu = 0-3.9 | % Co = 0-2.9 | % Zreq = 0.6-8.9 |
| % La = 0-0.2 | % Ce = 0-5 0.2 | % Cs = 0-0.2 | % Moeq = 0-4.4 |

the rest consisting of iron and trace elements wherein,

% Ceq=% C+0.86*% N+1.2*% B; and

% Zreq=% Zr+½% Hf; and

% Moeq=% Mo+½% W; and

% Mn+% Zr+% Ta+% Hf+% Ti>4%

In this document trace elements is considered any element, not explicitly indicated and in an amount of less than 0.9%. For some particular embodiments trace elements are required to be less than 0.4%. For some particular embodiments trace elements are required to be less than 0.18%. For some particular embodiments trace elements are required to be less than 0.06%. As previously mentioned, the notion less than an amount includes the explicit absence. Possible elements considered as trace elements are: H, Li, Na, K, Rb, Fr, Be, Mg, Ca, Sr, Ba, Ra, Ac, Tc, Re, Ru, Os, Rh, Ir, Pd, Pt, Ag, Au, Zn, Cd, Hg, B, Ga, In, Tl, Ge, Sn, Pb, P, As, Sb, Bi, O, S, Se, Te, Po, F, Cl, Br, I, At, He, Ne, Ar, Kr, Xe, Rn, Th, Pa, U, Np, Pu, Am, Cm, Bk, Cf, Es, Fm, Md, No and Lr alone and/or in combination. In many applications, the absence of most trace elements or even its entirety is obvious and/or desirable. As mentioned each trace element is considered an entity and therefore in many embodiments of the present invention different trace elements have different admissible amounts. The trace elements may have an intentional presence to look for a given functionality described in the state of the art or even cost reduction or alternatively the presence of the trace element (if present) may also be accidental and related to the lack of purity of the alloying and scrap elements used to produce the material. The reason for the presence of different trace elements may be different for the same alloy.

Inventor has found that for some applications all trace elements as a sum are preferred in a content below 2.0%, in other applications below 1.4%, in other applications below 0.8%, in other applications below 0.2%, in other applications below 0.1% or even below 0.06%.

Inventor has found that for some applications each individual trace element is preferred in a content below 2.0%, in other applications below 1.4%, in other applications below 0.8% in other applications below 0.2%, in other applications below 0.1% or even below 0.06%.

Carbon equivalent is important and of great importance in determining the majority of relevant properties. When high wear resistance is required the % Ceq cannot be too low.

For some embodiments of the present invention, the inventor has found that it is desirable % Ceq greater than 0.31%. For some embodiments of the present invention, the inventor has found that it is desirable % Ceq greater than 0.46%. For some embodiments of the present invention, the inventor has found that it is desirable % Ceq greater than 0.61%. For some embodiments of the present invention, the inventor has found that it is desirable % Ceq greater than 0.81%. For some embodiments of the present invention, the inventor has found that it is desirable % Ceq greater than 0.92%. When high toughness and/or elongation is required It is often desirable % Ceq not being too high. For some embodiments of the present invention the inventor has found that it is desirable % Ceq less than 1.98%. For some embodiments of the present invention the inventor has found that it is desirable % Ceq less than 1.48%. For some embodiments of the present invention the inventor has found that it is desirable % Ceq less than 0.98%. For some embodiments of the present invention the inventor has found that it is desirable % Ceq less than 0.59%.

Inventor has found that for several applications it is desired having % Ceq between 0.22 and 1.49%, for some applications % Ceq between 0.22 and 0.88%, and for some applications even % Ceq between 0.25 and 0.38%.

When high wear resistance is required the % C cannot be too low. For some embodiments of the present invention, the inventor has found that it is desirable % C greater than 0.31%.

For some embodiments of the present invention, the inventor has found that it is desirable % C greater than 0.46%. For some embodiments of the present invention, the inventor has found that it is desirable % C greater than 0.61%. For some embodiments of the present invention, the inventor has found that it is desirable % C greater than 0.81%. For some embodiments of the present invention, the inventor has found that it is desirable % C greater than 0.92%. When high toughness and/or elongation is required It is often desirable % C not being too high. For some embodiments of the present invention the inventor has found that it is desirable % C less than 1.98%. For some embodiments of the present invention the inventor has found that it is desirable % C less than 1.48%. For some embodiments of the present invention the inventor has found that it is desirable % C less than 0.98%. For some embodiments of the present invention the inventor has found that it is desirable % C less than 0.59%.

Inventor has found that for several applications it is desired having % C between 0.22 and 1.49%, for some applications % C between 0.22 and 0.88%, and for some applications even % C between 0.25 and 0.38%.

Sometimes within the carbon equivalent, it is desired % N content not being excessive. For some embodiments of the present invention the inventor has found that it is desirable % N less than 0.09%. For some embodiments of the present invention the inventor has found that it is desirable % N less than 0.004%. For some embodiments of the present invention the inventor has found that it is desirable % N being absent. For some embodiments of the present invention % N can help to improve hardenability. For some embodiments of the present invention, the inventor has found that it is desirable % N greater than 0.06%. For some embodiments of the present invention, the inventor has found that it is desirable % N greater than 0.110%.

Sometimes within the carbon equivalent, it is desired % B content not being excessive. For some embodiments of the present invention the inventor has found that it is desirable % B less than 0.03%. For some embodiments of the present invention the inventor has found that it is desirable % B less than 0.019%. For some embodiments of the present invention the inventor has found that it is desirable % B less than 0.009%. For some embodiments of the present invention the inventor has found that it is desirable % B being absent. For some embodiments of the present invention % B can help to improve hardenability, especially retarding ferritic transformation. For some embodiments of the present invention, the inventor has found that it is desirable % B greater than 0.002%. For some embodiments of the present invention, the inventor has found that it is desirable % B greater than 0.0042%.

For some embodiments of the present invention, the inventor has found that it is desirable % B greater than 0.006%.

Chromium content is important and has a great importance in determining the majority of relevant properties, since its presence in secondary carbides is almost always of great influence. When mechanical resistance is required without excessive sacrifice of toughness, % Cr cannot be too low. For some embodiments of the present invention, the inventor has found that it is desirable % Cr greater than 3.6%. For some embodiments of the present invention, the inventor has found that it is desirable % Cr greater than 5.2%. For some embodiments of the present invention, the inventor has found that it is desirable % Cr greater than 6.5%. When high toughness and/or elongation is required often is desired % Cr not being too high. This is further the case when the presence of other carbide formers like % V, % Mo and/or % W is high. For some embodiments of the present invention the inventor has found that it is desirable % Cr less than 9.5%. For some embodiments of the present invention the inventor has found that it is desirable % Cr less than 8.5%. For some embodiments of the present invention the inventor has found that it is desirable % Cr less than 4.9%.

Manganese content is important and has a great importance in the present invention.

Inventor has found that surprisingly from a specific content of % Mn, especially when properly combined with % Zr, % Ti, % Si, % V, and/or % Cr, the materials of the present aspect of the invention can present a high hardness increase upon the application of a low temperature heat treatment. The critical content depends on the specific quantities of the other elements in the alloy. For some embodiments of the present invention, the inventor has found that it is desirable % Mn greater than 1.8%. For some embodiments of the present invention, the inventor has found that it is desirable % Mn greater than 3.6%. For some embodiments of the present invention, the inventor has found that it is desirable % Mn greater than 4.6%. For some embodiments of the present invention, the inventor has found that it is desirable % Mn greater than 5.6%. For some embodiments of the present invention, the inventor has found that it is desirable % Mn greater than 6.6%. For some embodiments of the present invention, the inventor has found that it is desirable % Mn greater than 7.6%.

An excessive content of % Mn, and depending on the quantities of other elements in the alloy, has been found that can negatively affect the ease of machining of the steel. For some embodiments of the present invention the inventor has found that it is desirable % Mn less than 9.8%. For some embodiments of the present invention the inventor has found that it is desirable % Mn less than 7.8%. For some embodiments of the present invention the inventor has found that it is desirable % Mn less than 5.8%.

Nickel content is important and has a great importance, in particular its capability to increase hardness and control precipitation. For some embodiments of the present invention, the inventor has found that it is desirable % Ni greater than 0.25%. For some embodiments of the present invention, the inventor has found that it is desirable % Ni greater than 1.52%. For some embodiments of the present invention, the inventor has found that it is desirable % Ni greater than 2.52%. For some embodiments of the present invention, the inventor has found that it is desirable % Ni greater than 3.02%. When high toughness is required, amongst others, often it is desired % Ni not being too high. For some embodiments of the present invention the inventor has found that it is desirable % Ni less than 4.8%. For some embodiments of the present invention the inventor has found that it is desirable % Ni less than 2.78%. For some embodiments of the present invention the inventor has found that it is desirable % Ni less than 0.49%.

For some embodiments of the present invention the inventor has found that it is desirable % Ni being absent from the composition.

Silicon content is important and has a great importance, in particular its capability to increase hardness and control precipitation. For some embodiments of the present invention, the inventor has found that it is desirable % Si greater than 0.25%. For some embodiments of the present invention, the inventor has found that it is desirable % Si greater than 1.52%. For some embodiments of the present invention, the inventor has found that it is desirable % Si greater than 1.82%. For some embodiments of the present invention, the inventor has found that it is desirable % Si greater than 2.52%. For some embodiments of the present invention, the inventor has found that it is desirable % Si greater than 3.02%.

Inventor has found than for some compositions, % Si can be negatively affecting the obtainable values of toughness for high thicknesses. For some embodiments of the present invention the inventor has found that it is desirable % Si less than 0.4%. For some embodiments of the present invention the inventor has found that it is desirable % Si less than 0.18%. For some embodiments of the present invention the inventor has found that it is desirable % Si less than 0.08%. For some embodiments of the present invention the inventor has found that it is desirable % Si less than 0.04%. For some embodiments of the present invention the inventor has found that it is desirable % Si being absent from the composition.

Inventor has found that for some compositions the sum of % Se+% Te+% S+% P+% As+% Pb+% Sb+% Sn can favor machining. For some embodiments of the present invention, the inventor has found that it is desirable further include in the steel composition % Se+% Te+% S+% P+% As+% Pb+% Sb+% Sn greater than 0.052%. But often the sum % Se+% Te+% S+% P+% As+% Pb+% Sb+% Sn has a negative effect on toughness. For some embodiments of the present invention, the inventor has found that it is desirable % Se+% Te+% S+% P+% As+% Pb+% Sb+% Sn less than 0.04%. For some embodiments of the present invention, the inventor has found that it is desirable % Se+% Te+% S+% P+% As+% Pb+% Sb+% Sn less than 0.008%. For some embodiments of the present invention, the inventor has found that it is desirable % Se+% Te+% S+% P+% As+% Pb+% Sb+% Sn being absent.

Inventor has found that for some compositions the sum of % Ta+% Nb can favor wear resistance. For some embodiments of the present invention, the inventor has found that it is desirable further include in the steel composition % Ta+% Nb greater than 0.22%. For some embodiments of the present invention, the inventor has found that it is desirable % Ta+% Nb more than 0.54%. For some embodiments of the present invention, the inventor has found that it is desirable % Ta+% Nb more than 1.6%. For some embodiments of the present invention, the inventor has found that it is desirable % Ta+% Nb more than 2.04%. But often the sum % Ta+% Nb has a negative effect on toughness. For some embodiments of the present invention, the inventor has found that it is desirable % Ta+% Nb less than 0.4%.

For some embodiments of the present invention, the inventor has found that it is desirable % Ta+% Nb less than 0.08%. For some embodiments of the present invention, the inventor has found that it is desirable % Ta+% Nb being absent.

Inventor has found that for some compositions the sum of % Se+% Te can favor machining.

For some applications of the present invention, the inventor has found that it is desirable further include in the steel composition % Se+% Te greater than 0.052%. But often the sum % Se+% Te has a negative effect on the steels of the present invention especially when % Mn is high and can disrupt the positive effect of a high % Mn. For some applications of the present invention, the inventor has found that it is desirable % Se+% Te less than 0.19%.

For some applications of the present invention, the inventor has found that it is desirable % Se+% Te less than 0.09%. For some applications of the present invention, the inventor has found that it is desirable % Se+% Te less than 0.04%. For some applications of the present invention, the inventor has found that it is desirable % Se+% Te less than 0.008%.

For some applications of the present invention, the inventor has found that it is desirable % Se+% Te being absent.

For some applications of the present invention, the inventor has found that % P+% S are further contained in the steel composition. Inventor has found that for some compositions % P+% S have a negative effect on the steels of the present invention especially when % Mn is high and can disrupt the positive effect of a high % Mn. For some applications of the present invention the inventor has found that it is desirable % P+% S less than 0.028%. For some applications of the present invention the inventor has found that it is desirable % P+% S less than 0.018%. For some applications of the present invention the inventor has found that it is desirable % P+% S less than 0.008%. For some applications of the present invention the inventor has found that it is desirable % P+% S less than 0.0004%. For some applications of the present invention the inventor has found that it is desirable % P+% S being absent from the composition.

For some applications of the present invention, the inventor has found that P is further contained in the steel composition. Inventor has found that for some compositions % P has a negative effect on the steels of the present invention especially when % Mn is high and can disrupt the positive effect of a high % Mn. For some applications of the present invention the inventor has found that it is desirable % P less than 0.028%. For some applications of the present invention the inventor has found that it is desirable % P less than 0.018%. For some applications of the present invention the inventor has found that it is desirable % P less than 0.008%. For some applications of the present invention the inventor has found that it is desirable % P less than 0.0008%. For some applications of the present invention the inventor has found that it is desirable % P being absent from the composition.

For some applications of the present invention, the inventor has found that S is further contained in the steel composition. Inventor has found that for some compositions % S has a negative effect on the steels of the present invention especially when % Mn is high and can disrupt the positive effect of a high % Mn. For some applications of the present invention the inventor has found that it is desirable % S less than 0.018%. For some applications of the present invention the inventor has found that it is desirable % S less than 0.008%. For some applications of the present invention the inventor has found that it is desirable % S less than 0.0008%. For some applications of the present invention the inventor has found that it is desirable % S less than 0.0004%. For some applications of the present invention the inventor has found that it is desirable % S being absent from the composition.

Molybdenum content is important and has a great importance in determination of the majority of relevant properties, since its presence in secondary carbides is almost always of great influence. When resistance to temper is required molybdenum cannot be too low.

For some embodiments of the present invention, the inventor has found that it is desirable % Mo greater than 0.16%. For some embodiments of the present invention, the inventor has found that it is desirable % Mo greater than 0.21%. For some embodiments of the present invention, the inventor has found that it is desirable % Mo greater than 1.1%. When high toughness and/or elongation is required often is desired % Mo not too high. This is also the case when the presence of other carbide builders like % V, % Cr, and/or % W is high. Also in some instances % Mo can negatively influence the effect of % Zr. For some embodiments of the present invention the inventor has found that it is desirable % Mo less than 0.8%. For some embodiments of the present invention the inventor has found that it is desirable % Mo less than 0.19%. For some embodiments of the present invention the inventor has found that it is desirable % Mo less than 0.04%. For some embodiments of the present invention the inventor has found that it is desirable % Mo being absent.

Inventor has found that for some embodiments of the present invention % Mo can be partially replaced by double the amount, in weight of % W. Also for some applications, what is described for % Mo in the preceding paragraph applies for % W but the contents expressed must be double. In this sense it is also interesting the % Moeq concept, for the cases of partial substitution, wherein % Moeq=% Mo+½% W. The desired contents for % Moeq follow the above about % Mo.

Zirconium content is important and has a great importance in determination of the majority of relevant properties, since its presence in secondary carbides is almost always of great influence. When high ultimate hardness is required % Zr cannot be too low. For some embodiments of the present invention, the inventor has found that it is desirable % Zr greater than 0.22%. For some embodiments of the present invention, the inventor has found that it is desirable % Zr greater than 1.2%. For some embodiments of the present invention, the inventor has found that it is desirable % Zr greater than 2.55%. For some embodiments of the present invention, the inventor has found that it is desirable % Zr greater than 3.25%.

When high toughness and/or elongation is required often it is desired % Zr not being too high. This is also the case when the presence of other carbide formers like % Mo, % Cr and/or % W is high. For some embodiments of the present invention the inventor has found that it is desirable % Zr less than 6.8%. For some embodiments of the present invention the inventor has found that it is desirable % Zr less than 4.8%. For some embodiments of the present invention the inventor has found that it is desirable % Zr less than 2.8%. For some embodiments of the present invention the inventor has found that it is desirable % Zr less than 0.4%. For some embodiments of the present invention the inventor has found that it is desirable % Zr being absent.

Inventor has found that for several applications it is desired having % Zr between 0 and 5.4%, normally % Zr between 1.2 and 4.4%, and even % Zr between 2.1 and 4.4%.

Inventor has found that for some embodiments of the present invention % Zr can be partially replaced by double the amount, in weight of % Hf. Also for some applications, what is described for % Zr in the preceding paragraph applies for % Hf but the contents expressed must be double. In this sense it is also interesting the % Zreq concept, for the cases of partial substitution, wherein % Zreq=% Zr+½% Hf. The desired contents for % Zreq follow the above about % Zr.

Vanadium content is important and has a great importance in determination of the majority of relevant properties, since its presence in secondary carbides is almost always of great influence. When hot hardness is required % V cannot be too low. For some embodiments of the present invention, the inventor has found that it is desirable % V greater than 0.22%.

For some embodiments of the present invention, the inventor has found that it is desirable % V greater than 0.32%. For some embodiments of the present invention, the inventor has found that it is desirable % V greater than 0.55%. For some embodiments of the present invention, the inventor has found that it is desirable % V greater than 1.1%. For some embodiments of the present invention, the inventor has found that it is desirable % V greater than 2.05%. When high toughness and/or elongation is required often it is desired % V not being too high. This is also the case when the presence of other carbide formers like % Mo, % Cr and/or % W is high. For some embodiments of the present invention the inventor has found that it is desirable % V less than 3.8%. For some embodiments of the present invention the inventor has found that it is desirable % V less than 2.8%. For some embodiments of the present invention the inventor has found that it is desirable % V less than 1.8%. For some embodiments of the present invention the inventor has found that it is desirable % V less than 0.4%. For some embodiments of the present invention the inventor has found that it is desirable % V being absent.

Titanium content is important and has a great importance in determination of the majority of relevant properties, since its presence in secondary carbides is almost always of great influence. When hot hardness is required % Ti cannot be too low. For some embodiments of the present invention, the inventor has found that it is desirable % Ti greater than 0.22%.

For some embodiments of the present invention, the inventor has found that it is desirable % Ti greater than 0.55%. For some embodiments of the present invention, the inventor has found that it is desirable % Ti greater than 1.6 For some embodiments of the present invention, the inventor has found that it is desirable % Ti greater than 2.6%. For some embodiments of the present invention, the inventor has found that it is desirable % Ti greater than 3.6%. Sometimes it is desired % Ti content not being excessive. For some embodiments of the present invention the inventor has found that it is desirable % Ti less than 4.8%. For some embodiments of the present invention the inventor has found that it is desirable % Ti less than 2.8%. For some embodiments of the present invention the inventor has found that it is desirable % Ti being absent.

Sometimes it is desired % Co content not being excessive. For some embodiments of the present invention the inventor has found that it is desirable % Co less than 2.3%. For some embodiments of the present invention the inventor has found that it is desirable % Co less than 1.2%. For some embodiments of the present invention the inventor has found that it is desirable % Co being absent. For some embodiments of the present invention % Co can help to improve the properties of the steel. For some embodiments of the present invention, the inventor has found that it is desirable % Co greater than 0.001%. For some embodiments of the present invention, the inventor has found that it is desirable % Co greater than 0.1%.

Sometimes it is desired % Cu content not being excessive. For some embodiments of the present invention the inventor has found that it is desirable % Cu less than 1.10%. For some embodiments of the present invention the inventor has found that it is desirable % Cu less than 0.4%. For some embodiments of the present invention the inventor has found that it is desirable % Cu being absent. For some embodiments of the present invention % Cu can help to improve the properties of the steel. For some embodiments of the present invention, the inventor has found that it is desirable % Cu greater than 0.001%. For some embodiments of the present invention, the inventor has found that it is desirable % Cu greater than 0.1%.

Sometimes it is desired % Al content not being excessive. For some embodiments of the present invention the inventor has found that it is desirable % Al less than 0.8%. For some embodiments of the present invention the inventor has found that it is desirable % Al less than 0.2%. For some embodiments of the present invention the inventor has found that it is desirable % Al being absent. For some embodiments of the present invention % Al can help to improve the properties of the steel. For some embodiments of the present invention, the inventor has found that it is desirable % Al greater than 0.6%. For some embodiments of the present invention, the inventor has found that it is desirable % Al greater than 1.10%.

In an embodiment, the steels of this aspect of the invention can are characterized by a hardness increase of more than 8HRc, when properly prepared and subjected to a heat treatment at low temperature. In an embodiment, the steels of this aspect of the invention can are characterized by a hardness increase of more than 16HRc, when properly prepared and subjected to a heat treatment at low temperature. In an embodiment, the steels of this aspect of the invention can are characterized by a hardness increase of more than 22HRc, when properly prepared and subjected to a heat treatment at low temperature. In an embodiment, the steels of this aspect of the invention can are characterized by a hardness increase of more than 32HRc, when properly prepared and subjected to a heat treatment at low temperature. In an embodiment, the steels of this aspect of the invention can are characterized by a hardness increase of more than 42HRc, when properly prepared and subjected to a heat treatment at low temperature. In an embodiment, the steels of this aspect of the invention can are characterized by a hardness of less than 348 HB, when properly prepared. In an embodiment, the steels of this aspect of the invention can are characterized by a hardness of less than 298 HB, when properly prepared. In an embodiment, the steels of this aspect of the invention can are characterized by a hardness of less than 248 HB, when properly prepared. In an embodiment, the steels of this aspect of the invention can are characterized by a hardness of less than 228 HB, when properly prepared. In an embodiment of the present aspect of the invention, properly prepared refers to an austenitization at 1020° C. during 30 minutes once the core has reached the temperature followed by oil quenching. In an embodiment of the present aspect of the invention, properly prepared refers to an austenitization at 1020° C. during 30 minutes once the core has reached the temperature followed by air cooling. In an embodiment of the present aspect of the invention, properly prepared refers to an austenitization at 1050° C. during 30 minutes once the core has reached the temperature followed by oil quenching. In an embodiment of the present aspect of the invention, properly prepared refers to an austenitization at 1050° C. during 30 minutes once the core has reached the temperature followed by air cooling. In an embodiment of the present aspect of the invention, properly prepared refers to an austenitization at 1080° C. during 30 minutes once the core has reached the temperature followed by oil quenching. In an embodiment of the present aspect of the invention, properly prepared refers to an austenitization at 1100° C. during 30 minutes once the core has reached the temperature followed by air cooling. In an embodiment of the present aspect of the invention, properly prepared refers to an austenitization at 1150° C. during 30 minutes once the core has reached the temperature followed by oil quenching. In an embodiment of the present aspect of the invention, properly prepared refers to an austenitization at 1200° C. during 30 minutes once the core has reached the temperature followed by air cooling. In an embodiment of the present aspect of the invention, properly prepared refers to an austenitization at 1250° C. during 30 minutes once the core has reached the temperature followed by oil quenching. In an embodiment of the present aspect of the invention, the heat treatment at low temperature provoking the hardness increase, refers to a tempering or similar treatment of 4 h at 480° C. Heating up and cooling are rather insignificant but don't need to be especially fast. In an embodiment of the present aspect of the invention, the heat treatment at low temperature provoking the hardness increase, refers to a tempering or similar treatment of 4 h at 520° C. Heating up and cooling are as fast as possible. In an embodiment of the present aspect of the invention, the heat treatment at low temperature provoking the hardness increase, refers to a tempering or similar treatment of 2 h at 540° C. Heating up and cooling are rather insignificant but don't need to be especially fast. In an embodiment of the present aspect of the invention, the heat treatment at low temperature provoking the hardness increase, refers to a tempering or similar treatment of 4 h at 600° C. Heating up and cooling are rather insignificant but don't need to be especially fast. In an embodiment of the present aspect of the invention, the heat treatment at low temperature provoking the hardness increase, refers to a tempering or similar treatment of 4 h at 620° C. Heating up and cooling are rather insignificant but don't need to be especially fast. In an embodiment of the present aspect of the invention, the heat treatment at low temperature provoking the hardness increase, refers to a tempering or similar treatment of 8 h at 520° C. Heating up and cooling are 50K/h.

In an aspect of the present invention the inventor has found that the materials of the present invention are susceptible of being shaped with a manufacturing method comprising the following steps:
Usage of an additive manufacturing method to manufacture a model a mold or an intermediate mold or partial mold.
Filling at least part of the mold with particulate material comprising at least one metallic phase.
Usage of a Cold Isostatic Pressing (CIP) step
Elimination of the mold.
and a densification step which can be sintering, Hot Isostatic Pressing (HIP) or any other involving high enough temperatures.

This shaping process is to the best knowledge of the inventor new and constitutes an invention per se. As mentioned, the applicability of this invention to other materials has to be confirmed on a case by case basis, but the invention is stablished in this document.

Besides the materials of the present invention, the inventor has found that this aspect of the invention works with tool steels and high speed steels. Maraging steels are considered here also tool materials. In an embodiment of this aspect of the invention, it has been found that it works specially well with steels characterized in that % Cr<2.9% and % Moeq>0.8%. In an embodiment of this aspect of the invention, it has been found that it works specially well with steels characterized in that % Cr<1.9% and % Moeq>1.6%.

In an embodiment of this aspect of the invention, it has been found that it works specially well with steels characterized in that % Cr<1.9% and % Moeq>2.6%. In an embodiment of this aspect of the invention, it has been found that it works specially well with steels characterized in that % Cr<0.9% and % Moeq>2.1%. In an embodiment of this aspect of the invention, it has been found that it works specially well with steels characterized in that % Cr<0.3% and % Moeq>3.10%. The inventor has also found that the present aspect of the invention work with most hard metals (tungsten carbide in either Ni, Co or respective alloys) and most metal matrix composites with high volume of abrasion resistance particles (carbides, nitrides, borides oxides or mixtures thereof). What has been said in this paragraph, obviously applies also to all other aspects and embodiments in the following paragraphs until the end of the document.

In this document, whether the CIP step is a dry bag, wet bag, warm isostatic pressing or any other similar method depends on the actual application, primarily nature of the particulate material used, geometry and availability amongst others. In some embodiments, dry bag is preferred. In some embodiments, dry bag is preferred. In some embodiments, warm isostatic pressing is preferred at a temperature of 62° C. or more. In some embodiments, warm isostatic pressing is preferred at a temperature of 82° C. or more.

In some embodiments, warm isostatic pressing is preferred at a temperature of 160° C. or more. In some embodiments, warm isostatic pressing is preferred at a temperature of 220° C. or more. In some embodiments, warm isostatic pressing is preferred at a temperature of 450° C. or more.

The additive manufacturing step, may consists on the fabrication of a model or a mold. In an embodiment, a model is fabricated using an additive manufacturing technique, the model is subsequently used to fabricate a mold normally with a very flexible material (like rubber, plastisol, neoprene, any other elastomer, . . . ), in this case the first step of the method implying additive manufacturing is employed to fabricate at least a part of a model and then the method comprises an additional step, between the first and the second step:
Usage of an additive manufacturing method to manufacture at least a part of a model.
(might also include) assembling this part of the model to other parts.
Manufacturing a mold with a very flexible material using the model of the previous steps to provide shape to at least part of the mold.
Filling at least part of the mold with particulate material comprising at least one metallic phase.
Usage of a Cold Isostatic Pressing (CIP) step
Elimination of the mold.
and a densification step which can be sintering, Hot Isostatic Pressing (HIP) or any other involving high enough temperatures.

In an embodiment of the present aspect the mold is fabricated trough immersion, pouring, application or any other mean implying the very flexible material to be above its glass transition temperature, in such case the inventor has found that it is interesting to use in the additive manufacturing step to manufacture the model a high temperature resistant polymer. In some embodiments, the inventor has found that it is the glass transition temperature that matters most: in an embodiment, it should be higher than 85° C.; in another embodiment, it should be higher than 122° C.; in another embodiment, it should be higher than 162° C.; in another embodiment, it should be higher than 202° C.; in another embodiment, it should be higher than 252° C.; in another embodiment, it should be higher than 292° C.; in another embodiment, it should be higher than 362° C. In some embodiments the inventor has found that the heat deflection temperature at 0.45 MPa is what should be considered: in an embodiment, it should be higher than 125° C.; in another embodiment, it should be higher than 152° C.; in another embodiment, it should be higher than 282° C.; in another embodiment, it should be higher than 232° C.; in another embodiment, it should be higher than 262° C.; in another embodiment, it should be higher than 282° C.; in another embodiment, it should be higher than 342° C. Like in the whole of this document, if not otherwise indicated, for some applications the different properties indicated for different embodiments can be combined, in this case for example some applications might require a polymer with a high enough transition temperature and a high enough heat deflection temperature at 0.45 MPa. To cite a few examples of possible polymers for the model construction: poli (hydroxy butyl) methacrylate and poli (hydroxy ethyl) methacrylate, polimides, Polybenzimidazole aromatic derivatives, etc.

In another embodiment of the present aspect the mold is fabricated trough immersion, pouring, application or any other mean implying a multiple component very flexible material which undergoes a curing process after the mixing of the two or more components, in this embodiment almost any kind of material can be used to manufacture the model, and any two or more components very elastic material can be used for the manufacturing of the mold (for example a two-component neoprene). In another embodiment, the same process is followed as in the preceding embodiment but using a one component fluid at low temperature (below 140° C., preferably below 109° C., more preferably below 98° C., more preferably below 74° C. and even below 40° C.) solution or emulsion.

In an embodiment, the mold is fabricated directly through additive manufacturing using a very flexible material as the build material, the method looks as follows:
Usage of an additive manufacturing method to manufacture a mold or a part of a mold using a very flexible material as at least one of the build materials.
(might also include) assembling this part of the model to other parts.
Manufacturing a cover mold with a very flexible material using the model of the previous steps.
Filling at least part of the mold with particulate material comprising at least one metallic phase.
Usage of a Cold Isostatic Pressing (CIP) step
Elimination of the mold.
and a densification step which can be sintering, Hot Isostatic Pressing (HIP) or any other involving high enough temperatures.

In the present aspect of the present invention it is understood as a “very flexible material” a material with a high enough elongation at breakage. In an embodiment, higher than 55%. In another embodiment, higher than 76%. In another embodiment, higher than 92%.

In another embodiment, higher than 110%. In another embodiment, higher than 160%. In another embodiment, higher than 210%. In another embodiment, higher than 360%. In another embodiment, higher than 576%. For some applications, especially when accurate dimensions are desirable and also when complex internal cooling or similar networks are desirable, the inventor has found that often a minimum hardness level is desirable: in an embodiment, higher than 72 shore A; in another embodiment, higher than 81 shore A; in another embodiment, higher than 91 shore A; in another embodiment, higher than 102 shore A; in another embodiment, higher than 122 shore A; in another embodiment, higher than 181 shore A. In the same line for some applications an excessive elongation can be undesirable: in an embodiment, 390% or less; in another embodiment, 290% or less; in another embodiment, 190% or less; in another embodiment, 140% or less; in another embodiment, 98% or less. There are embodiments which require a combination of the mentioned properties (as an example an elongation at breakage higher than 76% but lower than 140% with a hardness higher than 81 shore A. Any other combination would have been the proper one for another application).

A very important set of embodiments of the present aspect relate to the manufacture of components with complex internal structures of channels or any other kind of voids (which might be eventually filled with a different material) (to name a few examples: cooling channels network, voids to lighten the structure, copper networks for heating, power transference or signal transference, etc.) as it is well known, contained or enclosed voids are very difficult to handle with either CIP or HIP processes, and normally metallic cores or mandrels of simple geometry are required. The inventor has found that very surprisingly for the present invention it is possible to use polymeric material to make some of the most interesting internal void geometries.

Complex cooling channels and channels to be filled with other materials can be made in this fashion, with high precision. In the case of cooling channels, conformal cooling strategies can be applied.

In an embodiment of the present aspect of the invention, the additive manufacturing step is applied to manufacture an intermediate mold or a part of an intermediate mold. This mold is then filled with the particulate material comprising at least one metallic phase and is then covered with a mold manufactured with a very elastic material manufactured in any of the ways described for this effect in the preceding embodiments (very elastic material above glass transition temperature, multi-component very elastic material applied at low temperature, single component low temperature emulsion, . . . ). This is followed at least by a CIP or similar step and at least one consolidation step at a high enough temperature. In an embodiment, the additive manufactured intermediate mold is the one that incorporates most of the cooling channels or other internal features of the component. Obviously since the particulate material is filled into the intermediate mold, this has a geometry which is similar to the negative of the geometry to be achieved after the consolidation of the particulate material. The shrinkage of the intermediate mold, the mold manufactured with a very elastic material, the consolidation of the particulate material, etc. are often taking into account and corrected for in the design phase. In an embodiment of the present aspect the inner features have minimal or even no mechanical machining after consolidation.

In this aspect of the invention when an intermediate mold is utilized, it is often interesting to differentiate between internal features and external ones. In this sense, internal features are those that are completely surrounded by particulate material upon filling and thus, do not receive the pressure during the CIP step directly from the fluid or directly through the very elastic material cover mold, but always through the surrounding particulate material.

As contraposition, external features are those that only have particulate material in one side, and the opposite side of the wall is in direct contact with the dry bag, the fluid of the CIP or similar, often trough the cover mold manufactured with very elastic material.

This embodiment is schematized in FIG. 4. the method looks as follows:
Usage of an additive manufacturing method to manufacture an intermediate mold or a part of an intermediate mold.
(might also include) assembling this part of the intermediate mold to other parts.
Filling at least part of the mold with particulate material comprising at least one metallic phase.
Manufacturing a cover mold with a very flexible material using the filled intermediate AM fabricated mold of the previous steps.
Usage of a Cold Isostatic Pressing (CIP) step
Elimination of the mold.
and a densification step which can be sintering, Hot Isostatic Pressing (HIP) or any other involving high enough temperatures.

The filling step and manufacturing of the cover mold with a very flexible material step might be inverted.

For an embodiment, the mean thickness of the AM fabricated intermediate mold for the exterior features is 1.8 mm or less. For an embodiment, the mean thickness of the AM fabricated intermediate mold for the exterior features is 1.3 mm or less. For an embodiment, the mean thickness of the AM fabricated intermediate mold for the exterior features is 0.8 mm or less. For an embodiment, the mean thickness of the AM fabricated intermediate mold for the exterior features is 0.4 mm or less. For an embodiment, the mean thickness of the AM fabricated intermediate mold for the exterior features is 0.2 mm or less.

In an embodiment, a high enough temperature for the densification step refers to a temperature higher than 0.52 Tm where Tm is the melting temperature of the particulate material with the lowest melting point. In an embodiment, a high enough temperature for the densification step refers to a temperature higher than 0.62 Tm where Tm is the melting temperature of the particulate material with the lowest melting point. In an embodiment, a high enough temperature for the densification step refers to a temperature higher than 0.72 Tm where Tm is the melting temperature of the particulate material with the lowest melting point. In an embodiment, a high enough temperature for the densification step refers to a temperature higher than 0.82 Tm where Tm is the melting temperature of the particulate material with the lowest melting point. In an embodiment, a high enough temperature for the densification step refers to a temperature higher than 0.52 Tm where Tm is the melting temperature of the particulate material with the highest volume fraction. In an embodiment, a high enough temperature for the densification step refers to a temperature higher than 0.62 Tm where Tm is the melting temperature of the particulate material with the highest volume fraction. In an embodiment, a high enough temperature for the densification step refers to a temperature higher than 0.72 Tm where Tm is the melting temperature of the particulate material with the highest volume fraction. In an embodiment, a high enough temperature for the densification step refers to a temperature higher than 0.82 Tm where Tm is the melting temperature of the particulate material with the highest volume fraction. In an embodiment, a high enough temperature for the densification step refers to a temperature higher than 0.52 Tm where Tm is the melting temperature of the particulate material with the highest weight fraction. In an embodiment, a high enough temperature for the densification step refers to a temperature higher than 0.62 Tm where Tm is the melting temperature of the particulate material with the highest weight fraction. In an embodiment, a high enough temperature for the densification step refers to a temperature higher than 0.72 Tm where Tm is the melting temperature of the particulate material with the highest weight fraction. In an embodiment, a high enough temperature for the densification step refers to a temperature higher than 0.82 Tm where Tm is the melting temperature of the particulate material with the highest weight fraction. In an embodiment, a high enough temperature for the densification step refers to a temperature higher than 980° C. In an embodiment, a high enough temperature for the densification step refers to a temperature higher than 1055° C.

In an embodiment, a high enough temperature for the densification step refers to a temperature higher than 1120° C. In an embodiment, a high enough temperature for the densification step refers to a temperature higher than 1160° C. In an embodiment, a high enough temperature for the densification step refers to a temperature higher than 1210° C.

In an embodiment, the maximum pressure during the CIP cycle is 110 MPa or more. In an embodiment, the maximum pressure during the CIP cycle is 210 MPa or more. In an embodiment, the maximum pressure during the CIP cycle is 310 MPa or more. In an embodiment, the maximum pressure during the CIP cycle is 410 MPa or more. In an embodiment, the maximum pressure during the CIP cycle is 510 MPa or more. In an embodiment, the maximum pressure during the CIP cycle is 710 MPa or more. In an embodiment, the maximum pressure during the CIP cycle is 810 MPa or more. In an embodiment, the maximum pressure during the CIP cycle is 1010 MPa or more.

In an embodiment, the AM material used has a hard filling of 21% or more. In an embodiment, the AM material used has a hard filling of 41% or more. In an embodiment, the AM material used has a hard filling of 51% or more. In an embodiment, the AM material used has a hard filling of 61% or more.

In an embodiment, the AM material used has is characterized by a Bulk Modulus of 1.1 GPa or more. In an embodiment, the AM material used has is characterized by a Bulk Modulus of 2.1 GPa or more. In an embodiment, the AM material used has is characterized by a Bulk Modulus of 3.1 GPa or more. In an embodiment, the AM material used has is characterized by a Bulk Modulus of 3.6 GPa or more. In an embodiment, the AM material used has is characterized by a Bulk Modulus of 4.1 GPa or more.

In an embodiment, the AM material used has is characterized by a Elastic Strength of 45 MPa or more. In an embodiment, the AM material used has is characterized by a Elastic Strength of 55 MPa or more. In an embodiment, the AM material used has is characterized by a Elastic Strength of 65 MPa or more. In an embodiment, the AM material used has is characterized by a Elastic Strength of 75 MPa or more. In an embodiment, the AM material used has is characterized by a Elastic Strength of 85 MPa or more.

In an embodiment, the method is used to manufacture a die casting die. In an embodiment, the method is used to manufacture a die casting die with interior cooling. In an embodiment, the method is used to manufacture a die casting die with very close to the surface conformal cooling (as described in posterior paragraphs). In an embodiment, the method is used to manufacture a die casting die with very close to the surface conformal cooling and also internal heating to reduce thermal gradients.

In an embodiment, the method is used to manufacture a hot stamping die. In an embodiment, the method is used to manufacture a hot stamping die with interior cooling.

In an embodiment, the method is used to manufacture a hot stamping die with very close to the surface conformal cooling (as described in posterior paragraphs). In an embodiment, the method is used to manufacture a hot stamping die with very close to the surface conformal cooling where the die surface temperature is kept below 140° C. during the whole cycle. In an embodiment, the method is used to manufacture a hot stamping die with very close to the surface conformal cooling where the die surface temperature is kept below 79° C. during the whole cycle. In an embodiment, the method is used to manufacture a hot stamping die with very close to the surface conformal cooling where the die surface temperature is kept below 49° C. during the whole cycle. In an embodiment, the method is used to manufacture a hot stamping die with very close to the surface conformal cooling where the die surface temperature is kept below 29° C. during the whole cycle. In an embodiment, the method is used to manufacture a hot stamping die with very close to the surface conformal cooling where the die surface temperature is kept below 19° C. during the whole cycle. In an embodiment, the method is used to manufacture a hot stamping die with very close to the surface conformal cooling where the die surface temperature is kept below 14° C. during the whole cycle. In an embodiment, the method is used to manufacture a hot stamping die with very close to the surface conformal cooling where the die surface temperature is kept above −10° C. during the whole cycle. In an embodiment, the method is used to manufacture a hot stamping die with very close to the surface conformal cooling where the die surface temperature is kept above −9° C. during the whole cycle. In an embodiment, the method is used to manufacture a hot stamping die with very close to the surface conformal cooling where the die surface temperature is kept above −4° C. during the whole cycle. In an embodiment, the method is used to manufacture a hot stamping die with very close to the surface conformal cooling where the die surface temperature is kept above 0.5° C. during the whole cycle. In an embodiment, the method is used to manufacture a hot stamping die with very close to the surface conformal cooling where the die surface temperature is kept above 6° C. during the whole cycle. In an embodiment, the method is used to manufacture a hot stamping die with very close to the surface conformal cooling where the die surface temperature is kept above 11° C. during the whole cycle. In an embodiment, the method is used to manufacture a hot stamping die with very close to the surface conformal cooling where the die surface is covered with a homogeneous water film prior to the placement of the hot sheet in every cycle. In an embodiment, the method is used to manufacture a hot stamping die with very close to the surface conformal cooling where the die surface is uniformly sprayed with water or a water solution prior to the placement of the hot sheet in every cycle. In an embodiment, the method is used to manufacture a hot stamping die with very close to the surface conformal cooling where the die surface is uniformly sprayed with a mixture of air and water or a water solution prior to the placement of the hot sheet in every cycle. In an embodiment, the method is used to manufacture a hot stamping die with very close to the surface conformal cooling where the die surface is uniformly sprayed with a fluid or solution prior to the placement of the hot sheet in every cycle. In an embodiment, the method is used to manufacture a hot stamping die with very close to the surface conformal cooling where the die surface is uniformly sprayed with a system of nozzles. In an embodiment, the method is used to manufacture a hot stamping die with very close to the surface conformal cooling where the die surface is uniformly sprayed with any mechanical system. In an embodiment, the method is used to manufacture a hot stamping die with very close to the surface conformal cooling where the die surface is uniformly sprayed with a system of nozzles or mechanical system which is fixed. In an embodiment, the method is used to manufacture a hot stamping die with very close to the surface conformal cooling where the die surface is uniformly sprayed with a system of nozzles or any other mechanical system which retracts in every cycle.

In an embodiment, the method is used to manufacture a forging die. In an embodiment, the method is used to manufacture a forging die with interior cooling. In an embodiment, the method is used to manufacture a forging die with very close to the surface conformal cooling (as described in posterior paragraphs). In an embodiment, the method is used to manufacture a forging die with very close to the surface conformal cooling and also internal heating to reduce thermal gradients.

In an embodiment, the method is used to manufacture a plastic injection die. In an embodiment, the method is used to manufacture a plastic injection die with interior cooling. In an embodiment, the method is used to manufacture a plastic injection die with very close to the surface conformal cooling (as described in posterior paragraphs). In an embodiment, the method is used to manufacture a plastic injection die with very close to the surface conformal cooling and also internal heating to reduce thermal gradients.

In an embodiment, the method is used to manufacture a soft zone die for hot stamping with internal heating. In an embodiment, the method is used to manufacture a soft zone die for hot stamping with internal heating through cartridges. In an embodiment, the method is used to manufacture a soft zone die for hot stamping with internal heating trough embedded Joule effect circuit. In an embodiment, the method is used to manufacture a soft zone die for hot stamping with internal heating trough embedded Eddy current system.

In an embodiment the particulate material refers to powder. In an embodiment the particulate material refers to spherical powder. In an embodiment the particulate material refers to granules.

In an embodiment this steel and the particulate material is suitable for use in powder form in a powder mixture. Particle size of metallic powders, when not otherwise stated, refers to D50. For some applications fine powders can be used with a d50 of 78 microns or less, preferably 48 microns or less, more preferably 18 microns or less and even 8 microns or less. For some other applications rather coarser powders are acceptable with d50 of 780 microns or less, preferably 380 microns or less, more preferably 180 microns or less and even 120 microns or less. In some applications fine powders are even disadvantageous, so that powders with d50 of 12 microns or more are desired, preferably 22 microns or more, even more preferably 42 microns or more and even 72 microns or more.

In some applications the powder should be quite spherical and the particle size distribution quite narrow. The sphericity of the powder, is a dimensionless parameter defined as the ratio between the surface area of a sphere having the same volume as the particle and the surface area of the particle and for some applications it may be preferably greater than 0.53, more preferably greater than 0.76, even more preferably greater than 0.86, and even more preferably greater than 0.92. When in the present invention high metallic particulate compactation is desired often a high sphericity of the metallic powder is desirable preferably greater than 0.92, more preferably greater than 0.94, even more preferably greater than 0.98 and even 1. When speaking of sphericity, for some applications the sphericity can be evaluated for just the majority of the powder in terms of the average sphericity of the most spherical particulates. The 60% of the volume of powder employed or more, preferably 78% or more, more preferably 83% or more and even more preferably 96% or more should be considered to calculate the average. For some applications, instead sometimes sphericity below 0.94, preferably below 0.88%, more preferably below 0.68% and even below 0.48 can be advantageous.

In an embodiment the steel of the above composition can be manufactured in form of powder. In another embodiment the powder is spherical. In an embodiment refers to a spherical powder of the steel of the above composition with particle size (d50) of 200 micrometers or less, in another embodiment 190 micrometers or less, in another embodiment 180 micrometers or less, in another embodiment 90 micrometers or less, and even in another embodiment 45 micrometers or less.

The present invention allows the realization of very aggressive cooling strategies, as mentioned given that the cooling channels can be brought very close to the surface given the improved resistance to stress corrosion cracking and to mechanical failure even when the channels have been machined with a rough surface. Besides the conventional drilling, brazing, shell construction, etc. manufacturing strategies, the present invention is very interesting for Additive Manufacturing (AM) and other more advanced manufacturing technologies, where even more aggressive cooling strategies can be applied, like cooling systems resembling the way the human body regulates temperature trough blood circulation trough primary channels that go into secondary channels with final capillary channels that execute the heat transference very close to the surface and a similar system to extract the cooling fluid after the intended heat exchange. Very many other strategies can be implemented with very effective, regular and tailored thermal regulation.

An important advantage when it comes to thermoregulation systems, especially if it is performed with a fluid assistance, is that it is possible to obtain a homogenous distribution of the thermoregulatory fluid and very close to the surface to be thermoregulated. In the case of using channels, they can be very well distributed and very close to the surface. It has been found that for some applications the mean distance of more effective fine channels for thermoregulation will be desirable lower than 18 mm, preferably lower than 8 mm, more preferably lower than 4.8 mm and even lower than 1.8 mm. For some applications a too small distance can be counterproductive, for those applications this distance will be desirable above 0.6 mm, preferably above 1.2 mm, more preferably above 6 mm and even above 16 mm. For some applications it is suitable that the mean distance between fine channels will be 18 mm or less, preferably 9 mm or less, more preferably 4.5 mm or less and ever lower than 1.8 mm. For some applications, especially when mechanical solicitation is high or there is corrosion risk, it will be desirable that the material used to the component manufacture has a high fracture toughness. It has been found that for some applications it is important that the mean diameter of fine channels is lower than 38 mm, preferably lower than 18 mm, more preferably lower than 8 mm and even lower than 2.8 mm. It has been found that for some applications it is important that the mean equivalent diameter of fine channels will be above 1.2 mm, preferably above 6 mm, more preferably above 12 mm and even above 22 mm. It has been found that for some applications it will be desirable that the minimum average diameter equivalent of fine channel will be lower than 18 mm, preferably lower than 8 mm, more preferably and even lower than 2.8 mm.

It has been found that for some applications it is important that the equivalent average diameter of fine channels will be above 1.2 mm, preferably above 6 mm, more preferably above 12 mm and above 22 mm. It has been found that for some applications it will be desirable that the minimum equivalent diameter will be lower than 18 mm, preferably lower than 12 mm, preferably lower than 9 mm, more preferably lower than 4 mm and even lower than 1.8 mm. It has been found that for some applications it is important the average equivalent diameter of main channels to be above 12 mm, preferably above 22 mm, more preferably above 56 mm and even above 108 mm.

In thermoregulation systems with components submitted to important mechanical efforts, there is always the dilemma between the proximity and the channels section where the thermoregulation fluid circulates. If channels have a little section, pressure drop increase and the head exchange capacity is reduced. If the distance to the surface to be thermoregulated is high then the thermoregulation is ineffective. On the other hand if channels have a big section and are close to the surface to be thermoregulated, the mechanical failure possibilities increase in great manner. To solve this dilemma, in the present invention a combined system which replicates the blood transport in human body (which also has a thermoregulatory mission) is proposed. There are main arteries in the human body which transport oxygenated blood to secondary arteries, to reach fine capillaries. The less oxygenated blood is transported through capillaries to secondary veins and thence to main veins. Similarly, as can be found in FIG. 1, in the proposed system the thermoregulatory fluid (hot or cold depending on the thermoregulatory function) is transported from main channels to secondary channels (there may be different secondary channels orders, this means, tertiary, quaternary, etc.) until arrive to fine and not very large channel very close to the surface to be thermoregulated. This system is advantageous for some applications, for other applications is more suitable the use of more traditional systems. Being the small cross section very short, the pressure drop effect turns it into manageable. By means of simulation of finite elements, the more advantageous configurations of secondary and main channels for a given application can be studied, both in terms of thermoregulatory efficacy as in fluid mechanics referred to sections, length, position, flow, pressure, type of fluid, etc. A special feature of the proposed system, compared to traditional systems, lies in that input and output of the thermoregulatory fluid within the same component is made by different channels, which mainly are connected between them, by channels having an individual cross section considerably smaller, which are mainly responsible to perform the desired thermoregulation. It has been found that for some applications the cross section of the input channel (sometimes there may be more than one channel, in this case cross section will be summed), it will be desirable to be at least 3 times higher than the section of the smaller channel of all the channels contributing in the desired area of the component where the thermoregulation is desired, preferably above 6 times, more preferably above 11 times, and even above 110 times.

As can be found in the schematic representation in FIG. 1A, the thermoregulation fluid enters into the component by a main channel (or several channels, in the schematic representation only can be found one channel, but in the same way there may be several inputs or main entrance channels), the fluid is divided into several secondary channels until arrive to the fine channels of desired heat exchange. It has been found that for some applications it will be desirable that the main input channels have several divisions (branches), it will be desirable 3 or more, preferably 6 or more, more preferably 22 or more and even 110 or more. As previously defined, the secondary channels may have several division orders (tertiary channels, quaternary channels, . . . ) it has been found that for some applications it will be desirable to have a high division order of the input channels, for these applications it will be desirable a division order of 3 or more, preferably 4 or more, more preferably 6 or more and even 12 or more. There are applications wherein an excessive division order in the input channels can be negative, for these applications it will be desirable a division order of 18 or less, preferably 8 or less, more preferably 4 or less, and even 3 or less. It has been found that for some applications it will be desirable that the secondary input channels have several divisions; it will be desirable 3 or more, more preferably 6 or more, more preferably 22 or more, even 110 or more. Related to the heat exchange channels as previously discussed in preceding paragraphs, it will be often desirable that these channels will be close to the thermoregulation surface, close between them to have an homogenous regulation and in applications with a high mechanic solicitation it will be desirable a small channel section, which increases fluid pressure drops and it will be desirable not being too long. FIG. 1B shows a schematic representation, a bird's eye view, of a possible sub-superficial distribution of the fine channels in the desired exchange zone or active surface. For some applications it has been found that it will be specially desirable that individually the fine channels under the active surface don't have an excessive average length (effective length, the length of the section under the active surface wherein efficient thermoregulation is desired, not accounting the section that carried the fluid from the secondary channels, eventually also from main channels, to the section wherein the heat exchange with the active surface is efficient, the average value due to the very fine channel may have a different length and hence the arithmetic average value is used as in the rest of the document, unless otherwise it is indicated), in these applications it will be desirable an average value of less than 1.8 m, preferably less than 450 mm, more preferably less than 180 mm and even less than 98 mm. For some applications it will be desirable to work with a very small cross section channels or minimize pressure drops due to any other reason, in this case it will be desirable an average effective lengths of less than 240 mm, preferably less than 74 mm, more preferably less than 48 mm and even of less than 18 mm. For several applications, the end of the fine channel acts as discontinuity and for this or other reasons it will be desirable a minimum average effective length of 12 mm or more, preferably above 32 mm, more preferably above 52 mm and even above 110 mm.

For several applications it will be desirable a high sub-superficial fine channels under the active surfaces where thermoregulation is desired. In this sense if sub-superficial fine channels are cut at the point where has the higher cross section and the zone to be thermoregulated is evaluated, which is the channel surface density where the channels are present, this means which percentage of the total area performs the channel area (which can be referred as fine channels surface density), it has been found that for some applications it will be desirable fine channel higher than 12%, preferably higher than 27%, more preferably higher than 42%, and even higher than 52%. There are applications wherein a very homogenous or intensive heat exchange is required, wherein fine channels surface densities are desired 62% or more, preferably higher than 72%, more preferably higher than 77% and even higher than 86%. For some applications, and excessive fine channel surface density may bring mechanical failure of the component or other problems, in such cases it will be desirable a fine channel surface density of 57% or lower, preferably 47% or lower, more preferably 23% or lower and even 14% or lower. It has been found that for some applications which is important is to control the ratio H=Total length (sum) of the fine channels effective part/average length of the fine channels effective part. It has been found that for some applications it will be desirable a H ratio higher than 12, preferably higher than 110, more preferably higher than 1100 and even higher than 11000. For some applications an excessive H ratio may be negative, for such applications it will be desirable an H ratio lower than 900, preferably lower than 230, more preferably lower than 90 and even lower than 45. There are also applications wherein it is desirable a certain number of fine channels per square metre. For some applications it will be desirable 110 or more fine channels per square metre, preferably more than 1100 or more, more preferably 11000 or more and even 52000 or more. It has been found that for some applications it will be desirable that the main channels output have several divisions, it will be desirable 3 or more, preferably 6 or more, more preferably 22 or more and even 110 or more. As defined, secondary channels may have several division orders (tertiary channels, quaternary channels.) it has been found that for some applications it will be desirable a high division order in channels output, for such applications it will be desirable a division order of 2 or more, preferably 4 or more, more preferably 6 or more and even 12 or more. There are applications wherein an excessive division order in channels output can be negative, for such applications it will be desirable a division order of 18 or less, preferably 8 or less, more preferably 4 or less and even 3 or less. It has been found that for some applications it will be desirable that output secondary channels have several divisions, it will be desirable 3 or more, preferably 6 or more, more preferably 22 or more and even 110 or more.

For some applications it will be more desirable give up excessive divisions, so in this applications there will not be secondary channels, it is moving from primary channels to thermoregulation fine channels.

It has been found that for certain applications wherein a fluid for thermoregulation is used it will be suitable that the fluid will be a water-base fluid, it will be desirable a 42% in volume or more water, preferably 52% or more, more preferably 86% or more and even 96% or more. It has been found that for several application it will be interesting that the organic-based fluid will be mainly a mineral oil, in such cases it will be desirable the mineral oil in quantity of at least 32% in volume, preferably 52% or more, more preferably 78% or more, and even 92% or more. It has been found that for some applications it will be interesting that the organic-based fluid will be mainly an aromatic organic component, in such cases it will be desirable the aromatic organic component at least 32% in volume, preferably more than 52% or more, more preferably 78% or more and even 92% or more.

It has been found that for some applications it will be interesting that the organic-based fluid will be mainly vegetal oil, in such cases it will be interesting the amount of vegetal oil to be at least 32% in volume, preferably 52% or more, more preferably 78% or more, and even 92% or more. It has been found that for some applications it will be interesting that the organic-based fluid will be mainly a non-aromatic organic component, in such cases it will be interesting that the quantity of non-aromatic organic component will be at least 32% in volume, preferably 52% or more, more preferably 78% or more, and even 92% or more. It has been found that for some applications it will be interesting that the thermoregulatory fluid will be a gas. It has been found that for some applications it will be interesting that the thermoregulatory fluid will be a mist. In some of these applications it has been found that is suitable that the gas and/or mist enter into the component with certain pressure, usually it is desired an absolute inlet pressure of 2.2 bar or more, preferably 11 bar or more, more preferably 110 bar or more, and even 1100 bar or more. It has been found that in some applications wherein the thermoregulatory fluid is a liquid, it is suitable that the liquid enter into the component with certain pressure, usually it is desired an absolute inlet pressure of 2.2 bar or more, preferably 5.5 bar or more, more preferably 11 bar or more, and even 22 bar or more.

For some applications, for example when the component is a piece or tool that has to cool the piece that is conforming, it is interesting to have a high cooling rate of the processed component. This can be done with the present invention using conformal cooling, with the channels very close to the surface, also with the system described in the preceding paragraphs. For some applications, the present invention, allows use the latent heat of vaporization from a fluid for cooling fast. A possible execution consists on a replicate of the sweating system of the human body. By analogy in this document it is denominated sweeting component (sometimes, especially when reference is made to applications wherein the component is a die, mould or tool in general, it can be referred as sweeting die). It consists on a die having small holes which transport small fluid quantities to the active evaporation surface. For some applications it is desired a controlled drip scenario.

For some applications it is even desired a jet or more massive water supply. For some applications it is desired a scenario of incomplete drop formation in the active evaporation surface, this means a drop that does not break off from the evaporation surface unless it transforms to steam. To determine the scenario that takes place, fluid pressure, surface tension and the configuration of fluid transporting internal channels and the outlet holes in the active evaporation surface, among others must be controlled. Often it is suitable to implement a system with controlled pressure drop for a better pressure balance in the different holes.

Although often the fluid to be evaporated in the evaporation surface is water, an aqueous solution or an aqueous suspension, several other fluids can be used, so the term water can be replaced by other fluids which may evaporate with latent heat of vaporization associated. It has been found that for some applications it is interesting that the diameter of the tubes for transporting fluid to the active surface are small. In those cases it is desirable less than 1.4 mm, preferably less than 0.9 mm, more preferably 0.45 mm and even less than 0.18 mm. For some applications it is interesting that the diameter of the tubes for transporting fluid to the active evaporation surface is not too small, in those cases it is desirable greater than 0.08 mm, preferably greater than 0.6, more preferably greater than 1.2 mm and even greater than 2.2 mm. For some applications it has been found that the pressure applied to the fluid in the tubes for transporting fluid to the active surface should not be too small, for those cases it is desirable a differential pressure (difference with the gas pressure on the evaporation surface) of 0.8 bar or less, preferably 0.4 bar or less, more preferably 0.08 bar or less, and even 0.008 bar or less. For some applications it has been found that it is interesting regulate the number of fluid average drops emerging from the holes in the tubes wherein fluid is transported to the active evaporation surface. For some applications it has been found that it is interesting that the average drop number emerging from the holes in the tubes for conducting fluid to the active evaporation surface must not be too high, for those cases it is desirable a number of drops per minute lower than 80, preferably lower than 18, more preferably lower than 4 and even lower than 0.8. As previously disclosed, there are applications wherein it is undesirable drops breaking off itself from the end of the holes. For some applications it has been found that the number of average drop emerging from the holes in the tubes for conducting fluid to the active evaporation surface must not be too low, for those cases it is desirable a number of drops per minute greater than 80, preferably greater than 18, more preferably greater than 4 and even greater than 0.8. It has been found that for some applications is very important the control of the tubes number to transport the fluid to the active evaporation surface per unity of active evaporation surface. In this sense for some applications it is suitable to have more than 0.5 tubes per cm2, preferably more than 1.2 tubes per cm2, more preferably more than 6 tubes per cm2 and even more than 27 tubes per cm2. For some applications the important is the percentage of the active evaporation surface which is holes. In this sense for some applications it is desirable that at least a percentage greater than 1.2% of the contact area surface is hole, preferably greater than 28% and even greater than 62%. For some applications it has been found that it is desirable that the average distance between the holes centres in the active evaporation surface will be less than 12× the hole diameter, preferably less than 8×, more preferably less than 4×, and even less than 1.4×. For some applications it is important the surface tension of the fluid being evaporated to be significant, in those cases it is desirable to be greater than 22 mM/m, preferably greater than 52 mM/m, more preferably greater than 70 mM/m, and even greater than 82 mM/m. For some applications it is important the surface tension of the fluid being evaporated not to be excessive, in those cases it is desirable to be lower than 75 mm/m, preferably lower than 69 mM/m, more preferably lower than 38 mM/m, and even lower than 18 mM/m.

For some applications it is quite important the way of providing the fluid to be evaporated to the tubes for transporting the fluid to the active evaporation surface. Often this input is made through a network of channels inside the component. These channels may have different geometries and have accumulation zones and also it is interesting as previously disclosed to have controlled pressure drop zones to equilibrate different zones. The mission of this channel framework in addition to providing the desired flow to each of the tube, for some applications it is interesting that the pressure in the outlet tube or at least a part of them is fairly homogeneous. The techniques developed for drip irrigation systems, among others, can be replicated (sometimes with some adaptation due to downsize, but replicating the concept) for this purpose. The inventor has found that for some applications it is desirable that the pressure difference of the fluid which evaporates to reach the outlet tubes for transporting fluid to the active evaporation surface, for a representative group, to be lower than 8 bar, preferably lower than 4 bar, more preferably lower than 1.8 bar and even lower than 0.8 bar. For holes that do not require large pressures, as it is often the case of holes with not too thin diameter, it has been found that for some applications it is desirable a difference lower than 400 mbar, preferably lower than 90 mbar, more preferably lower than 8 mbar and even lower than 0.8 mbar. A representative group of tubes are for the same surface evaporation, in areas wherein the same evaporation intensity of 35% or more of the tubes in the aforementioned area is required, preferably 55% or more, more preferably 85% or more and even 95% or more. For some applications, especially also for some applications when different evaporation intensities are required in different areas, it is desirable that the difference of pressure of the fluid which evaporates when arrive to the tube outlets for the transport of the fluid to the active evaporation surface, for the hole with higher pressure and the hole with less pressure, to be greater than 0.012 bar, preferably greater than 0.12 bar, more preferably greater than 1.2 bar and even greater than 6 bar.

One possible implementation of the sweating component is shown in FIG. 2. These images are an illustrative example of a possible implementation to promote understanding, in no case it is a representation of how to implement the invention, since there are many implementations and it would be disproportionate try to illustrate all of them in detail. The selected implementation for the figure is not the more effective but it can be selected due it is believed that can better contribute to understanding the concept and to a rapid spread, to develop the implementation of the concept optimized for each particular application. In FIG. 2A it is intended to represent a hypothetical (or possible) cross section wherein a system of sub-superficial channels distribute the fluid to be evaporated to finally brought the fluid to the active evaporation surface, in which holes it is shown the formation of a drop. In this representation it must be understand that out of the plane, and therefore not visible in the representation, there are several tubes to transport the fluid to the active evaporation surface that feed on the same sub-superficial division. In FIG. 2B a possible distribution of the tube outlets to transport the fluid to the active evaporation surface is shown in a birds eye representation. In FIG. 2C is shown a schematic representation of a possible implementation of a mould part manufactured by additive manufacturing which is responsible of achieving the tubes to transport the fluid to the active evaporation surface and its corresponding holes.

Although often the cooling channels, and the holes outputs as well as the tubes to transport the fluid to the active evaporation surface, are circular, they can be of any other geometry in its cross section as well as of variable geometry, depending on the application. This applies to the entire document unless otherwise is specified.

An interesting application for the sweeting die, like the thermoregulation systems explained in this entire document and even combinations of both is hot stamping. The combination of sweeting dies with any of the thermoregulation systems explained throughout this document may be interesting for many applications besides the hot stamping. All that is mentioned for hot stamping, or part of this, may be extended to other applications, especially those where there is a component to be cooled that at least can accept direct contact with water or steam.

For applications where the contact with water is not acceptable, the tubes that go to the active surface can be infiltrated with a metal or a high thermal conductivity alloy, such as Ag, Cu, Al . . . . Then the tubes or channels to the surface will transport the heat better contributing to the total heat removal capacity of this active surface component. In fact in this way the thermoregulation capacity is improved both in the sense of cooling and heating, and can be used for some heat & cool applications. For some applications it is not suitable the metal or high thermal conductivity alloy outcropping to the active surface, at least in some areas, in those cases tubes may lack holes and finish below the active surface, before infiltration, so the metal or the high thermal conductivity alloy does not reach the surface.

In an embodiment the design of the cooling channel, the determination of the sizes, types of cooling channels, length of the channels, distance to the working surface as well as the flow rate of coolant among others may be done using any available simulation software.

In the context of the present invention the distance between the working surface of the tool, die, piece or mould and the channel refers to the minimum distance between any point of the channel surrounding and the working surface of the tool, die, piece or mould.

In an embodiment of the invention the shape of the channels do not have a constant section.

In an embodiment of the invention, the channels have a minimum shape and a maximum shape.

In the context of the present invention the average distance, is referred to the average value (where you sum all the numbers and then divide by the number of numbers) of the distance between the different channel surrounding sections and the working surface of the tool, die, piece or mould. In this context the minimum average distance refers to the minimum average distance between the channel surrounding and the working surface of the tool, die, piece or mould.

In an embodiment the channels are close to the working surface of the tool, die, piece or mould at a distance between the channel surrounding and the working surface of less than 75 mm.

In another embodiment the distance between the channel surrounding and the working surface of the tool, die, piece or mould is less than 51 mm, in another embodiment the distance is less than 46 mm, in another embodiment the distance is less than 39 mm, in another embodiment the distance is less than 27 mm, in another embodiment the distance is less than 19 mm, in another embodiment the distance is less than 12 mm, in another embodiment the distance is less than 10 mm, in another embodiment the distance is less than 8 mm, in another embodiment is less than 7.8 mm, in another embodiment the distance is less than 7.4 mm, in another embodiment the distance is less than 6.9 mm, in another embodiment the distance is less than 6.4 mm, in another embodiment the distance is less than 5.8 mm, in another embodiment the distance is less than 5.4 mm, in another embodiment the distance is less than 4.9 mm, in another embodiment the distance is less than 4.4 mm, in another embodiment the distance is less than 3.9 mm, and even in another embodiment the distance is less than 3.4 mm.

In an embodiment of the invention the shape of the cooling channels of the tool, die, piece or mould are selected from circular, square, rectangular, oval or half circle.

In an embodiment the cooling channels of the tool, die, piece or mould include primary channels and/or secondary channels and/or capillary channels; in another embodiment the cooling channels of the tool, die, piece or mould include primary channels; in another embodiment the cooling channels of the tool, die, piece or mould include primary channels and secondary channels, in another embodiment the cooling channels of the tool, die, piece or mould include primary channels and secondary channels and capillary channels, in another embodiment the cooling channels of the tool, die, piece or mould include primary channels and capillary channels; in another embodiment the cooling channels of the tool, die, piece or mould include secondary channels and capillary channels; in another embodiment the cooling channels of the tool, die, piece or mould include secondary channels; in another embodiment the cooling channels of the tool, die, piece or mould include capillary channels.

In an embodiment, for constant sections of the primary channels, the shape of the primary channels of the tool, die, piece or mould have a shape area of less than 2041.8 mm²; in another embodiment, the shape of the primary channels of the tool, die, piece or mould have a shape area of less than 1661.1 mm²; in another embodiment, the shape of the primary channels of the tool, die, piece or mould have a shape area of less than 1194 mm²; in another embodiment, the shape of the primary channels of the tool, die, piece or mould have a shape area of less than 572.3 mm²; in another embodiment, the shape of the primary channels of the tool, die, piece or mould have a shape area of less than 283.4 mm²; in another embodiment, the shape of the primary channels of the tool, die, piece or mould have a shape area of less than 213.0 mm²; in another embodiment, the shape of the primary channels of the tool, die piece or mould have a shape area of less than 149 mm²; in another embodiment, the shape of the primary channels of the tool, die, piece or mould have a shape area of less than 108 mm² in another embodiment, the shape of the primary channels of the tool, die, piece or mould have a shape area of less than 42 mm²; in another embodiment, the shape of the primary channels of the tool, die, piece or mould have a shape area of less than 37 mm²; in another embodiment, the shape of the primary channels of the tool, die, piece or mould have a shape area of less than 31 mm²; in another embodiment, the shape of the secondary channels of the tool, die, piece or mould have a shape area of less than 28 mm²; in another embodiment, the shape of the primary channels of the tool, die, piece or mould have a shape area of less than 21 mm²; in another embodiment, the shape of the primary channels of the tool, die, piece or mould have a shape area of less than 14 mm²; in another embodiment, the shape of the primary channels of the tool, die, piece or mould is between 56 mm² and 21 mm²; in another embodiment, the shape of the primary channels of the tool, die, piece or mould is between 56 mm² and 14 mm².

In an embodiment, when the section is not constant, the value of the above shape of the primary channels of the tool, die, piece or mould is referred to the minimum shape of the primary channel.

In an embodiment, for constant sections of the secondary channels, the shape of the secondary channels of the tool, die, piece or mould have a shape area of less than 122.3 mm²; in another embodiment, the shape of the secondary channels of the tool, die, piece or mould have a shape area of less than 82.1 mm2; in another embodiment, the shape of the secondary channels of the tool, die, piece or mould have a shape area of less than 68.4 mm2; in another embodiment, the shape of the secondary channels of the tool, die, piece or mould have a shape area of less than 43.1 mm²; in another embodiment, the shape of the secondary channels of the tool, die, piece or mould have a shape area of less than 26.4 mm²; in another embodiment, the shape of the secondary channels of the tool, die, piece or mould have a shape area of less than 23.2 mm²; in another embodiment, the shape of the secondary channels of the tool, die, piece or mould have a shape area of less than 18.3 mm²; in another embodiment, the shape of the secondary channels of the tool, die, piece or mould have a shape area of less than 14.1 mm²; in another embodiment, the shape of the secondary channels of the tool, die, piece or mould have a shape area of less than 11.2 mm²; in another embodiment, the shape of the secondary channels of the tool, die, piece or mould have a shape area of less than 9.3 mm²; in another embodiment, the shape of the secondary channels of the tool, die, piece or mould have a shape area of less than 7.2 mm²; in another embodiment, the shape of the secondary channels of the tool, die, piece or mould have a shape area of less than 6.4 mm²; in another embodiment o, the shape of the secondary channels of the tool, die, piece or mould have a shape area of less than 5.8 mm²; in another embodiment, the shape of the secondary channels of the tool, die, piece or mould have a shape area of less than 5.2 mm²; in another embodiment, the shape of the secondary channels of the tool, die, piece or mould have a shape area of less than 4.8 mm²; in another embodiment, the shape of the secondary channels of the tool, die, piece or mould have a shape area of less than 4.2 mm²; in another embodiment of the invention, the shape of the secondary channels of the tool, die, piece or mould have a shape area of less than 3.8 mm²; in another embodiment, the shape of the secondary channels of the tool, die, piece or mould is between 7.8 mm² and 3.8 mm²; in another embodiment, the shape of the secondary channels of the tool, die, piece or mould is between 5.2 mm² and 3.8 mm².

In an embodiment, when the section is not constant, the value of the above shape of the secondary channels of the tool, die, piece or mould is referred to the minimum shape of the secondary channel.

In an embodiment, for constant sections of the capillary channels the shape of the capillary channels of the tool, die, piece or mould have a shape area of less than 1.6 mm²; in another embodiment, the shape of the capillary channels of the tool, die, piece or mould have a shape area of less than 1.2 mm²; in another embodiment, the shape of the capillary channels of the tool, die, piece or mould have a shape area of less than 0.8 mm²; in another embodiment, the shape of the capillary channels of the tool, die, piece or mould have a shape area of less than 0.45 mm²; in another embodiment, the shape of the capillary channels of the tool, die, piece or mould have a shape area of less than 0.18 mm²; in another embodiment the shape of the secondary channels of the tool, die, piece or mould is between 1.6 mm² and 0.18 mm²; in another embodiment, the shape of the capillary channels of the tool, die, piece or mould is between 1.6 mm² and 0.45 mm²; in another embodiment, the shape of the capillary channels of the tool, die, piece or mould is between 1.2 mm² and 0.45 mm².

In an embodiment, when the section is not constant, the value of the above shape of the capillary channels of the tool, die, piece or mould is referred to the minimum shape of the capillary channel.

In the context of the present invention, the equivalent diameter is referred to the equivalent spherical diameter of any other shape, including square, rectangular, oval and half circle shapes among other more complex shapes.

In an embodiment, for other shapes of the secondary channels different from circular shapes and including square, rectangular, oval and half circle shapes among other shapes, the shape of the secondary channels of the tool, die, piece or mould have a shape area of less than 1.4 times the equivalent diameter; in another embodiment of the invention, the shape of the secondary channels of the tool, die, piece or mould have a shape area of less than 0.9 times the equivalent diameter; in another embodiment, the shape of the secondary channels of the tool, die, piece or mould have a shape area of less than 0.7 times the equivalent diameter; in another embodiment, the shape of the secondary channels of the tool, die, piece or mould have a shape area of less than 0.5 times the equivalent diameter; in another embodiment, the shape of the secondary channels of the tool, die, piece or mould have a shape area of less than 0.18 times the equivalent diameter.

In an embodiment the shape of the secondary channels and capillary channels do not have a constant section. In an embodiment of the invention, the secondary channels have a minimum shape and a maximum shape. In an embodiment, the capillary channels have a minimum shape and a maximum shape.

In an embodiment the sum of the minimum shapes of all the capillary channels connected to a secondary channel must be equal to the shape of the secondary channel to which are connected. In another embodiment of the invention the sum of the minimum shapes of all the capillary channels connected to a secondary channel are at least 1.2 times the shape of the secondary channel to which are connected.

In an embodiment the sum of the maximum shapes of all the capillary channels connected to a secondary channel are more than the shape of the secondary channel to which are connected. In another embodiment the sum of the maximum shapes of all the capillary channels connected to a secondary channel are at least 1.2 times the shape of the secondary channel to which are connected.

In an aspect of the present invention, the inventor has seen that for some applications it is very interesting to have a material capable of having a high wear resistance with low cost.

The inventor has seen that a way to achieve such feature consists on the selection of the right composition within the following range followed by the right thermomechanical processing:

| | | | |
|---|---|---|---|
| % Ceq = 0.61-3.5 | % C = 0.41-2.9 | % N = 0-0.4 | % B = 0-3.0 |
| % Cr = 0-11.9 | % Ni = 0-5.9 | % Si = 0-3.9 | % Mn = 1.6-11.9 |
| % Al = 0-4.9 | % Mo = 0-4.4 | % W = 0-7.8 | % Ti = 0.55-9.0 |
| % Ta = 0-4.9 | % Zr = 0-4.9 | % Hf = 0-3 | % V = 0-9.9 |
| % Nb = 0-2.8 | % Cu = 0-3.9 | % Co = 0-2.9 | % La = 0-0.2 |
| % Ce = 0-5 0.2 | % Cs = 0-0.2 | % Moeq = 0-4.4 | |

the rest consisting of iron and trace elements wherein,

% Ceq=% C+0.86*% N+1.2*% B; and

% Moeq=% Mo+½% W; and

% Mn+% Zr+% Ta+% Hf+% Ti>2.1%

In this document trace elements is considered any element, not explicitly indicated and in an amount of less than 0.9%. For some particular embodiments trace elements are required to be less than 0.4%. For some particular embodiments trace elements are required to be less than 0.18%. For some particular embodiments trace elements are required to be less than 0.06%. As previously mentioned, the notion less than an amount includes the explicit absence. Possible elements considered as trace elements are: H, Li, Na, K, Rb, Fr, Be, Mg, Ca, Sr, Ba, Ra, Ac, Tc, Re, Ru, Os, Rh, Ir, Pd, Pt, Ag, Au, Zn, Cd, Hg, B, Ga, In, Tl, Ge, Sn, Pb, P, As, Sb, Bi, O, S, Se, Te, Po, F, Cl, Br, I, At, He, Ne, Ar, Kr, Xe, Rn, Th, Pa, U, Np, Pu, Am, Cm, Bk, Cf, Es, Fm, Md, No and Lr alone and/or in combination. In many applications, the absence of most trace elements or even its entirety is obvious and/or desirable. As mentioned each trace element is considered an entity and therefore in many embodiments of the present invention different trace elements have different admissible amounts. The trace elements may have an intentional presence to look for a given functionality described in the state of the art or even cost reduction or alternatively the presence of the trace element (if present) may also be accidental and related to the lack of purity of the alloying and scrap elements used to produce the material. The reason for the presence of different trace elements may be different for the same alloy.

Carbon equivalent is important and of great importance in determining the majority of relevant properties. When high wear resistance is required the % Ceq cannot be too low. For some embodiments of the present invention, the inventor has seen that it is desirable % Ceq greater than 0.81%. For some embodiments of the present invention, the inventor has seen that it is desirable % Ceq greater than 1.06%. For some embodiments of the present invention, the inventor has seen that it is desirable % Ceq greater than 1.22%. For some embodiments of the present invention, the inventor has seen that it is desirable % Ceq greater than 1.65%. For some embodiments of the present invention, the inventor has seen that it is desirable % Ceq greater than 2.02%. When high toughness and/or elongation is required It is often desirable % Ceq not being too high. For some embodiments of the present invention the inventor has seen that it is desirable % Ceq less than 2.98%. For some embodiments of the present invention the inventor has seen that it is desirable % Ceq less than 1.98%. For some embodiments of the present invention the inventor has seen that it is desirable % Ceq less than 1.48%. For some embodiments of the present invention the inventor has seen that it is desirable % Ceq less than 0.9%.

When high wear resistance is required the % C cannot be too low. For some embodiments of the present invention, the inventor has seen that it is desirable % C greater than 0.81%.

For some embodiments of the present invention, the inventor has seen that it is desirable % C greater than 1.06%. For some embodiments of the present invention, the inventor has seen that it is desirable % C greater than 1.22%. For some embodiments of the present invention, the inventor has seen that it is desirable % C greater than 1.65%. For some embodiments of the present invention, the inventor has seen that it is desirable % C greater than 2.02%. When high toughness and/or elongation is required It is often desirable % C not being too high. For some embodiments of the present invention the inventor has seen that it is desirable % C less than 2.98%. For some embodiments of the present invention the inventor has seen that it is desirable % C less than 1.98%. For some embodiments of the present invention the inventor has seen that it is desirable % C less than 1.48%. For some embodiments of the present invention the inventor has seen that it is desirable % C less than 0.9%.

Sometimes within the carbon equivalent, it is desired % N content not being excessive. For some embodiments of the present invention the inventor has seen that it is desirable % N less than 0.09%. For some embodiments of the present invention the inventor has seen that it is desirable % N less than 0.004%. For some embodiments of the present invention the inventor has seen that it is desirable % N being absent. For some embodiments of the present invention % N can help to improve hardenability. For some embodiments of the present invention, the inventor has seen that it is desirable % N greater than 0.06%. For some embodiments of the present invention, the inventor has seen that it is desirable % N greater than 0.11%.

Sometimes within the carbon equivalent, it is desired % B content not being excessive. For some embodiments of the present invention the inventor has seen that it is desirable % B less than 0.03%. For some embodiments of the present invention the inventor has seen that it is desirable % B less than 0.019%. For some embodiments of the present invention the inventor has seen that it is desirable % B less than 0.009%. For some embodiments of the present invention the inventor has seen that it is desirable % B being absent. For some embodiments of the present invention % B can help to improve hardenability, especially retarding ferritic transformation. For some embodiments of the present invention, the inventor has seen that it is desirable % B greater than 0.002%. For some embodiments of the present invention, the inventor has seen that it is desirable % B greater than 1.4%. For some embodiments of the present invention, the inventor has seen that it is desirable % B greater than 3.1%.

Chromium content is important and has a great importance in determining the majority of relevant properties, since its presence in secondary carbides is almost always of great influence. When mechanical resistance is required without excessive sacrifice of toughness, % Cr cannot be too low. For some embodiments of the present invention, the inventor has seen that it is desirable % Cr greater than 3.6%. For some embodiments of the present invention, the inventor has seen that it is desirable % Cr greater than 5.2%. For some embodiments of the present invention, the inventor has seen that it is desirable % Cr greater than 6.5%. When high toughness and/or elongation is required often is desired % Cr not being too high. This is further the case when the presence of other carbide formers like % V, % Mo and/or % W is high. For some embodiments of the present invention the inventor has seen that it is desirable % Cr less than 9.5%. For some embodiments of the present invention the inventor has seen that it is desirable % Cr less than 8.5%. For some embodiments of the present invention the inventor has seen that it is desirable % Cr less than 4.9%.

Manganese content is important and has a great importance in the present invention. Inventor has seen that surprisingly from a specific content of % Mn, especially when properly combined with % Zr, % Ti, % Si, % V, and/or % Cr, the materials of the present aspect of the invention can present a high hardness increase upon the application of a low temperature heat treatment. The critical content depends on the specific quantities of the other elements in the alloy. For some embodiments of the present invention, the inventor has seen that it is desirable % Mn greater than 1.8%. For some embodiments of the present invention, the inventor has seen that it is desirable % Mn greater than 3.6%. For some embodiments of the present invention, the inventor has seen that it is desirable % Mn greater than 4.6%. For some embodiments of the present invention, the inventor has seen that it is desirable % Mn greater than 5.6%. For some embodiments of the present invention, the inventor has seen that it is desirable % Mn greater than 6.6%. For some embodiments of the present invention, the inventor has seen that it is desirable % Mn greater than 7.6%. An excessive content of % Mn, and depending on the quantities of other elements in the alloy, has been seen that can negatively affect the ease of machining of the steel. For some embodiments of the present invention the inventor has seen that it is desirable % Mn less than 9.8%. For some embodiments of the present invention the inventor has seen that it is desirable % Mn less than 7.8%. For some embodiments of the present invention the inventor has seen that it is desirable % Mn less than 5.8%.

Nickel content is important and has a great importance, in particular its capability to increase hardness and control precipitation. For some embodiments of the present invention, the inventor has seen that it is desirable % Ni greater than 0.25%. For some embodiments of the present invention, the inventor has seen that it is desirable % Ni greater than 1.52%. For some embodiments of the present invention, the inventor has seen that it is desirable % Ni greater than 2.52%. For some embodiments of the present invention, the inventor has seen that it is desirable % Ni greater than 3.02%. When high toughness is required, amongst others, often it is desired % Ni not being too high. For some embodiments of the present invention the inventor has seen that it is desirable % Ni less than 4.8%. For some embodiments of the present invention the inventor has seen that it is desirable % Ni less than 2.78%. For some embodiments of the present invention the inventor has seen that it is desirable % Ni less than 0.49%.

For some embodiments of the present invention the inventor has seen that it is desirable % Ni being absent from the composition.

Silicon content is important and has a great importance, in particular its capability to increase hardness and control precipitation. For some embodiments of the present invention, the inventor has seen that it is desirable % Si greater than 0.25%. For some embodiments of the present invention, the inventor has seen that it is desirable % Si greater than 1.52%. For some embodiments of the present invention, the inventor has seen that it is desirable % Si greater than 1.82%. For some embodiments of the present invention, the inventor has seen that it is desirable % Si greater than 2.52%. For some embodiments of the present invention, the inventor has seen that it is desirable % Si greater than 3.02%. Inventor has seen than for some compositions, % Si can be negatively affecting the obtainable values of toughness for high thicknesses. For some embodiments of the present invention the inventor has seen that it is desirable % Si less than 0.4%. For some embodiments of the present invention the inventor has seen that it is desirable % Si less than 0.18%. For some embodiments of the present invention the inventor has seen that it is desirable % Si less than 0.08%. For some embodiments of the present invention the inventor has seen that it is desirable % Si less than 0.04%. For some embodiments of the present invention the inventor has seen that it is desirable % Si being absent from the composition.

Inventor has seen that for some compositions the sum of % Se+% Te+% S+% P+% As+% Pb+% Sb+% Sn can favor machining. For some embodiments of the present invention, the inventor has seen that it is desirable further include in the steel composition % Se+% Te+% S+% P+% As+% Pb+% Sb+% Sn greater than 0.052%. But often the sum % Se+% Te+% S+% P+% As+% Pb+% Sb+% Sn has a negative effect on toughness. For some embodiments of the present invention, the inventor has seen that it is desirable % Se+% Te+% S+% P+% As+% Pb+% Sb+% Sn less than 0.04%. For some embodiments of the present invention, the inventor has seen that it is desirable % Se+% Te+% S+% P+% As+% Pb+% Sb+% Sn less than 0.008%. For some embodiments of the present invention, the inventor has seen that it is desirable % Se+% Te+% S+% P+% As+% Pb+% Sb+% Sn being absent.

Inventor has seen that for some compositions the sum of % Ta+% Nb can favor wear resistance. For some embodiments of the present invention, the inventor has seen that it is desirable further include in the steel composition % Ta+% Nb greater than 0.22%. For some embodiments of the present invention, the inventor has seen that it is desirable % Ta+% Nb more than 0.54%. For some embodiments of the present invention, the inventor has seen that it is desirable % Ta+% Nb more than 1.6%. For some embodiments of the present invention, the inventor has seen that it is desirable % Ta+% Nb more than 2.04%. But often the sum % Ta+% Nb has a negative effect on toughness. For some embodiments of the present invention, the inventor has seen that it is desirable % Ta+% Nb less than 0.4%. For some embodiments of the present invention, the inventor has seen that it is desirable % Ta+% Nb less than 0.08%. For some embodiments of the present invention, the inventor has seen that it is desirable % Ta+% Nb being absent.

Inventor has seen that for some compositions the sum of % Se+% Te can favor machining. For some applications of the present invention, the inventor has seen that it is desirable further include in the steel composition % Se+% Te greater than 0.052%. But often the sum % Se+% Te has a negative effect on the steels of the present invention especially when % Mn is high and can disrupt the positive effect of a high % Mn. For some applications of the present invention, the inventor has seen that it is desirable % Se+% Te less than 0.19%. For some applications of the present invention, the inventor has seen that it is desirable % Se+% Te less than 0.09%. For some applications of the present invention, the inventor has seen that it is desirable % Se+% Te less than 0.04%. For some applications of the present invention, the inventor has seen that it is desirable % Se+% Te less than 0.008%. For some applications of the present invention, the inventor has seen that it is desirable % Se+% Te being absent.

For some applications of the present invention, the inventor has seen that % P+% S are further contained in the steel composition. Inventor has seen that for some compositions % P+% S have a negative effect on the steels of the present invention especially when % Mn is high and can disrupt the positive effect of a high % Mn. For some applications of the present invention the inventor has seen that it is desirable % P+% S less than 0.028%. For some applications of the present invention the inventor has seen that it is desirable % P+% S less than 0.018%. For some applications of the present invention the inventor has seen that it is desirable % P+% S less than 0.008%. For some applications of the present invention the inventor has seen that it is desirable % P+% S less than 0.0004%. For some applications of the present invention the inventor has seen that it is desirable % P+% S being absent from the composition.

For some applications of the present invention, the inventor has seen that P is further contained in the steel composition. Inventor has seen that for some compositions % P has a negative effect on the steels of the present invention especially when % Mn is high and can disrupt the positive effect of a high % Mn. For some applications of the present invention the inventor has seen that it is desirable % P less than 0.028%. For some applications of the present invention the inventor has seen that it is desirable % P less than 0.018%. For some applications of the present invention the inventor has seen that it is desirable % P less than 0.008%. For some applications of the present invention the inventor has seen that it is desirable % P less than 0.0008%. For some applications of the present invention the inventor has seen that it is desirable % P being absent from the composition.

For some applications of the present invention, the inventor has seen that S is further contained in the steel composition. Inventor has seen that for some compositions % S has a negative effect on the steels of the present invention especially when % Mn is high and can disrupt the positive effect of a high % Mn. For some applications of the present invention the inventor has seen that it is desirable % S less than 0.018%. For some applications of the present invention the inventor has seen that it is desirable % S less than 0.008%. For some applications of the present invention the inventor has seen that it is desirable % S less than 0.0008%. For some applications of the present invention the inventor has seen that it is desirable % S less than 0.0004%. For some applications of the present invention the inventor has seen that it is desirable % S being absent from the composition.

Molybdenum content is important and has a great importance in determination of the majority of relevant properties, since its presence in secondary carbides is almost always of great influence. When resistance to temper is required molybdenum cannot be too low. For some embodiments of the present invention, the inventor has seen that it is desirable % Mo greater than 0.16%. For some embodiments of the present invention, the inventor has seen that it is desirable % Mo greater than 0.21%. For some embodiments of the present invention, the inventor has seen that it is desirable % Mo greater than 1.10%. When high toughness and/or elongation is required often is desired % Mo not too high. This is also the case when the presence of other carbide builders like % V, % Cr, and/or % W is high. Also in some instances % Mo can negatively influence the effect of % Zr. For some embodiments of the present invention the inventor has seen that it is desirable % Mo less than 0.8%. For some embodiments of the present invention the inventor has seen that it is desirable % Mo less than 0.19%. For some embodiments of the present invention the inventor has seen that it is desirable % Mo less than 0.04%. For some embodiments of the present invention the inventor has seen that it is desirable % Mo being absent.

Inventor has seen that for some embodiments of the present invention % Mo can be partially replaced by double the amount, in weight of % W. Also for some applications, what is described for % Mo in the preceding paragraph applies for % W but the contents expressed must be double. In this sense it is also interesting the % Moeq concept, for the cases of partial substitution, wherein % Moeq=% Mo+½% W. The desired contents for % Moeq follow the above about % Mo.

Vanadium content is important and has a great importance in determination of the majority of relevant properties, since its presence in secondary carbides is almost always of great influence. When hot hardness is required % V cannot be too low. For some embodiments of the present invention, the inventor has seen that it is desirable % V greater than 0.22%. For some embodiments of the present invention, the inventor has seen that it is desirable % V greater than 0.32%. For some embodiments of the present invention, the inventor has seen that it is desirable % V greater than 0.55%. For some embodiments of the present invention, the inventor has seen that it is desirable % V greater than 1.1%. For some embodiments of the present invention, the inventor has seen that it is desirable % V greater than 2.05%. When high toughness and/or elongation is required often it is desired % V not being too high. This is also the case when the presence of other carbide formers like % Mo, % Cr and/or % W is high. For some embodiments of the present invention the inventor has seen that it is desirable % V less than 3.8%. For some embodiments of the present invention the inventor has seen that it is desirable % V less than 2.8%. For some embodiments of the present invention the inventor has seen that it is desirable % V less than 1.8%. For some embodiments of the present invention the inventor has seen that it is desirable % V less than 0.4%. For some embodiments of the present invention the inventor has seen that it is desirable % V being absent.

Titanium content is important and has a great importance in determination of the majority of relevant properties, since its presence in secondary carbides is almost always of great influence. When hot hardness is required % Ti cannot be too low. For some embodiments of the present invention, the inventor has seen that it is desirable % Ti greater than 0.22%.

For some embodiments of the present invention, the inventor has seen that it is desirable % Ti greater than 0.55%. For some embodiments of the present invention, the inventor has seen that it is desirable % Ti greater than 1.6 For some embodiments of the present invention, the inventor has seen that it is desirable % Ti greater than 2.6%. For some embodiments of the present invention, the inventor has seen that it is desirable % Ti greater than 3.6%. Sometimes it is desired % Ti content not being excessive. For some embodiments of the present invention the inventor has seen that it is desirable % Ti less than 8.8%. For some embodiments of the present invention the inventor has seen that it is desirable % Ti less than 4.8%. For some embodiments of the present invention the inventor has seen that it is desirable % Ti less than 2.8%. For some embodiments of the present invention the inventor has seen that it is desirable % Ti less than 1.8%. For some embodiments of the present invention the inventor has seen that it is desirable % Ti being absent.

Sometimes it is desired % Co content not being excessive. For some embodiments of the present invention the inventor has seen that it is desirable % Co less than 2.3%. For some embodiments of the present invention the inventor has seen that it is desirable % Co less than 1.2%. For some embodiments of the present invention the inventor has seen that it is desirable % Co being absent. For some embodiments of the present invention % Co can help to improve the properties of the steel. For some embodiments of the present invention, the inventor has seen that it is desirable % Co greater than 0.001%. For some embodiments of the present invention, the inventor has seen that it is desirable % Co greater than 0.10%.

Sometimes it is desired % Cu content not being excessive. For some embodiments of the present invention the inventor has seen that it is desirable % Cu less than 1.1%. For some embodiments of the present invention the inventor has seen that it is desirable % Cu less than 0.4%. For some embodiments of the present invention the inventor has seen that it is desirable % Cu being absent. For some embodiments of the present invention % Cu can help to improve the properties of the steel. For some embodiments of the present invention, the inventor has seen that it is desirable % Cu greater than 0.001%. For some embodiments of the present invention, the inventor has seen that it is desirable % Cu greater than 0.1%.

Sometimes it is desired % Al content not being excessive. For some embodiments of the present invention the inventor has seen that it is desirable % Al less than 0.8%. For some embodiments of the present invention the inventor has seen that it is desirable % Al less than 0.2%. For some embodiments of the present invention the inventor has seen that it is desirable % Al being absent. For some embodiments of the present invention % Al can help to improve the properties of the steel. For some embodiments of the present invention, the inventor has seen that it is desirable % Al greater than 0.6%. For some embodiments of the present invention, the inventor has seen that it is desirable % Al greater than 1.1%.

In an embodiment, the tool steels of this aspect of the present invention can be characterized by a wear resistance higher than 1.2379 at 61 HRc when properly prepared. In an embodiment, the tool steels of this aspect of the present invention can be characterized by a wear resistance higher than double as high as 1.2379 at 61 HRc when properly prepared. In an embodiment, the tool steels of this aspect of the present invention can be characterized by a wear resistance higher than four times as high as 1.2379 at 61 HRc when properly prepared. In an embodiment, the tool steels of this aspect of the present invention can be characterized by a wear resistance higher than eight times as high as 1.2379 at 61 HRc when properly prepared. In an embodiment of the present aspect of the invention, properly prepared refers to an austenitization at 1020° C. during 30 minutes once the core has reached the temperature followed by oil quenching and three tempering cycles. In an embodiment of the present aspect of the invention, properly prepared refers to an austenitization at 1020° C. during 30 minutes once the core has reached the temperature followed by air cooling and three tempering cycles. In an embodiment of the present aspect of the invention, properly prepared refers to an austenitization at 1050° C. during 30 minutes once the core has reached the temperature followed by oil quenching and three tempering cycles. In an embodiment of the present aspect of the invention, properly prepared refers to an austenitization at 1050° C. during 30 minutes once the core has reached the temperature followed by air cooling and three tempering cycles. In an embodiment of the present aspect of the invention, properly prepared refers to an austenitization at 1080° C. during 30 minutes once the core has reached the temperature followed by oil quenching and three tempering cycles. In an embodiment of the present aspect of the invention, properly prepared refers to an austenitization at 1100° C. during 30 minutes once the core has reached the temperature followed by air cooling and three tempering cycles. In an embodiment of the present aspect of the invention, properly prepared refers to an austenitization at 1150° C. during 30 minutes once the core has reached the temperature followed by oil quenching and three tempering cycles. In an embodiment of the present aspect of the invention, properly prepared refers to an austenitization at 1200° C. during 30 minutes once the core has reached the temperature followed by air cooling and three tempering cycles. In an embodiment of the present aspect of the invention, properly prepared refers to an austenitization at 1250° C. during 30 minutes once the core has reached the temperature followed by oil quenching and three tempering cycles. In an embodiment of the tempering cycles are at temperatures between 480° C. and 650° C. In an embodiment of the tempering cycles are at temperatures between 480° C. and 580° C. In an embodiment of the tempering cycles are at temperatures between 500° C. and 550° C.

For example:

| C | Mn | Si | Ni | Cr | Mo | V | Zr | Al | Ti | Cu | B |
|---|---|---|---|---|---|---|---|---|---|---|---|
| 1.1 | 3.2 | 0.00 | 0.00 | 7.50 | 0.00 | 0.00 | 0.00 | 0.00 | 1.5 | 0.00 | 0.0006 |
| 2.55 | 0.00 | 0.00 | 0.00 | 4.00 | 0.00 | 0.40 | 0.00 | 0.00 | 7.00 | 0.00 | 0.0006 |
| 0.00 | 2.00 | 0.00 | 0.00 | 4.00 | 0.25 | 0.00 | 0.00 | 0.00 | 4.00 | 0.00 | 2.5 |
| 0.20 | 2.00 | 1.60 | 3.20 | 0.00 | 0.25 | 0.00 | 0.40 | 0.20 | 6.00 | 0.00 | 3.5 |

Any of the above-described embodiments can be combined with any other embodiment herein described in any combination, to the extent that the respective features are not incompatible.

The present invention is also interesting to implement “sweating components”. Those are tools (for example dies) or any other type of component that capitalizes on the heat of evaporation of water to execute a thermal regulation.

Interconnected porosity sweating die (or any other random or determined (sweating gland or alike). Also trough Investment Casting.

SnGa specially for Ti base alloys and Al base alloys. Infiltration with a SnGa or AlGa alloy and then liquid phase sintering.

The author has found, that most of the AM processes and even the not AM manufacturing processes can be advantageously combined for some applications. Especially processes that allow for a low cost construction, which can be combined with higher added value manufacturing processes for highly demanded zones. One such case is the usage of a more or less conventional process like a casting (sand, investment, nano- . . . ), HIP, fast substractive manufacturing process with low cost material, or a lower cost AM method, like one based on the stereo-lithography of particle charged resins or filling with particles of organic material moulds manufactured trough AM or fast near net shape conventional method. To bring the value added material, also conventional methods can be applied like welding based methods (TIG, MIG, plasma, . . . ) or others like cladding, thermal spray, cold spray or similar. Also AM methods can be used being very often the ones with localized material supply often the preferred ones, like the so called Direct Energy Deposition, etc. In some cases the more value added manufacturing process is employed to bring higher added value material or attain a particular microstructure in order to have a specific functionality in some particular areas of the manufactured component (often a tool). This can also sometimes be achieved with localized heat treatments, trough induction, laser, etc, superficial treatments (nitriding, carburizing, boridizing, sulfidizing, mixtures thereof, etc.) or thin coatings as described. For some applications the added value manufacturing step might also be incorporated to increase the manufacturing accuracy in certain critical areas so that tighter tolerances can be achieved. When this is the case it is interesting sometimes to have a 3D view or scanning system to be able to evaluate with a closed loop the amounts to be corrected. For some applications it is also interesting to have a system which is simultaneously additive and subtractive so that it can apport material and also machine it away with sufficient precision.

A method for producing a die or mold from sintered powder material and having at least one internal channel formed therein for conducting a heat transfer medium into, though, and out of the mold, comprising placing a first layer of sintering powder selected from the group consisting of iron, iron-carbon, copper, copper alloy, tungsten carbide and titanium carbide in a frame, forming a mother mold conforming in size and configuration to a desired mold cavity, forming a pattern of long and slender shape having a desired surface configuration corresponding to that of said internal channel for conducting a heat transfer medium and which complements the surface of the desired mold cavity, said pattern being made of metal infiltratable into the pores of said sintering powder and having a lower melting point than that of said sintering powder, at least partially embedding said mother mold in said layer of sintering powder, adding a second layer of said sintering powder to completely embed the mother mold and separated from the first layer by a demolding agent, completely embedding said pattern in complementary spaced relation in one of said layers of sintering powder so that both ends of said pattern contact with the inside of a wall of said frame, heating said sintering powder, mother mold and pattern to a sintering temperature to sinter said powder and to infiltrate said infiltratable metal of said pattern into said powder, and cooling so as to obtain a hardened, sintered mold separable into two parts along the boundary of said first and second layers and having an internal channel whose configuration complements that of said pattern and the mold cavity.

Also the inventor has found an alternative way to capitalize the heat of vaporization of a fluid like in the case of the sweating dies, in which a fluid is brought to the Surface trough small wisely placed orifices. (the fluid id often water or a water based fluid but could also be another fluid depending on the application). The way in question consists on the formation of distributed droplets on the Surface of a die or tool. One way to achieve such effect consists on keeping the die or tool below the dew point and pulverize it with an atomized fluid (for example a water solution) on the working surface before the cooling action of the manufactured component takes place. In some applications the heat input from the component is quite intense and keeping the die or tool below the dew point is not an easy task (it can be achieved with some aggressive cooling strategies like the usage of very close to the surface cooling channels like the capillary system described in this document, where an undercooled fluid is circulated, like Freon or even liquid nitrogen. In some applications it can also be achieved with a severe external cooling action, like spraying of pulverized water to capitalize also in this stage the heat of vaporization of water). The application of a fairly homogeneous layer of fluid droplets on at least part of the working surface can be made in several ways, one of them being the usage of fluid atomizing nozzles. Especially for dies or tools with complex geometries with vertical walls and generally faces with different orientations, sometimes care has to be taken on selecting the size of the fluid droplets to assure their remanence in the desired location.

In the case of hot stamping proceeding in this way as was the case with the sweating dies, extremely short component cooling times are achievable, which allow even to use different manufacturing techniques than the traditional single step press, being possible to move into multiple step transferized press or even progressive die press systems.

For some applications it is important that the cooling takes place in a set up that constrains the possible undesirable distortions associated to the thermal expansion coefficient of the component being manufactured, and thus the component is kept in some kind of die, tool or shape retainer while being cooled. Some applications have low dimensional accuracy constraints and thus it is not necessary to have shape retention during the cooling step and thus this can be done through direct pulverization on the component (with adequate nozzles or other fluid atomizing system) to promote the cooling of the manufactured component capitalizing the heat of vaporization of the atomized liquid.

Degradation and failure of structures, tools, die, moulds, pieces or machine part tools represent a huge cost. Material properties play a determinant role in durability of many components, such as tools, dies, moulds or pieces. In an embodiment the technical effects of the above disclosed embodiments include a reduction in cost and long durability of the components due to the properties of the steel used to manufacture the tool, die, piece or mould such as fracture toughness, environmental resistance, corrosion resistance, stress corrosion cracking resistance, mechanical strength, and/or wear resistance. In several embodiments, the invention also provides a reduction in the time spent on cooling which would drastically increase the production rate as well as reduce costs.

Any of the steels of the present invention can be manufactured with any metallurgical process, among which the most common are sand casting, lost wax casting, continuous casting, melting in electric furnace, vacuum induction melting. Powder metallurgy processes can also be used along with any type of atomization and subsequent compacting as the HIP, CIP, cold or hot pressing, sintering (with or without a liquid phase), thermal spray or heat coating, to name a few of them. The alloy can be directly obtained with the desired shape or can be improved by other metallurgical processes. Any refining metallurgical process can be applied, like ESR, AOD, VAR . . . . Forging or rolling are frequently used to increase toughness, even three-dimensional forging of blocks. Tool steel of the present invention can be obtained in the form of bar, wire or powder for use as solder alloy. Even, a low-cost alloy steel matrix can be manufactured and applying steel of the present invention in critical parts of the matrix by welding rod or wire made from steel of the present invention. Also laser, plasma or electron beam welding can be conducted using powder or wire made of steel of the present invention. The steel of the present invention could also be used with a thermal spraying technique to apply in parts of the surface of another material. Obviously the steel of the present invention can be used as part of a composite material, for example when embedded as a separate phase, or obtained as one of the phases in a multiphase material. Also when used as a matrix in which other phases or particles are embedded whatever the method of conducting the mixture (for instance, mechanical mixing, attrition, projection with two or more hoppers of different materials . . . ). The present invention is especially well suited to obtain steels for hot stamping tooling applications. The steels of the present invention perform especially well when used for plastic injection tooling. They are also well fitted as tooling for die casting applications. Another field of interest for the steels of the present document is the drawing and cutting of sheets or other abrasive components. Also for medical, alimentary and pharmaceutical tooling applications the steels of the present invention are of especial interest.

Any of the above-described embodiments can be combined with any other embodiment herein described in any combination, to the extent that the respective features are not incompatible.

Further embodiments are contained in the examples and in the claims.

### EXAMPLES

Several steels of the present invention were developed and are shown in tables in the following examples. Tables included in the examples shown all percentages in weight percent for each composition, the rest consisting of iron and trace elements.

### Example 1

### Hot Work Steel Having the Following Nominal Composition

TABLE 1

| | | | | | | | | | % (Sn + | % O | % | | |
|---|---|---|---|---|---|---|---|---|---|---|---|---|---|
| % C | % Si | % Mn | % Cr | % Mo | % Ni | % V | % P | % S | Sb + As) | ppm | Others | [HRc] | [MPa*✓m] |
| 0.38 | 0.2 | 0.55 | 5 | 1.8 | — | 0.6 | 0.02 | 0.005 | 0.04 | 20 | +N | 44 | 42 |
| 0.38 | 0.4 | 0.4 | 5.2 | 1.3 | — | 0.4 | 0.002 | | 0.2 | 8 | — | 43 | 38 |
| 0.38 | 0.05 | 2.8 | 4.8 | 1.2 | 0.4 | 0.5 | 0.004 | | 0.007 | 14 | +B | 43 | 85 |
| | | | | | | | | | | | 60 ppm | | |
| 0.37 | 0.1 | 3.2 | 5 | 2.9 | — | 0.6 | 0.0007 | | 0.007 | 3 | — | 42 | 62 |
| 0.37 | 0.05 | 3.4 | 0.05 | 3.2 | 0.35 | 0.6 | 0.0007 | | 0.002 | 12 | +B | 43 | 72 |
| | | | | | | | | | | | 60 ppm | | |

Pieces having 350×350×350 were tempered the fracture toughness reported is the mean value of the fracture toughness measured in the two transversal directions. Test pieces were extracted from the nucleus of the piece (maximum 20% of gravity center). Steels were forged, annealed and tempered (including temper) according to “best practice” methods (reported in literature) to obtain a fracture toughness at room temperature over 80 MPa*√m in AISI H10 steel, when tempering in oil for temper a test piece having 10 mm thickness.

Two first steels in table correspond with steels of state of the art and are included for comparative purposes.

### Example 2

### Steels Having the Following Nominal Composition were Developed

TABLE 2
Steels of the present invention.

| N° Ex | % C | % Mo | % Cu | % Al | % Ni | % Mn | % Cr | % W | % Co | % V | Others |
|---|---|---|---|---|---|---|---|---|---|---|---|
| 1.1 | 1.22 | | 4.00 | 1.10 | 6.00 | 25.00 | 4.00 | | 1.55 | 3.70 | |
| 1.2 | 1.44 | | 3.76 | 1.03 | 5.65 | 23.52 | 5.00 | | 1.46 | 3.48 | |
| 1.3 | 1.44 | | 3.76 | 1.04 | 5.64 | 23.52 | 5.00 | | 1.46 | 3.48 | |
| 1.4 | 1.38 | | 3.76 | 1.03 | 5.65 | 23.52 | 4.55 | | 1.46 | 3.48 | |
| 1.5 | 1.30 | | | | | 25.00 | 4.00 | | | 3.70 | |
| 1.6 | 0.76 | 3.80 | | 1.00 | | 25.00 | | 1.20 | | | |
| 1.7 | 1.30 | | | 1.00 | | 25.00 | 4.00 | | | 3.70 | |
| 1.8 | 0.71 | 3.53 | | 0.93 | 5.50 | 23.25 | | 1.12 | 1.50 | | |
| 1.9 | 1.21 | | | 0.93 | 5.50 | 23.25 | 3.72 | | 1.50 | 3.44 | |
| 1.10 | 0.45 | 2.50 | | | | 12.00 | 5.00 | | | 1.50 | Si = 0.5 |
| 1.11 | 1.30 | | | | | 22.00 | 4.00 | | | 3.70 | |
| 1.12 | 1.30 | 3.80 | | 1.00 | 6.00 | 16.00 | | 1.20 | 2.00 | | |
| 1.13 | 0.50 | 3.00 | | | | 19.00 | 4.00 | 1.00 | | | |
| 1.14 | 0.50 | 3.00 | | | | 32.00 | 4.00 | 1.00 | | | |
| 1.15 | 1.50 | | | | | 25.00 | 4.00 | | | 3.00 | Ti = 2 |
| 1.16 | 2.00 | 4.00 | | | | 25.00 | | 2.00 | | | |
| 1.17 | 1.50 | 4.00 | | | 9.00 | 16.00 | | 3.00 | 5.00 | | |
| 1.18 | 1.50 | | 4.00 | | | 25.00 | 4.00 | | | 3.00 | Ti = 2 |
| 1.19 | 1.40 | | | 15.00 | | 28.00 | 12.00 | | | | Si = 2 |
| 1.20 | 1.40 | | | 15.00 | | 25.00 | 5.00 | | | | Si = 4 |
| 1.21 | 0.15 | | | | | 25.00 | | | | | |
| 1.22 | | | | | 6.00 | 15.00 | | | 2.00 | | |
| 1.23 | | | | | 6.00 | 15.00 | | | 2.00 | | Ti = 2 |
| 1.24 | 0.15 | | | 1.00 | | 25.00 | | | | | |
| 1.25 | 0.14 | | | 0.93 | 5.50 | 23.25 | | | 1.50 | | |
| 1.26 | 0.76 | 3.80 | | | | 25.00 | | 12.00 | | | |

TABLE 3
Steels of the present invention.

| N° | | | | | | | | | | |
|---|---|---|---|---|---|---|---|---|---|---|
| Ex | % C | % Si | % Mn | % Cr | % Ni | % Mo | % V | % Co | % Al | Others |
| 2.1 | 0.33 | 0.3 | 0.4 | 8.3 | 6 | 1.4 | 0.6 | 1.6 | 2.5 | |
| 2.2 | 0.4 | 1 | 0.6 | 7.8 | 6.2 | 1.3 | 0.75 | 1.7 | 3 | |
| 2.3 | 0.4 | 0.3 | 0.4 | 7.9 | 6.2 | 1.3 | 0.74 | 1.7 | 1.28 | |
| 2.4 | 0.4 | 1.2 | 0.6 | 7.9 | 6.2 | 1.3 | 0.74 | 1.7 | 1.28 | |
| 2.5 | 0.4 | | | 7.9 | 6.2 | 1.3 | 0.74 | 1.7 | 1.28 | |
| 2.6 | 0.33 | 0.3 | 0.4 | 8.3 | 6 | 1.4 | 0.6 | 1.6 | 2.5 | |
| 2.7 | 0.33 | 0.3 | 0.4 | 9.3 | 6 | 1.4 | 0.6 | 1.6 | 3.5 | |
| 2.8 | 0.4 | 1 | 0.6 | 7.8 | 6.2 | 1.3 | 0.75 | 1.7 | 3 | |
| 2.9 | 0.33 | | | 8.3 | 6 | 1.4 | 0.6 | 1.6 | 2.5 | |
| 2.10 | 0.33 | | | 9.3 | 6 | 1.4 | 0.6 | 1.6 | 3.5 | |
| 2.11 | 0.4 | | | 7.8 | 6.2 | 1.3 | 0.75 | 1.7 | 3 | |
| 2.12 | 0.33 | | | 8 | 6.2 | 1.3 | 0.65 | 1.6 | 0.9 | |
| 2.13 | 0.4 | | | 7 | 6.2 | 1.3 | 0.65 | 1.6 | 1.6 | |
| 2.14 | 0.45 | | | 8.5 | 6.8 | 1.6 | 0.85 | 1.6 | 2 | |
| 2.15 | 0.38 | 0.12 | 0.13 | 8.4 | 6.5 | 1.2 | 0.75 | 1.8 | 0.9 | Zr = 0.07 |

TABLE 4
comparative examples of steels of the present invention
with conventional stainless steel AISI 316 (ex. 3.3)

| N° | | | | | | | | | | % |
|---|---|---|---|---|---|---|---|---|---|---|
| Ex | % C | % Ti | % Zr | % Cu | % Al | % P | % Ni | % Si | % Mn | Cr |
| 3.1 | 0.00 | 2.00 | 0.0 | 3.0 | 8.0 | 0.5 | 5.0 | 0.0 | 0.0 | 0.0 |
| 3.2 | 0.00 | 3.0 | 0.0 | 2.0 | 3.0 | 0.8 | 5.0 | 0.0 | 0.0 | 3.0 |
| 3.3 | 0.02 | 0.0 | 0.0 | 0.0 | 0.0 | 0.0 | 12.0 | 0.5 | 1.0 | 17.0 |
| 3.4 | 0.5 | 3.0 | 3.0 | 0.0 | 3.0 | 0.0 | 0.0 | 0.0 | 0.0 | 3.0 |
| 3.5 | 1.40 | 0.0 | 0.0 | 0.0 | 15.0 | 0.0 | 0.0 | 2.0 | 28.0 | 12.0 |

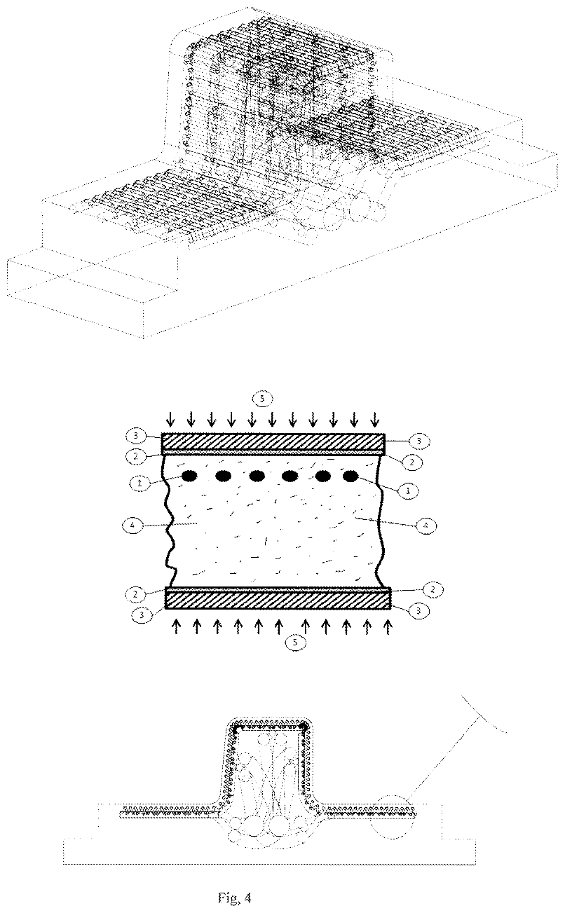

In FIG. 3 Taffel Plot for the compositions of Table 3 is shown.

TABLE 5
Corrosion rates for Taffel Plot of Figure 1 of compositions of Table

| N^{o} Ex | Color | Icor | Corrosion rate |
|---|---|---|---|
| 3.1 | Blue | 8.16E-05 | 0.947 |
| 3.2 | Black | 1.20E-04 | 1.420 |
| 3.3 | Orange | 1.51E-04 | 1.758 |
| 3.4 | Dark Green | 1.30E-04 | 1.514 |
| 3.5 | Ligth Green | 8.11E-05 | 0.942 |

### Example 3

### Steel Having the Following Nominal Composition were Developed

TABLE 6
Steels of the present invention.

| C | Mn | P | S | Si | Ni | Cr | Mo | V | Hf | W |
|---|---|---|---|---|---|---|---|---|---|---|
| 0.34- | <0.02 | <0.005 | <0.001 | <0.05 | 6.2- | 7.60- | 1.40- | 0.6- | <0.01 | <0.01 |
| 0.36 | | | | | 6.6 | 8.00 | 1.60 | 0.8 | | |
| 0.33 | 0.025 | 0.004 | 0.006 | 0.025 | 6.20 | 7.620 | 1.59 | 0.77 | <0.004 | <0.004 |
| | C | Ti | Cu | Nb | B | Mg | Al | N | Co | O |
| | 0.34- | <0.01 | <0.01 | <0.01 | <0.01 | — | 1.0- | <0.005 | 1.4- | <0.01 |
| | 0.36 | | | | | | 1.2 | | 1.7 | |
| | 0.33 | <0.004 | 0.010 | <0.004 | <0.004 | — | 1.18 | 0.004 | 1.68 | 0.005 |

### Example 4

### Steel of the Invention Having the Following Nominal Composition were Developed

TABLE 7
Steels of the present invention.

| C | Mn | P | S | Si | Ni | Cr | Mo | V | Hf | W |
|---|---|---|---|---|---|---|---|---|---|---|
| 1.30- | 15.5- | <0.005 | <0.001 | <0.01 | 5.5- | 7.50- | — | — | <0.01 | <0.01 |
| 1.50 | 16.5 | | | | 6.5 | 8.50 | | | | |
| 1.49 | 15.80 | 0.013 | 0.014 | 0.049 | 6.42 | 8.110 | 0.007 | <0.004 | <0.004 | <0.004 |
| 1.30- | 11.5- | <0.005 | <0.001 | <0.01 | 7.5- | 7.50- | — | — | <0.01 | <0.01 |
| 1.50 | 12.5 | | | | 8.5 | 8.50 | | | | |
| 1.56 | 11.50 | 0.019 | 0.021 | 0.068 | 7.90 | 7.660 | <0.004 | <0.004 | <0.004 | <0.004 |
| | C | Ti | Cu | Nb | B | Mg | Al | N | Co | O |
| | 1.30- | <0.01 | <0.01 | <0.01 | — | — | 8.0- | <0.005 | <0.01 | <0.01 |
| | 1.50 | | | | | | 9.0 | | | |
| | 1.49 | <0.004 | 0.007 | <0.004 | 0.028 | <0.004 | 8.59 | <0.001 | 0.005 | 0.005 |
| | 1.30- | <0.01 | <0.01 | <0.01 | — | — | 8.0- | <0.005 | <0.01 | <0.01 |
| | 1.50 | | | | | | 9.0 | | | |
| | 1.56 | <0.004 | 0.006 | <0.004 | 0.025 | <0.004 | 8.18 | <0.001 | 0.005 | 0.003 |

### Example 5

### Several Steel of the Invention Having the Following Composition were Developed

TABLE 8
comparative examples of steels of the present invention with conventional
stainless steels H13, H11, H20, H19, H10 and steel 1.2367.

| | | | | | | | | | | % (Sn + | % (Se + | % N | % O | | Tough- |
|---|---|---|---|---|---|---|---|---|---|---|---|---|---|---|---|
| N° Ex | % C | % Si | % Mn | % Cr | % Mo | % W | % Ni | % V | % B | As + Sb) | Te) | [ppm] | [ppm] | Others | ness |
| 3353LAB-1 | 0.38 | 0 | 3.2 | 4.5 | 0.4 | 4 | 0 | 2 | 0 | 0.04 | 0.08 | 40 | 8 | Co = 4.25; | High |
| | | | | | | | | | | | | | | Al = 0.2; | |
| | | | | | | | | | | | | | | Ce = 0.01 | |
| 3353LAB-2 | 0.38 | 1 | 1.2 | 5.2 | 1.25 | 0 | 0 | 0.4 | 0.025 | 0.003 | 0.004 | 8 | 11 | Ce = 0.2; | Medium |
| | | | | | | | | | | | | | | La = 0.2; | |
| | | | | | | | | | | | | | | Bi = 0.07 | |
| 3353LAB-3 | 0.4 | 1 | 2.8 | 5.2 | 1.3 | 0 | 0 | 1 | 0 | 0.003 | 0.004 | 8 | 11 | | High |
| 3353LAB-4 | 0.4 | 1 | 3.4 | 5.2 | 1.3 | 0 | 0 | 1 | 0 | 0.003 | 0.004 | 8 | 11 | | High |
| 3353LAB-5 | 0.3 | 0 | 2.8 | 3 | 2.8 | 0 | 0 | 0.5 | 0 | 0.003 | 0.004 | 18 | 11 | | High |
| 3353LAB-6 | 0.38 | 0 | 2.6 | 5 | 3 | 0 | 0 | 0.55 | 0 | 0.003 | 0.004 | 14 | 8 | | Medium |
| 3353LAB-7 | 0.5 | 0.2 | 1.5 | 4.5 | 3 | 0 | 0 | 0.55 | 0 | 0.003 | 0.004 | 14 | 5 | | Medium |
| 3353LAB-8 | 0.3 | 0 | 3.8 | 3.25 | 0 | 9.5 | 0 | 0.5 | 0 | 0.02 | 0.004 | 14 | 5 | Zr = 0.4 | High |
| 3356LAB-1 | 0.38 | 1 | 3.2 | 5 | 1.25 | 0 | 0 | 0.4 | 0 | 0.02 | 0.004 | 3 | 4 | | High |
| 3356LAB-2 | 0.38 | 0 | 3.2 | 5 | 1.25 | 0 | 0 | 0.4 | 0 | — | 0.004 | 8 | 4 | | High |
| 3356LAB-3 | 0.38 | 0 | 3.2 | 5 | 1.25 | 0 | 0 | 0.4 | 0.006 | — | — | — | 2 | | High |
| 3356LAB-4 | 0.38 | 0 | 3.2 | 5 | 1.25 | 0 | 0.35 | 0.4 | 0.006 | | 0.004 | 18 | 8 | | High |
| 3356LAB-5 | 0.38 | 0 | 4.5 | 5 | 1.25 | 0 | 0 | 0.4 | 0.006 | 0.09 | 0.001 | 8 | 11 | | High |
| 3356LAB-6 | 0.38 | 0 | 6 | 5 | 1.25 | 0 | 0 | 0.4 | 0 | — | — | — | 8 | | High |
| H13 | 0.4 | 1 | 0.4 | 5.3 | 1.4 | | | 1 | | 0.04 | 0.003 | 60 | 22 | | Low |
| H11 | 0.38 | 1 | 0.4 | 5.3 | 1.3 | | | 0.4 | | 0.02 | 0.003 | 20 | 10 | | LOW |
| H20 | 0.3 | 0.4 | 0.3 | 2 | | 9.5 | | 0.5 | | 0.1 | 0.02 | 75 | 25 | | LOW |
| H19 | 0.38 | 0.3 | 0.3 | 4.5 | 0.4 | 4 | 0.3 | 2 | | 0.21 | 0.08 | 180 | 45 | Co = 4.25 | LOW |
| H10 | 0.4 | 1 | 0.55 | 3.25 | 2.5 | | | 0.4 | | 0.08 | 0.12 | 120 | 45 | | LOW |
| 1.2367 | 0.38 | 0.4 | 0.4 | 5 | 3 | | | 0.5 | | 0.12 | 0.08 | 80 | 25 | | LOW |

### Example 6

### Several Steel of the Invention Having the Following Composition were Developed and Shown in Table 9

TABLE 9
Steels of the present invention.

| | | % C | | | | | | | | | % (Sn + | % | | | | |
|---|---|---|---|---|---|---|---|---|---|---|---|---|---|---|---|---|
| | % | meas- | | % | % | % | % | % | % | % | As + | (Se + | % | % | | Tough- |
| N° Ex | C | ured | % Si | Mn | Cr | Mo | W | Ni | V | B | An) | Te) | N | O | Others | ness |
| 3322LAB-4 | 0.37 | 0.372 | | 1.4 | 0.03 | 3.2 | | | | | 0.003 | 0.004 | 18 | 11 | | Medium |
| 3247LAB-1 | 0.4 | 0.34 | | 1.4 | 0.007 | 3.8 | | | 0.5 | 0.006 | 0.003 | 0.004 | 14 | 8 | | Medium |
| 3247LAB-2 | 0.4 | 0.366 | | 3.2 | 0.02 | 3.8 | | | 0.5 | 0.006 | 0.003 | 0.004 | 14 | 5 | | High |
| 3247LAB-3 | 0.4 | 0.365 | | 1.4 | 0.02 | 3.2 | | 0.4 | 0.5 | 0.006 | — | 0.003 | 14 | 5 | | Medium |
| 3247LAB-4 | 0.4 | 0.358 | | 3.2 | 0.02 | 3.2 | | 0.4 | 0.5 | 0.006 | 0.02 | 0.02 | 3 | 4 | | High |
| 3247LAB-5 | 0.4 | 0.355 | | 1.4 | 0.02 | 2.8 | | 0.4 | 0.5 | 0.006 | 0.003 | 0.08 | 8 | 4 | | Medium |
| 3247LAB-6 | 0.45 | 0.423 | | 1.4 | 0.02 | 3.8 | | 0.4 | 0.5 | — | 0.09 | — | — | 2 | | Medium |
| 3247LAB-7 | 0.45 | 0.406 | | 1.4 | 0.02 | 2.8 | 2 | | 0.5 | 0.006 | — | 0.004 | 18 | 8 | | Medium |
| 3247LAB-8 | 0.5 | 0.412 | | 1.4 | 0.02 | 3.8 | | 0.4 | | 0.006 | 0.09 | 0.001 | 8 | 11 | | Medium |
| 3247LAB-9 | 0.45 | 0.388 | | 1.4 | 0.02 | 3.2 | | | 0.5 | 0.006 | 0.04 | — | — | 8 | | Medium |
| 3247LAB-10 | 0.45 | 0.403 | | 1.4 | | 3.2 | | 0.4 | 0.5 | 0.006 | 0.04 | 0.003 | 14 | 22 | | Medium |
| 3217LAB-3 | 0.36 | 0.337 | | 1.4 | | 3.8 | | 0.4 | 0.5 | — | 0.02 | — | 14 | 11 | | Medium |
| 3217LAB-4 | 0.38 | 0.355 | | 1.4 | 1.8 | 3.8 | | 0.4 | 0.8 | 0.006 | 0.02 | 0.004 | 14 | 8 | | High |
| 3217LAB-5 | 0.4 | 0.349 | 0.25 | 1.4 | | 3.8 | | 0.4 | 0.5 | 0.006 | 0.04 | 0.004 | 3 | 8 | | Medium |
| 3217LAB-6 | 0.42 | 0.401 | 0.12 | 1.4 | | 3.2 | 1.2 | 0.4 | 1.2 | 0.012 | 0.08 | 0.12 | 3 | 8 | | Medium |
| 3217LAB-7 | 0.36 | 0.323 | 0.08 | 3.2 | | 3.8 | | 0.4 | 0.5 | 0.006 | 0.12 | 0.08 | 80 | 4 | | High |
| 3217LAB-8 | 0.38 | 0.337 | | 3.2 | 1.2 | 3.8 | | 0.4 | 0.5 | 0.006 | 0.002 | 0.004 | 8 | 4 | | High |
| 3217LAB-9 | 0.4 | 0.367 | | 3.2 | | 3.8 | | 0.4 | 0.5 | 0.02 | 0.3 | 0.004 | 8 | 3 | | High |
| 3059LAB-2 | 0.4 | | | 1.6 | | 3.8 | | 0.35 | 0.5 | 0.006 | 0.003 | 0.004 | 8 | 3 | | Medium |
| 3059LAB-4 | 0.4 | | | 1.6 | | 3.8 | | 0.35 | 0.5 | 0.0025 | 0.003 | 0.004 | — | 4 | Mg = 0.006 | Medium |
| 3059LAB-5 | 0.4 | | | 1.6 | | 3.8 | | 0.35 | 0.5 | 0.006 | 0.003 | 0.003 | 8 | 4 | Zr = 0.007 | Medium |
| 3059LAB-6 | 0.4 | | | 1.6 | 2.1 | 3.8 | | 0.35 | 0.5 | 0.004 | 0.003 | 0.02 | 8 | 3 | Zr = 0.007; | High |
| | | | | | | | | | | | | | | | Mg = 0.006 | |

### Example 7

### Steels Having the Following Nominal Composition were Developed

TABLE 10
Steels of the present invention.

| N° Ex | C | Ti | Zr | Mo | Cu | Al | P | Ni | Si | Mn | S | Cr | W | Nb | Co | V | Mg | Ta | Pd | Others |
|---|---|---|---|---|---|---|---|---|---|---|---|---|---|---|---|---|---|---|---|---|
| AISI 420 | 0.15 | 0.00 | 0.00 | 0.00 | 0.00 | 0.00 | 0.04 | 0.00 | 1.00 | 1.00 | 0.03 | 13.00 | 0.00 | 0.00 | 0.00 | 0.00 | | | | |
| HCR-10 | 0.00 | 0.00 | 5.20 | 0.00 | 0.00 | 0.00 | 1.50 | 8.00 | 0.00 | 0.00 | 0.00 | 0.00 | 0.00 | 0.00 | 0.00 | 0.00 | | | | |
| HCR-11 | 0.00 | 4.00 | 0.00 | 0.00 | 0.00 | 0.00 | 1.50 | 0.00 | 0.00 | 0.00 | 0.00 | 0.00 | 0.00 | 0.00 | 0.00 | 0.00 | | | | |
| HCR-12 | 0.40 | 2.00 | 3.80 | 0.00 | 2.00 | 2.00 | 0.00 | 5.00 | 0.00 | 0.00 | 0.00 | 0.00 | 0.00 | 0.00 | 0.00 | 0.00 | | | | |
| HCR-13 | 0.40 | 2.00 | 3.80 | 0.00 | 2.00 | 2.00 | 0.70 | 5.00 | 0.00 | 0.00 | 0.00 | 0.00 | 0.00 | 0.00 | 0.00 | 0.00 | | | | |
| HCR-14 | 0.40 | 2.00 | 3.80 | 0.00 | 2.00 | 2.00 | 3.00 | 5.00 | 0.00 | 0.00 | 0.00 | 0.00 | 0.00 | 0.00 | 0.00 | 0.00 | | | | |
| HCR-15 | 0.00 | 4.00 | 0.20 | 0.00 | 0.00 | 0.00 | 1.00 | 6.00 | 0.00 | 0.00 | 0.00 | 0.00 | 0.00 | 0.00 | 0.00 | 0.00 | | | | |
| HCR-6 | 0.50 | 2.00 | 5.20 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-7 | 0.50 | 2.00 | 6.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-8 | 0.00 | 2.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-9 | 0.00 | 4.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-1 | 0.50 | 2.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-2 | 0.15 | 0.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-3 | 0.08 | 0.00 | 2.80 | 0.00 | 3.00 | 2.00 | 1.50 | 2.00 | 0.00 | 0.00 | 0.00 | 0.00 | 0.00 | 0.00 | 0.00 | 0.00 | | | | |
| HCR-4 | 0.30 | 0.00 | 3.80 | 0.00 | 2.00 | 0.00 | 1.50 | 0.00 | 0.00 | 0.00 | 0.00 | 0.00 | 0.00 | 0.00 | 0.00 | 0.00 | | | | |
| HCR-5 | 0.50 | 2.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-16 | 0.50 | 0.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-17 | 0.50 | 2.00 | 0.00 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-18 | 0.50 | 2.00 | 3.80 | 0.00 | 0.00 | 2.00 | 1.50 | 5.00 | 0.00 | 0.00 | 0.00 | 0.00 | 0.00 | 0.00 | 0.00 | 0.00 | | | | |
| HCR-19 | 0.50 | 2.00 | 3.80 | 0.00 | 2.00 | 0.00 | 1.50 | 5.00 | 0.00 | 0.00 | 0.00 | 0.00 | 0.00 | 0.00 | 0.00 | 0.00 | | | | |
| HCR-20 | 0.50 | 2.00 | 3.80 | 0.00 | 2.00 | 2.00 | 0.00 | 5.00 | 0.00 | 0.00 | 0.00 | 0.00 | 0.00 | 0.00 | 0.00 | 0.00 | | | | |
| HCR-21 | 0.50 | 2.00 | 3.80 | 0.00 | 2.00 | 2.00 | 1.50 | 0.00 | 0.00 | 0.00 | 0.00 | 0.00 | 0.00 | 0.00 | 0.00 | 0.00 | | | | |
| HCR-22 | 0.50 | 4.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-23 | 0.50 | 2.00 | 7.60 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-24 | 0.50 | 2.00 | 3.80 | 0.00 | 4.00 | 2.00 | 1.50 | 5.00 | 0.00 | 0.00 | 0.00 | 0.00 | 0.00 | 0.00 | 0.00 | 0.00 | | | | |
| HCR-25 | 0.50 | 2.00 | 3.80 | 0.00 | 2.00 | 4.00 | 1.50 | 5.00 | 0.00 | 0.00 | 0.00 | 0.00 | 0.00 | 0.00 | 0.00 | 0.00 | | | | |
| HCR-26 | 0.50 | 2.00 | 3.80 | 0.00 | 2.00 | 2.00 | 3.00 | 5.00 | 0.00 | 0.00 | 0.00 | 0.00 | 0.00 | 0.00 | 0.00 | 0.00 | | | | |
| HCR-27 | 0.50 | 2.00 | 3.80 | 0.00 | 2.00 | 2.00 | 1.50 | 10.00 | 0.00 | 0.00 | 0.00 | 0.00 | 0.00 | 0.00 | 0.00 | 0.00 | | | | |
| HCR-28 | 0.50 | 1.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-29 | 0.50 | 2.00 | 1.90 | 0.00 | 2.00 | 2.00 | 1.50 | 5.00 | 0.00 | 0.00 | 0.00 | 0.00 | 0.00 | 0.00 | 0.00 | 0.00 | | | | |
| HCR-30 | 0.50 | 2.00 | 3.80 | 0.00 | 1.00 | 2.00 | 1.50 | 5.00 | 0.00 | 0.00 | 0.00 | 0.00 | 0.00 | 0.00 | 0.00 | 0.00 | | | | |
| HCR-31 | 0.50 | 2.00 | 3.80 | 0.00 | 2.00 | 1.00 | 1.50 | 5.00 | 0.00 | 0.00 | 0.00 | 0.00 | 0.00 | 0.00 | 0.00 | 0.00 | | | | |
| HCR-32 | 0.50 | 2.00 | 3.80 | 0.00 | 2.00 | 2.00 | 0.75 | 5.00 | 0.00 | 0.00 | 0.00 | 0.00 | 0.00 | 0.00 | 0.00 | 0.00 | | | | |
| HCR-33 | 0.50 | 2.00 | 3.80 | 0.00 | 2.00 | 2.00 | 1.50 | 2.50 | 0.00 | 0.00 | 0.00 | 0.00 | 0.00 | 0.00 | 0.00 | 0.00 | | | | |
| HCR-34 | 0.00 | 0.00 | 0.00 | 0.00 | 3.00 | 8.00 | 0.50 | 5.00 | 0.00 | 0.00 | 0.00 | 0.00 | 0.00 | 0.00 | 0.00 | 0.00 | | | | |
| HCR-35 | 0.00 | 3.00 | 0.00 | 0.00 | 0.00 | 3.00 | 0.50 | 5.00 | 0.00 | 0.00 | 0.00 | 0.00 | 0.00 | 0.00 | 0.00 | 0.00 | | | | |
| HCR-36 | 0.00 | 2.50 | 0.00 | 0.00 | 2.00 | 2.00 | 0.50 | 5.00 | 0.00 | 0.00 | 0.00 | 0.00 | 1.00 | 0.00 | 0.00 | 0.00 | | | | |
| HCR-37 | 0.00 | 3.00 | 0.00 | 0.00 | 2.00 | 3.00 | 0.50 | 5.00 | 0.00 | 0.00 | 0.00 | 5.00 | 0.00 | 0.00 | 0.00 | 0.00 | | | | |
| HCR-38 | 0.00 | 0.00 | 0.00 | 0.00 | 3.00 | 8.00 | 0.00 | 5.00 | 0.00 | 0.00 | 0.00 | 0.00 | 0.00 | 0.00 | 0.00 | 0.00 | | | | |
| HCR-39 | 0.00 | 0.00 | 0.00 | 0.00 | 0.00 | 8.00 | 0.50 | 5.00 | 0.00 | 0.00 | 0.00 | 0.00 | 0.00 | 0.00 | 0.00 | 0.00 | | | | |
| HCR-40 | 0.00 | 2.00 | 0.00 | 0.00 | 3.00 | 8.00 | 0.50 | 5.00 | 0.00 | 0.00 | 0.00 | 0.00 | 0.00 | 0.00 | 0.00 | 0.00 | | | | |
| HCR-41 | 0.00 | 0.00 | 0.00 | 0.00 | 3.00 | 8.00 | 0.50 | 5.00 | 0.00 | 0.00 | 0.00 | 5.00 | 0.00 | 0.00 | 0.00 | 0.00 | | | | |
| HCR-42 | 0.00 | 3.00 | 0.00 | 0.00 | 0.00 | 4.00 | 0.50 | 5.00 | 0.00 | 0.00 | 0.00 | 0.00 | 0.00 | 0.00 | 0.00 | 0.00 | | | | |
| HCR-43 | 0.00 | 2.50 | 0.00 | 0.00 | 2.00 | 2.00 | 0.50 | 5.00 | 0.00 | 0.00 | 0.00 | 0.00 | 2.00 | 0.00 | 0.00 | 0.00 | | | | |
| HCR-44 | 0.00 | 3.00 | 0.00 | 0.00 | 2.00 | 3.00 | 0.00 | 5.00 | 0.00 | 0.00 | 0.00 | 5.00 | 0.00 | 0.00 | 0.00 | 0.00 | | | | |
| HCR-45 | 0.00 | 3.00 | 0.00 | 0.00 | 2.00 | 3.00 | 0.80 | 5.00 | 0.00 | 0.00 | 0.00 | 3.00 | 0.00 | 0.00 | 0.00 | 0.00 | | | | |
| HCR-46 | 0.00 | 0.00 | 0.00 | 0.00 | 0.00 | 3.00 | 0.50 | 0.00 | 2.00 | 25.00 | 0.00 | 0.00 | 0.00 | 0.00 | 0.00 | 0.00 | | | | |
| HCR-47 | 0.00 | 2.00 | 0.00 | 0.00 | 0.00 | 4.00 | 0.80 | 0.00 | 0.00 | 25.00 | 0.00 | 0.00 | 0.00 | 0.00 | 0.00 | 0.00 | | | | |
| HCR-48 | 0.00 | 2.00 | 0.00 | 0.00 | 2.00 | 3.00 | 0.60 | 0.00 | 2.00 | 25.00 | 0.00 | 2.00 | 0.00 | 0.00 | 0.00 | 0.00 | | | | |
| HCR-49 | 0.00 | 3.00 | 0.00 | 0.00 | 0.00 | 3.00 | 0.50 | 0.00 | 0.00 | 0.00 | 0.00 | 5.00 | 0.00 | 0.00 | 0.00 | 0.00 | | | | |
| HCR-50 | 0.06 | 0.00 | 0.00 | 0.00 | 0.00 | 0.00 | | 9.00 | 0.5 | 1.00 | | 19.00 | 0.00 | 0.00 | 0.00 | 0.00 | | | | |
| HCR-51 | 0.02 | 0.00 | 0.00 | 0.00 | 0.00 | 0.00 | | 12.00 | 0.5 | 1.00 | | 17.00 | 0.00 | 0.00 | 0.00 | 0.00 | | | | |
| HCR-52 | 0.01 | 0.00 | 0.00 | 4.50 | 0.00 | 0.00 | | 25.00 | 0.35 | 1.00 | | 20.00 | 0.00 | 0.00 | 0.00 | 0.00 | | | | |
| HCR-53 | 0.05 | 0.20 | 0.00 | 9.00 | 0.00 | 0.20 | | 60.00 | 0.25 | 0.25 | | 22.50 | 0.00 | 3.80 | 0.50 | 0.00 | | | | |
| HCR-54 | 0.50 | 4.00 | 4.00 | 0.00 | 0.00 | 3.00 | 0.00 | 0.00 | 0.00 | 0.00 | 0.00 | 0.00 | 0.00 | 0.00 | 0.00 | 0.00 | | | | |
| HCR-55 | 0.50 | 2.00 | 4.00 | 0.00 | 0.00 | 3.00 | 0.00 | 0.00 | 0.00 | 0.00 | 0.00 | 1.50 | 0.00 | 0.00 | 0.00 | 0.00 | | | | |
| HCR-56 | 0.50 | 0.00 | 3.80 | 0.00 | 0.00 | 3.00 | 0.00 | 0.00 | 0.00 | 0.00 | 0.00 | 3.00 | 0.00 | 3.00 | 0.00 | 0.00 | | | | |
| HCR-57 | 0.50 | 4.00 | 4.00 | 0.00 | 0.00 | 3.00 | 0.00 | 0.00 | 0.00 | 0.00 | 0.00 | 3.00 | 0.00 | 0.00 | 0.00 | 0.00 | | | | |
| HCR-58 | 0.50 | 3.00 | 3.00 | 0.00 | 0.00 | 3.00 | 0.00 | 0.00 | 0.00 | 0.00 | 0.00 | 3.00 | 0.00 | 0.00 | 0.00 | 0.00 | | | | |
| HCR-59 | 0.50 | 3.00 | 4.00 | 0.00 | 0.00 | 4.00 | 0.00 | 0.00 | 0.00 | 0.00 | 0.00 | 5.00 | 0.00 | 0.00 | 0.00 | 0.00 | | | | |
| HCR-60 | 1.40 | 0.00 | 0.00 | 0.00 | 0.00 | 8.50 | 0.00 | 0.00 | 0.00 | 25.00 | 0.00 | 5.00 | 0.00 | 0.00 | 0.00 | 0.00 | | | | |
| HCR-61 | 1.40 | 0.00 | 0.00 | 0.00 | 0.00 | 8.50 | 0.00 | 5.00 | 0.00 | 25.00 | 0.00 | 5.00 | 0.00 | 0.00 | 0.00 | 4.00 | | | | |
| HCR-62 | 1.40 | 0.00 | 0.00 | 0.00 | 0.00 | 3.00 | 0.00 | 5.00 | 2.00 | 25.00 | 0.00 | 5.00 | 0.00 | 0.00 | 0.00 | 4.00 | | | | |
| HCR-63 | 1.400 | 0.00 | 0.00 | 0.00 | 0.00 | 15.000 | 0.00 | 0.00 | 2.000 | 28.00 | 0.00 | 12.000 | 0.00 | 0.00 | 0.00 | 0.00 | | | | |
| HCR-64 | 1.08 | 0.00 | 0.00 | 0.00 | 0.00 | 15.300 | 0.00 | 0.00 | 0.00 | 28.300 | 0.00 | 0.00 | 0.00 | 0.00 | 0.00 | 0.00 | | | | |
| HCR-65 | 1.400 | 0.00 | 0.00 | 0.00 | 0.00 | 15.000 | 0.00 | 0.00 | 4.000 | 25.00 | 0.00 | 5.000 | 0.00 | 0.00 | 0.00 | 0.00 | | | | |
| HCR-66 | 1.40 | 0.00 | 0.00 | 0.00 | 0.00 | 14.000 | 0.00 | 0.00 | 0.00 | 25.000 | 0.00 | 0.00 | 0.00 | 0.00 | 0.00 | 4.000 | | | | |
| HCR-63 | 1.400 | 0.00 | 0.00 | 0.00 | 0.00 | 15.000 | 0.00 | 0.00 | 2.000 | 28.00 | 0.00 | 12.000 | 0.00 | 0.00 | 0.00 | 0.00 | | | | |
| bis | | | | | | | | | | | | | | | | | | | | |
| HCR-65 | 1.400 | 0.00 | 0.00 | 0.00 | 0.00 | 15.000 | 0.00 | 0.00 | 4.000 | 25.00 | 0.00 | 5.000 | 0.00 | 0.00 | 0.00 | 0.00 | | | | |
| bis | | | | | | | | | | | | | | | | | | | | |
| HCR-67 | 0.500 | 2.000 | 4.800 | 0.00 | 0.00 | 0.00 | 0.00 | 0.00 | 0.00 | 0.00 | 0.00 | 0.00 | 0.00 | 3.000 | 0.00 | 0.00 | | | | |
| HCR-68 | 0.300 | 4.000 | 4.000 | 0.00 | 0.00 | 0.00 | 0.00 | 0.00 | 0.00 | 0.00 | 0.00 | 0.00 | 0.00 | 0.00 | 0.00 | 0.00 | | | | |
| HCR-69 | 0.300 | 0.00 | 4.000 | 0.00 | 0.00 | 0.00 | 0.00 | 0.00 | 0.00 | 0.00 | 0.00 | 0.00 | 0.00 | 3.000 | 0.00 | 0.00 | | | | |
| HCR-70 | 0.400 | 3.000 | 4.000 | 0.00 | 0.00 | 0.00 | 0.00 | 0.00 | 0.00 | 0.00 | 0.00 | 0.00 | 0.00 | 3.000 | 0.00 | 0.00 | | | | |
| HCR- | 0.300 | 4.000 | 4.000 | 0.00 | 0.00 | 0.00 | 0.00 | 0.00 | 0.00 | 0.00 | 0.00 | 0.00 | 0.00 | 0.00 | 0.00 | 0.00 | | | | |
| 68bis | | | | | | | | | | | | | | | | | | | | |
| HCR- | 0.300 | 0.00 | 4.000 | 0.00 | 0.00 | 0.00 | 0.00 | 0.00 | 0.00 | 0.00 | 0.00 | 0.00 | 0.00 | 3.000 | 0.00 | 0.00 | | | | |
| 69bis | | | | | | | | | | | | | | | | | | | | |
| HCR-71 | 0.300 | 4.000 | 4.000 | 0.00 | 0.00 | 0.00 | 0.50 | 0.00 | 0.00 | 0.00 | 0.00 | 0.00 | 0.00 | 0.00 | 0.00 | 0.00 | | | | |
| HCR-72 | 0.300 | 0.00 | 4.000 | 0.00 | 0.00 | 0.00 | 0.50 | 0.00 | 0.00 | 0.00 | 0.00 | 0.00 | 0.00 | 3.000 | 0.00 | 0.00 | | | | |
| HCR-73 | 0.300 | 4.000 | 4.000 | 0.00 | 0.00 | 0.00 | 1.50 | 0.00 | 0.00 | 0.00 | 0.00 | 0.00 | 0.00 | 0.00 | 0.00 | 0.00 | | | | |
| HCR-74 | 0.300 | 0.00 | 4.000 | 0.00 | 0.00 | 0.00 | 1.50 | 0.00 | 0.00 | 0.00 | 0.00 | 0.00 | 0.00 | 3.000 | 0.00 | 0.00 | | | | |
| HCR-75 | 0.300 | 2.000 | 7.000 | 0.00 | 0.00 | 0.00 | 0.00 | 0.00 | 0.00 | 0.00 | 0.00 | 0.00 | 0.00 | 3.000 | 0.00 | 0.00 | | | | |
| HCR-76 | 1.400 | 0.00 | 0.00 | 0.00 | 0.00 | 15.000 | 0.00 | 0.00 | 2.000 | 28.00 | 0.00 | 12.000 | 0.00 | 0.00 | 0.00 | 0.00 | | | | |
| HCR-77 | 1.400 | 0.00 | 0.00 | 0.00 | 0.00 | 15.000 | 0.00 | 0.00 | 2.000 | 28.00 | 0.00 | 5.000 | 0.00 | 0.00 | 0.00 | 1.00 | | | | |
| HCR-78 | 1.400 | 0.00 | 0.00 | 0.00 | 0.00 | 15.000 | 0.00 | 5.00 | 1.000 | 28.00 | 0.00 | 12.000 | 0.00 | 0.00 | 0.00 | 0.00 | | | | |
| HCR-79 | 1.40 | 0.00 | 0.00 | 0.00 | 0.00 | 20.00 | 0.00 | 0.00 | 1.00 | 32.00 | 0.00 | 5.00 | 0.00 | 0.00 | 0.00 | 0.00 | | | | |
| HCR-80 | 0.80 | | | | | 20.00 | | | 1.00 | 32.00 | | 5.00 | | | | | | | | |
| HCR-81 | 0.40 | 0.00 | 0.00 | 0.00 | 0.00 | 20.00 | 0.00 | 0.00 | 1.00 | 32.00 | 0.00 | 5.00 | 0.00 | 0.00 | 0.00 | 0.00 | | | | |
| HCR-82 | 1.40 | | | | | | | | 1.00 | 32.00 | | 5.00 | | | | | 24* | | | |
| HCR-83 | 1.40 | 0.00 | 0.00 | 0.00 | 0.00 | 15.00 | 0.00 | 0.00 | 1.00 | 32.00 | 0.00 | 5.00 | 0.00 | 0.00 | 0.00 | 0.00 | 12* | | | |
| HCR-84 | 0.40 | | | | | | | | | | | | | 3.00 | | | | 4.00 | | |
| HCR-85 | 0.40 | 2.00 | | | | 2.00 | | | | | | | | | | | | 2.00 | | |
| HCR-86 | 0.40 | | 2.00 | | | 2.00 | | | | | | 2.00 | | | | | | 2.00 | 2.00 | |
| HCR-87 | 0.40 | 2.00 | 2.00 | | 2.00 | 2.00 | | 2.00 | | | | 2.00 | | | | | | 2.00 | 2.00 | |
| HCR-88 | 0.50 | | | | | 3.00 | | 5.00 | | | | 4.00 | | | | | | | | B = 0.01 |
| HCR-89 | 0.50 | | | | | 2.00 | | 5.00 | | | | 4.00 | | | | | | | | B = 0.01 |
| HCR-90 | 0.50 | | | | | 2.50 | | 5.00 | | | | 4.00 | | | | | | | | B = 0.01 |
| HCR-91 | 0.50 | | | | | 3.00 | | 3.00 | | | | 4.00 | | | | | | | | B = 0.01 |
| HCR-92 | | 3.00 | | | 2.00 | 3.00 | | 5.00 | | | | 4.00 | | | 1.50 | | | | | |
| HCR-93 | 0.80 | | | 0.24 | | 3.00 | | | 1.60 | 2.00 | | 3.00 | | | 1.50 | | | | | |
| HCR-94 | 0.50 | | 0.30 | | | 2.50 | | 1.50 | | | | 3.00 | | | | | | | | B = 0.01 |
| HCR-100 | | 1.00 | | | 2.00 | 3.00 | | 5.00 | | | | 5.00 | | | | | | | | |
| HCR-95 | | 1.00 | | | | 2.00 | | 3.00 | | | | 3.00 | | | | | | | | |
| HCR-96 | | 1.00 | | | | 2.00 | 0.30 | 3.00 | | | | 3.00 | | | | | | | | |
| HCR-97 | | 1.00 | | | 2.00 | 2.00 | | 3.00 | | | | 3.00 | | | | | | | | |
| HCR-98 | | 1.00 | | | | 2.00 | | | | | | 3.00 | | | | | | | | |
| HCR-99 | | | | | 2.00 | 2.00 | 0.30 | 3.00 | | | | 3.00 | | | | | | | | |
| HCR-109 | 0.80 | | | 0.24 | | 4.00 | | | 1.60 | 2.00 | | 4.00 | | | 1.50 | | | | | Y = 0.10 |
| | | | | | | | | | | | | | | | | | | | | La = 0.5 |
| HCR-107 | | | | | | 2.50 | | | | | | 3.00 | | | | | | | | Ce = 1.0 |
| HCR-108 | | | | | | 3.00 | | | | | | 3.00 | | | | | | | | Ce = 0.5 |
| HCR-106 | | | | | | 2.50 | | | | | | 3.00 | | | | | | | | Ce = 0.02 |
| HCR-101 | 0.50 | | 0.30 | 4.00 | | 2.50 | | | | | | 3.00 | | | | | | | | B = 0.01 |
| HCR-102 | 0.50 | | 0.08 | 4.00 | | 3.00 | | | | | | 6.00 | | | | | | | | B = 0.01 |
| HCR-103 | | 1.00 | | | | 3.50 | | 5.00 | | | | 6.00 | | | | | | | | |
| HCR-104 | | 1.00 | | | | 3.50 | | | | | | 6.00 | | | | | | | | |
| HCR-105 | | | | | | 3.50 | | | | | | 3.00 | | | | | | | | |
| HCR-115 | | | | | | 2.50 | | | | | | 3.00 | | | | | | | | Ge = 0.8 |
| HCR-118 | | | | | | 2.50 | | | | | | 3.00 | | | | | | 0.30 | | Ru = 0.10 |
| HCR-113 | | | | | | 2.50 | | | | | | 3.00 | | | | | | | | Ru = 0.28 |
| HCR-114 | | | | | | 2.50 | | | | | | 3.00 | | | | | | | | Ga = 0.8 |
| HCR-116 | | | | | | 2.50 | | | | | | 3.00 | | | | | | | | Y = 0.30 |
| HCR-117 | | | | | | 2.50 | | | | | | 3.00 | | | | | | | | B = 0.01 |
| | | | | | | | | | | | | | | | | | | | | Ce = 0.01 |
| | | | | | | | | | | | | | | | | | | | | Ca = 0.01 |
| HCR-110 | 0.55 | | | 0.24 | | 2.50 | | 2.00 | 1.60 | 2.00 | | 5.00 | | | 1.50 | | | | | |
| HCR-111 | 0.55 | | | 0.24 | | 3.00 | | 5.00 | 1.60 | 2.00 | | 5.00 | | | 1.50 | | | | | |
| HCR-112 | 0.55 | 1.50 | | 0.24 | | 3.00 | | 5.00 | 1.60 | 2.00 | | 5.00 | | | 1.50 | | | | | |
| HCR-119 | | | | | | 3.00 | | 2.00 | | 9.00 | | 3.00 | | | | | | | | |
| HCR-120 | | 1.00 | | | | 1.50 | | 2.00 | | 12.00 | | 5.00 | | | | | | | | |
| HCR-121 | | 1.00 | | | | 3.00 | | 2.00 | | 9.00 | | 5.00 | | | | | | | | |
| HCR-122 | | | | | | 3.00 | | 2.00 | | 12.00 | | 3.00 | | | | | | | | |
| HCR-123 | | 1.00 | | 1.00 | | 3.00 | | 2.00 | | 12.00 | | 3.00 | | | | | | | | |
| HCR-124 | | | | | | 2.00 | | | | | | 2.60 | | | | | | | | |
| HCR-125 | | | | | | 2.50 | | | | | | 2.00 | | | | | | | | |
| HCR-126 | 0.33 | | | 1.40 | | 2.50 | | 6.00 | 0.30 | 0.40 | | 8.30 | | | 1.60 | 0.60 | | | | |
| HCR-127 | 0.40 | | | 1.30 | | 3.00 | | 6.20 | 1.00 | 0.60 | | 7.80 | | | 1.70 | 0.75 | | | | |
| MB1 | 0.40 | | | 1.30 | | 1.28 | | 6.20 | 0.30 | 0.40 | | 7.90 | | | 1.70 | 0.74 | | | | |
| MB2 | 0.40 | | | 1.30 | | 1.28 | | 6.20 | 1.20 | 0.60 | | 7.90 | | | 1.70 | 0.74 | | | | |
| MB3 | 0.40 | | | 1.30 | | 1.28 | | 6.20 | | | | 7.90 | | | 1.70 | 0.74 | | | | |
| HCR 129 | | 0.8 | | | | 3.5 | | | | | | 3.5 | | | | | | | | Ce = 2 |
| | | | | | | | | | | | | | | | | | | | | Y = 0.2 |
| | | | | | | | | | | | | | | | | | | | | La = 2.5 |
| HCR 128 | | | | | | 3 | | | | | | 3 | | | | | | | | Ce = 4 |
| HCR | | | | | | 2.5 | | | | | | 2.5 | | | | | | | | La = 2.5 |
| 1277 | | | | | | | | | | | | | | | | | | | | |
| HCR 130 | 0.33 | | | 1.40 | | 2.50 | | 6.00 | 0.30 | 0.40 | | 8.30 | | | 1.60 | 0.60 | | | | |
| HCR 131 | 0.33 | | | 1.40 | | 3.50 | | 6.00 | 0.30 | 0.40 | | 9.30 | | | 1.60 | 0.60 | | | | |
| HCR 132 | 0.40 | | | 1.30 | | 3.00 | | 6.20 | 1.00 | 0.60 | | 7.80 | | | 1.70 | 0.75 | | | | |
| HCR 140 | 0.2 | | | | | 3.5 | 0.3 | | | | | 3.5 | | | | | | | | Ce = 0.06 |
| HCR 136 | | 0.8 | | | | 2.5 | | 3.5 | | | | 8 | | | | | | | | Ce = 0.03 |
| HCR 137 | | | | | | 2.5 | 0.1 | 3.5 | | | | 8 | | | | | | | | Ce = 0.03 |
| HCR 133 | 0.35 | | | 1.3 | | 3 | | 6 | 1 | | | 8 | | | 1.6 | 0.75 | | | | |
| HCR 134 | 0.25 | | | 1.3 | | 2 | | 6 | 1 | | | 8 | | | 1.6 | 0.1 | | | | |
| HCR 135 | | 0.8 | | | | 2.5 | | | 1 | 0.69 | | 8 | | | | 0.1 | | | | |
| HCR 138 | 0.2 | | | | | 2 | | | | | | 6 | | | | | | | | |
| HCR 139 | 0.2 | | 0.08 | | | 3 | | | | | | 9 | | | | | | | | |
| HCR 141 | 0.2 | 0.6 | 0.4 | | | 3.5 | | | | | | 2.5 | | | | | | | | |
| HCR 142 | 0.4 | | | | | | | | | | | 15 | | | | | | | | |
| HCR 143 | 0.4 | | | | | | | | | | | 20 | | | | | | | | |
| HCR 144 | 0.4 | | | | | | | | | | | 25 | | | | | | | | |
| HCR 145 | 0.4 | | | | | | | | | | | 12 | | | | | | | | |
| HCR 146 | 0.4 | | | | | | | | | | | 8 | | | | | | | | |
| HCR 147 | 0.4 | | | | | | | | | | | 6 | | | | | | | | |
| HCR 148 | 0.4 | | | | | | | | | | | 10 | | | | | | | | |
| HCR 149 | 0.4 | | | | | 2 | | | | | | 8 | | | | | | | | |
| HCR 150 | | | | | | | | | | | | 15 | | | | | | | | |
| HCR 151 | 0.4 | | | | | | | | | | | 18 | | | | | | | | |
| HCR 152 | 0.4 | | | | | | | | | | | 17 | | | | | | | | |
| HCR 153 | 1 | | | | | | | | | | | 20 | | | | | | | | |
| HCR 154 | 1 | | | | | | | | | | | 25 | | | | | | | | |
| HCR 155 | 1 | | | | | | | | | | | 15 | | | | | | | | |
| HCR 156 | 0.33 | | | 1.40 | | 2.50 | | 6.00 | 0.00 | 0.00 | | 8.30 | | | 1.60 | 0.60 | | | | |
| HCR 157 | 0.33 | | | 1.40 | | 3.50 | | 6.00 | 0.00 | 0.00 | | 9.30 | | | 1.60 | 0.60 | | | | |
| HCR 158 | 0.40 | | | 1.30 | | 3.00 | | 6.20 | 0.00 | 0.00 | | 7.80 | | | 1.70 | 0.75 | | | | |
| HCR 159 | 0.33 | | | 1.3 | | 0.9 | | 6.2 | | | | 8 | | | 1.6 | 0.65 | | | | |
| HCR 160 | 0.4 | | | 1.3 | | 1.6 | | 6.2 | | | | 7 | | | 1.6 | 0.65 | | | | |
| HCR 161 | 0.45 | | | 1.6 | | 2 | | 6.8 | | | | 8.5 | | | 1.6 | 0.85 | | | | |
| HCR 162 | 0.00 | 2.00 | 3.80 | 0.00 | 2.00 | 2.00 | 1.50 | 5.00 | 0.00 | 0.00 | 0.00 | 0.00 | 0.00 | 0.00 | 0.00 | 0.00 | | | | |
| HCR 163 | | 3 | 2 | | 2 | 2 | | 5 | | | | | | | | | | | | B = 0.3 |
| HCR 164 | | 3 | | | | 2 | | 3 | | | | 3 | | | | | | | | B = 0.35 |
| | | | | | | | | | | | | | | | | | | | | Ce = 0.03 |

In table 11, are shown different parameters measured for the same examples shown in Table 10. Immersion tests were performed during 72 h in three types of water, deionized water, tap water from Rubi in Spain and marine water from Barceloneta, in Spain. Resistance to oxidation of different water solutions were measured before thermal treatment and after thermal treatment.

TABLE 11
Different properties for steels of Table 10.

| | | | Atac Before | | | Atac After | | |
|---|---|---|---|---|---|---|---|---|
| | HRc | HRc | TT | | | TT | | |
| N° Ex | min | max | Dest | Wat | Mar | Dest | Wat | Mar |
| AISI 420 | 39 | 53.5 | | 4 | | | 2 | |
| HCR-10 | 36/359 | 49.5 | | 3 | | | 3 | |
| HCR-11 | 293HB | 43.0 | | 3 | | | 1 | |
| HCR-12 | 35.0 | 44.0 | | 5 | | | 4 | |
| HCR-13 | 262HB | 37.0 | | 2 | | | 1 | |
| HCR-14 | 35.5 | 53.0 | | 3 | | | 2 | |
| HCR-15 | 41.5 | 52.0 | | 3 | | | 2 | |
| HCR-6 | 35 | 54.0 | | 3 | | | 2 | |
| HCR-7 | 33 | 55.0 | | 3 | | | 1 | |
| HCR-8 | 39 | 55.0 | | 3 | | | 1 | |
| HCR-9 | 255 HB | 293HB | | 2 | | | 1 | |
| HCR-1 | 194 HB | 226HB | | 2 | | | 1 | |
| HCR-2 | 31.5 | 52.0 | | 2/1 | | | 3 | |
| HCR-3 | 34 | 54.0 | | 2/1 | | | 1 | |
| HCR-4 | 47 | 55.0 | | 2/1 | | | 1 | |
| HCR-5 | 30 | 45.0 | | 2/1 | | | 1 | |
| HCR-16 | 42.0 | 51.0 | 2 | | | 2 | | |
| HCR-17 | 41.5 | 51.0 | 2 | | | 2 | | |
| HCR-18 | | | | | | | | |
| HCR-19 | | | | | | | | |
| HCR-20 | | | | | | | | |
| HCR-21 | | | | | | | | |
| HCR-22 | | | | | | | | |
| HCR-23 | | | | | | | | |
| HCR-24 | | | | | | | | |
| HCR-25 | | | | | | | | |
| HCR-26 | | | | | | | | |
| HCR-27 | | | | | | | | |
| HCR-28 | | | | | | | | |
| HCR-29 | | | | | | | | |
| HCR-30 | | | | | | | | |
| HCR-31 | | | | | | | | |
| HCR-32 | | | | | | | | |
| HCR-33 | | | | | | | | |
| HCR-34 | | — | 2 | | | 2 | | |
| HCR-35 | | — | 3 | | | 3 | | |
| HCR-36 | | — | 3 | | | 3 | | |
| HCR-37 | 38.5 | 50.0 | 5 | | 5 | 5 | | 5 |
| HCR-38 | | — | 5 | | 3 | 5 | | 3 |
| HCR-39 | | — | 5 | | 2 | 5 | | 2 |
| HCR-40 | 382HB | 46.0 | 5 | | 4 | 5 | | 4 |
| HCR-41 | | — | 4 | | 4 | 4 | | 4 |
| HCR-42 | | — | 4 | | 5 | 4 | | 5 |
| HCR-43 | | — | 3 | | 5 | 3 | | 5 |
| HCR-44 | | — | | | 4 | | | 4 |
| HCR-45 | 39.5 | 50.0 | 5 | | 5 | 5 | | 5 |
| HCR-46 | | — | | | 3/5 | | | 3/5 |
| HCR-47 | | — | | | 3 | | | 3 |
| HCR-48 | | — | | | 4 | | | 4 |
| HCR-49 | | — | 5 | | 2 | 5 | | 2 |
| HCR-50 | | | | | | | | |
| HCR-51 | | | | | | | | |
| HCR-52 | | | | | | | | |
| HCR-53 | | | | | | | | |
| HCR-54 | 210HB | 226HB | 4 | | 2 | 4 | | 2 |
| HCR-55 | 198HB | 206HB | 2 | | 2 | 2 | | 2 |
| HCR-56 | 194HB | 220HB | 2 | | 2 | 2 | | 2 |
| HCR-57 | 226HB | 255HB | 5 | | 2 | 5 | | 2 |
| HCR-58 | 141HB | 216HB | 5 | | 2 | 5 | | 2 |
| HCR-59 | 243HB | 43.0 | 5 | | 2 | 5 | | 2 |
| HCR-60 | 45.0 | 51.0 | 5 | | 2 | 5 | | 2 |
| HCR-61 | 45.5 | 52.0 | 5 | | 2 | 5 | | 2 |
| HCR-62 | 35.5 | 52.0 | 5 | | 2 | 5 | | 2 |
| HCR-63 | 43.0 | 47.0 | | | | | | |
| HCR-64 | 42.5 | 43.0 | | | | | | |
| HCR-65 | 52.0 | 54.0 | | | | | | |
| HCR-66 | 41.0 | 45.0 | | | | | | |
| HCR-63 | 52.0 | 54.0 | | | | | | |
| bis | | | | | | | | |
| HCR-65 | 43.0 | 46.0 | | | | | | |
| bis | | | | | | | | |
| HCR-67 | 194HB | 226HB | | | | | | |
| HCR-68 | 215HB | 249HB | | | | | | |
| HCR-69 | 190HB | 238HB | | | | | | |
| HCR-70 | 226HB | 249HB | | | | | | |
| HCR- | 190HB | 249HB | | | | | | |
| 68bis | | | | | | | | |
| HCR- | 179HB | 220HB | | | | | | |
| 69bis | | | | | | | | |
| HCR-71 | 202HB | 210HB | | | | | | |
| HCR-72 | 194HB | 226HB | | | | | | |
| HCR-73 | 206HB | 285HB | | | | | | |
| HCR-74 | 206HB | 238HB | | | | | | |
| HCR-75 | 255HB | 285HB | | | | | | |
| HCR-76 | | | | | | | | |
| HCR-77 | | | | | | | | |
| HCR-78 | | | | | | | | |
| HCR-79 | 50.0 | 51.0 | | | | | | |
| HCR-80 | 301HB | 328HB | | | | | | |
| HCR-81 | 277HB | 395HB | | | | | | |
| HCR-82 | | | | | | | | |
| HCR-83 | | | | | | | | |
| HCR-84 | 137HB | 141HB | | | | | | |
| HCR-85 | 179HB | 202HB | | | | | | |
| HCR-86 | 182HB | 202HB | | | | | | |
| HCR-87 | 269HB | 309HB | | | | | | |
| HCR-88 | 46.0 | 57.0 | | | | | | |
| HCR-89 | 45.0 | 55.0 | | | | | | |
| HCR-90 | 44.5 | 52.0 | | | | | | |
| HCR-91 | 44.5 | 59.0 | | | | | | |
| HCR-92 | 338HB | 52.0 | | | | | | |
| HCR-93 | 269HB | 60.0 | | | | | | |
| HCR-94 | 38.0 | 60.0 | | | | | | |
| HCR-100 | 40.0 | 45.0 | | | | | | |
| HCR-95 | 194HB | 318HB | | | | | | |
| HCR-96 | 210HB | 318HB | | | | | | |
| HCR-97 | 328HB | 424HB/41HRc | | | | | | |
| HCR-98 | 127HB | 130HB | | | | | | |
| HCR-99 | 36.0 | 40.0 | | | | | | |
| HCR-109 | 243HB | 53.0 | | | | | | |
| HCR-107 | 285HB | 47.0 | | | | | | |
| HCR-108 | 37.0 | 46.0 | | | | | | |
| HCR-106 | 147HB | 158HB | | | | | | |
| HCR-101 | 139HB | 170HB | | | | | | |
| HCR-102 | 135HB | 138HB | | | | | | |
| HCR-103 | 123HB | 126HB | | | | | | |
| HCR-104 | 122HB | 130HB | | | | | | |
| HCR-105 | 243HB | 51.0 | | | | | | |
| HCR-115 | 45.0 | 52.0 | | | | | | |
| HCR-118 | 38.0 | 47.0 | | | | | | |
| HCR-113 | 51.0 | 56.0 | | | | | | |
| HCR-114 | 139HB | 158HB | | | | | | |
| HCR-116 | 151HB | 215HB | | | | | | |
| HCR-117 | 145HB | 161HB | | | | | | |
| HCR-110 | 147HB | 158HB | | | | | | |
| HCR-111 | 135HB | 147HB | | | | | | |
| HCR-112 | 141HB | 147HB | | | | | | |
| HCR-119 | 277HB | 422.0 | | 1 | | | 1 | |
| HCR-120 | 243HB | 44.0 | | 1 | | | 2 | |
| HCR-121 | 210HB | 44.0 | | 1 | | | 1 | |
| HCR-122 | 277HB | 42.5 | | 2 | | | 1 | |
| HCR-123 | 249HB | 46.0 | | 2 | | | 2 | |
| HCR-124 | 33HRc/309HB | 52.0 | | 5 | | | 5 | |
| HCR-125 | 41.0 | 57.0 | | 2 | | | 2 | |
| HCR-126 | 48.0 | 59.0 | | 5 | | | 2 | |
| HCR-127 | 45.0 | 59.5 | | 5 | | | 2 | |
| MB1 | 41.0 | 55.0 | | | | | | |
| MB2 | 42.0 | 60.0 | | | | | | |
| MB3 | 47.5 | 58.0 | | | | | | |
| HCR 129 | 118HB | 122HB | | 1 | | | | |
| HCR 128 | 151HB | 277HB | | 1 | | | | |
| HCR 1277 | 164HB | 173HB | | 4 | | | | |
| HCR 130 | 40.0 | 60.0 | | 4 | | | | |
| HCR 131 | 39.0 | 59.0 | | 4 | | | | |
| HCR 132 | 41.5 | 60.0 | | 4 | | | | |
| HCR 140 | | 58.0 | | 2 | | | | |
| HCR 136 | 41.0 | 56.0 | | 5 | | | | |
| HCR 137 | 164HB | 182HB | | 2 | | | | |
| HCR 133 | 262HB | 38.0 | | 2 | | | | |
| HCR 134 | 269HB | 40.5 | | 2 | | | | |
| HCR 135 | 269HB | 43.0 | | 1 | | | | |
| HCR 138 | 215HB | 277HB | | 2 | | | | |
| HCR 139 | 243HB | 299HB | | 1 | | | | |
| HCR 141 | 153HB | 202HB | | 1 | | | | |
| HCR 142 | 49.0 | 54.0 | | 5 | | | 2 | |
| HCR 143 | 206HB | 255HB | | 5 | | | 2 | |
| HCR 144 | 176HB | 206HB | | 5 | | | 2 | |
| HCR 145 | 50.0 | 53.0 | | 5 | | | 2 | |
| HCR 146 | 50.0 | 54.0 | | 1 | | | 2 | |
| HCR 147 | 50.0 | 54.0 | | 1 | | | 2 | |
| HCR 148 | 46.0 | 53.0 | | 2 | | | 2 | |
| HCR 149 | 48.0 | 52.5 | | 2 | | | 2 | |
| HCR 150 | 220HB | 318HB | | 5 | | | 2 | |
| HCR 151 | 46.0 | 48.5 | | 5 | | | | |
| HCR 152 | 51.0 | 54.0 | | 5 | | | | |
| HCR 153 | 277HB | 57.0 | | 5 | | | | |
| HCR 154 | 35/301HB | 52.0 | | 5 | | | | |
| HCR 155 | 269HB | 56.0 | | 2 | | | | |
| HCR 156 | 38.0 | 57.0 | | | | | | |
| HCR 157 | 40.5 | 56.5 | | | | | | |
| HCR 158 | 40.5 | 59.0 | | | | | | |
| HCR 159 | 40.0 | 56.5 | | | | | | |
| HCR 160 | 39.5 | 59.0 | | | | | | |
| HCR 161 | 40.0 | 53.0 | | | | | | |
| HCR 162 | | | | | | | | |
| HCR 163 | | | | | | | | |
| HCR 164 | | | | | | | | |

Numbers in the corrosion test show in the table corresponds with:

1. Homogeneous corrosion which cannot be clean out with water or a cloth.

2. Homogeneous corrosion layer which can be clean out with water and a cloth.

3. Inhomogeneous attacks

4. Few small areas with corrosive attack

5. No attack.

### Example 8

A plot were made of the d(dL/L)/dt (increment of length increase normalized with length divided by increment of time) vs. temperature during cooling for steel 3356LAB-3, shown in Example 5, table 8, as shown in FIG. 2

For comparative purposes a plot were made of the d(dL/L)/dt (increment of length increase normalized with length divided by increment of time) vs. temperature during cooling for conventional steel H11, shown in Example 5, table 8, as shown in FIG. 1.

TD values obtained for the steel of the invention and a conventional steel are different. FIG. 2, shows that, in the case of conventional steel H11, TD value is higher than 360° C., instead TD value for steel of the invention 3356LAB-3, is less than 280° C.

### Example 9

### Steels Having the Following Nominal Composition were Developed

TABLE 12
Steels of the present invention.

| % C | % Mn | % Si | % Ni | % Cr | % Mo | % V | % Zr | % Al | % Ti | % Cu | % B | Hsoft | Hmax |
|---|---|---|---|---|---|---|---|---|---|---|---|---|---|
| 0.13 | 2.00 | 1.60 | 0.00 | 7.50 | 0.00 | 0.40 | 1.50 | 0.00 | 0.00 | 0.00 | 0.000 | 143HB | 220HB |
| 1.30 | 0.00 | 1.60 | 0.00 | 7.50 | 0.00 | 0.40 | 1.50 | 0.00 | 0.00 | 0.00 | 0.000 | 43 | 61 |
| 1.30 | 2.00 | 1.60 | 3.20 | 1.00 | 0.25 | 0.40 | 4.30 | 0.00 | 0.00 | 0.00 | 0.000 | 43 | 56 |
| 0.95 | 2.00 | 1.60 | 3.20 | 1.00 | 0.25 | 0.80 | 0.40 | 0.00 | 0.00 | 0.00 | 0.001 | 49 | 59 |
| 1.20 | 2.00 | 1.60 | 0.00 | 1.00 | 0.25 | 0.80 | 0.40 | 0.00 | 0.00 | 0.00 | 0.006 | 40 | 64 |
| 1.30 | 2.00 | 1.60 | 0.00 | 7.50 | 0.00 | 0.40 | 1.50 | 0.00 | 0.00 | 0.00 | 0.000 | 43 | 61 |
| 0.50 | 6.00 | 2.00 | 0.00 | 0.00 | 0.00 | 0.00 | 3.80 | 0.00 | 2.00 | 0.00 | 0.00 | 285HB | 49 |
| 0.85 | 6.00 | 2.00 | 0.00 | 0.00 | 0.00 | 0.00 | 3.80 | 0.00 | 2.00 | 0.00 | 0.00 | 285HB | 45.5 |
| 0.85 | 6.00 | 2.00 | 0.00 | 0.00 | 0.00 | 1.00 | 3.80 | 0.00 | 2.00 | 0.00 | 0.00 | 220HB | 47 |
| 1.00 | 6.00 | 2.00 | 0.00 | 7.00 | 0.00 | 0.00 | 3.80 | 0.00 | 2.00 | 0.00 | 0.00 | 338HB | 44.5 |
| 0.50 | 6.00 | 2.00 | 0.00 | 0.00 | 0.00 | 0.00 | 3.80 | 0.00 | 2.00 | 0.00 | 0.00 | 238HB | 43.5 |
| 0.85 | 6.00 | 2.00 | 0.00 | 0.00 | 0.00 | 0.00 | 3.80 | 0.00 | 2.00 | 0.00 | 0.00 | 309HB | 41 |
| 0.85 | 6.00 | 2.00 | 0.00 | 0.00 | 0.00 | 1.00 | 3.80 | 0.00 | 2.00 | 0.00 | 0.00 | 232HB | 43.5 |
| 1.00 | 6.00 | 2.00 | 0.00 | 7.00 | 0.00 | 0.00 | 3.80 | 0.00 | 2.00 | 0.00 | 0.00 | 318HB | 36 |
| 0.50 | 6.00 | 2.00 | 0.00 | 0.00 | 0.00 | 0.00 | 3.80 | 0.00 | 2.00 | 0.00 | 0.00 | 232HB | 41 |
| 1.00 | 6.00 | 2.00 | 0.00 | 7.00 | 0.00 | 2.40 | 3.80 | 3.00 | 3.00 | 0.00 | 0.00 | 40 | 46 |
| 1.00 | 6.00 | 2.00 | 0.00 | 0.00 | 0.00 | 2.40 | 3.80 | 0.00 | 2.50 | 0.00 | 0.00 | 243HB | 46 |
| 1.00 | 6.00 | 2.00 | 0.00 | 0.00 | 0.00 | 0.00 | 3.80 | 0.00 | 4.00 | 0.00 | 0.00 | 238HB | 44 |
| 1.00 | 6.00 | 2.00 | 0.00 | 0.00 | 0.00 | 0.00 | 3.80 | 0.00 | 3.00 | 0.00 | 0.00 | 295HB | 46.5 |
| 0.50 | 6.00 | 2.00 | 0.00 | 0.00 | 0.00 | 0.00 | 3.80 | 0.00 | 2.00 | 0.00 | 0.00 | 225HB | 3 |
| 0.33 | 6.00 | 2.00 | 0.00 | 0.00 | 0.00 | 0.00 | 3.80 | 0.00 | 2.00 | 0.00 | 0.00 | 238HB | 51 |
| 0.80 | 6.00 | 2.00 | 0.00 | 0.00 | 0.00 | 0.00 | 3.80 | 0.00 | 2.00 | 0.00 | 0.00 | 266HB | 43 |
| 0.50 | 4.00 | 2.00 | 0.00 | 0.00 | 0.00 | 0.00 | 3.80 | 0.00 | 2.00 | 0.00 | 0.00 | 205HB | 53 |
| 0.33 | 4.00 | 2.00 | 0.00 | 0.00 | 0.00 | 0.00 | 3.80 | 0.00 | 2.00 | 0.00 | 0.00 | 220HB | 52 |
| 0.80 | 4.00 | 2.00 | 0.00 | 0.00 | 0.00 | 0.00 | 3.80 | 0.00 | 2.00 | 0.00 | 0.00 | 250HB | 43 |
| 0.50 | 8.00 | 2.00 | 0.00 | 0.00 | 0.00 | 0.00 | 3.80 | 0.00 | 2.00 | 0.00 | 0.00 | 285HB | 52 |
| 0.33 | 8.00 | 2.00 | 0.00 | 0.00 | 0.00 | 0.00 | 3.80 | 0.00 | 2.00 | 0.00 | 0.00 | 262HB | 48 |
| 0.80 | 8.00 | 2.00 | 0.00 | 0.00 | 0.00 | 0.00 | 3.80 | 0.00 | 2.00 | 0.00 | 0.00 | 310HB | 46 |
| 0.45 | 5.00 | 2.00 | 0.00 | 0.00 | 0.00 | 0.00 | 3.80 | 0.00 | 2.00 | 0.00 | 0.00 | 238HB | 53 |
| 0.45 | 5.00 | 2.00 | 0.00 | 0.00 | 0.00 | 0.00 | 0.80 | 0.00 | 2.00 | 0.00 | 0.00 | 285HB | 43 |
| 0.45 | 5.00 | 2.00 | 0.00 | 0.00 | 0.00 | 0.00 | 0.00 | 0.00 | 2.00 | 0.00 | 0.00 | 208HB | 318HB |
| 0.45 | 5.00 | 2.00 | 0.00 | 0.00 | 0.00 | 0.00 | 3.80 | 0.00 | 2.00 | 0.00 | 0.01 | 238HB | 52 |
| 0.45 | 5.00 | 2.00 | 0.00 | 0.00 | 0.00 | 0.00 | 0.00 | 0.00 | 2.00 | 0.00 | 0.01 | 269HB | 293 |
| 0.45 | 5.00 | 2.00 | 0.00 | 0.00 | 0.00 | 0.00 | 3.80 | 0.00 | 2.00 | 0.00 | 0.40 | 262HB | 52.5 |
| 0.45 | 5.00 | 2.00 | 0.00 | 0.00 | 0.00 | 0.00 | 0.00 | 0.00 | 2.00 | 0.00 | 0.40 | 262HB | 328HB |
| 0.45 | 5.00 | 2.00 | 0.00 | 0.00 | 0.00 | 0.00 | 3.80 | 0.00 | 2.00 | 4.00 | 0.00 | 293HB | 52 |
| 0.45 | 5.00 | 2.00 | 0.00 | 0.00 | 0.00 | 0.00 | 0.00 | 1.20 | 2.00 | 0.00 | 0.00 | 206HB | 277HB |

### Example 11

A hot stamping die as illustrated in Figure-4 is constructed. Additive manufacturing is used to manufacture the intermediate mold (1 and 2 in FIG. 4). UV Stereolithography is used with a polymerizable resin with a UV light initiator and acrylic monomers based on poli (hydroxy butyl) methacrylate.

with a Tg slightly higher than 300° C., and a heat deflection temperature at 0.45 MPa around than 290° C. The Bulk modulus is around 3 GPa and the yield strength around 70 MPa. The intermediate mold is filled with powder (4 in FIG. 4) with the composition of example 6-3217 LAB 3-. Then the filled intermediate model is submerged in molten rubber to create an outer model (part 3 in FIG. 4). The mold undergoes a CIP cycle at 450 MPa during 10 minutes. A thermal destruction of both the intermediate mold and exterior rubber mold take place in a controlled atmosphere furnace up to 650° C. followed by a chemical cleansing. A sintering under Ar atmosphere at 1200° C. during 1:30 h is the next step. Finally, a HIP at 1150° C. during 4 h at 100 MPa is the final consolidation step.

The die is then installed in a hot stamping test line. The temperature is controlled trough a fast action variotherm type of water tempering system, and the surface temperature of the die is controlled trough an embedded sensor with redundant thermocouples at 1 mm from the die surface. Temperature is set at 16° C., and no more than 10° C. variation is registered throughout the process. The die is uniformly sprayed on the working surface with a set of nozzles that atomize a water-air mixture. Spraying takes place between the removing of a finished component and the placement of the next hot sheet. The open die cycle (component removal, spraying of the surface, new hot sheet placement and movement of the press) takes 6 seconds. The closed die cycle (quenching step) takes 0.5 seconds. The sheet material is 1.85 mm 22MnB5 and yield strengths surpassing 1100 MPa and ultimate strengths surpassing 1550 MPa with elongations of more than 7,5% are consistently obtained.

### Example 12

A hot zone die similar to that illustrated in Figure-4 is constructed. Instead of a complex internal cooling structure, it has cylindrical holes to allocate cartridge heating elements of diameter 20 mm. The channels are placed 40 mm from the surface. DLP Stereolithography is used with a low cost polymerizable resin with a visible light initiator and acrylic monomers. The resin does not have any special temperature resistance.

The intermediate mold is filled with powder (4 in FIG. 4) with the composition of example 2-1.1-. Then the filled intermediate model is submerged in a mixture of a two-component neoprene (Liquid EPDM Rubber) to create an outer model (part 3 in FIG. 4) and is let cure in air. The mold undergoes a CIP cycle at 650 MPa during 10 minutes. A thermal destruction of both the intermediate mold and exterior rubber mold take place in a controlled atmosphere furnace up to 450° C. followed by a chemical cleansing. A sintering under Ar atmosphere at 1250° C. during 1:30 h is the next step. Finally, a HIP at 1200° C. during 4 h at 100 MPa is the final consolidation step.

1. A tool steel having the following composition, all percentages in weight percent:

| | | | |
|---|---|---|---|
| % C_{eq} = 0.4-4 | % C = 0.4-4 | % N = 0-0.6 | % B = 0-4 |
| % Cr = 0-11 | % Ni = 0-9.5 | % Si = 0-4 | % Mn = 10-40 |
| % Al = 0-17 | % Mo = 0-10 | % W = 0-6.2 | % Ti = 0-6.4 |
| % Ta = 0-3 | % Zr = 0-3 | % Hf = 0-3 | % V = 0-12 |
| % Nb = 0-3 | % Cu = 0-6 | % Co = 0-7 | % Lu = 0-2 |
| % La = 0-2 | % Ce = 0-2 | % Nd = 0-2 | % Gd = 0-2 |
| % Sm = 0-2 | % Y = 0-2 | % Pr = 0-2 | % Sc = 0-2 |
| % Pm = 0-2 | % Eu = 0-2 | % Tb = 0-2 | % Dy = 0-2 |
| % Ho = 0-2 | % Er = 0-2 | % Tm = 0-2 | % Yb = 0-2 |
| % P = 0-2 | % S = 0-2 | | |

the rest consisting of iron and trace elements
wherein,
% C_{eq}=% C+0.86*% N+1.2*% B,
wherein % Al+% Si+% Cr+% V>2%;
if % C>0.9% then % Al<10%; and wherein
% V>0.57 and/or
% Al>0.1 and/or
% Mo=0.01-7.6 and/or
% W>0.55.

2. A steel having the following composition, all percentages in weight percent:

| | | | |
|---|---|---|---|
| % C_{eq} = 0.4-2.9 | % C = 0.4-2.9 | % N = 0-0.6 | % B = 0-4 |
| % Cr = 2.1-11 | % Ni = >0.59-9.5 | % Si = 0-4 | % Mn = 0-<11.2 |
| % Al = >0.53-9 | % Mo = 0-6 | % W = 0-6.2 | % Ti = 0-4.9 |
| % Ta = 0-3 | % Zr = 0-6 | % Hf = 0-3 | % V = 0-12 |
| % Nb = 0-3 | % Cu = 0-6 | % Co = 0-7 | % Lu = 0-2 |
| % La = 0-2 | % Ce = 0-2 | % Nd = 0-2 | % Gd = 0-2 |
| % Sm = 0-2 | % Y = 0-2 | % Pr = 0-2 | % Sc = 0-2 |
| % Pm = 0-2 | % Eu = 0-2 | % Tb = 0-2 | % Dy = 0-2 |
| % Ho = 0-2 | % Er = 0-2 | % Tm = 0-2 | % Yb = 0-2 |

the rest consisting of iron and trace elements
wherein,
% C_{eq}=% C+0.86*% N+1.2*% B, and
wherein
% Al+% Si+% Cr+% Ti+% Zr>2.63%.

3. A tool steel according to claim 1, wherein % V>0.57%.

4. A tool steel according to claim 1, wherein % Al>0.1%.

5. A tool steel according to claim 1, wherein. % N>0.008%.

6. A tool steel according to claim 1, wherein % W=0.01-4.6%.

7. A tool steel according to claim 1, wherein % Ti=0.01-5.1%.

8. A tool steel according to claim 1, wherein % Mn>15.2%.

9. A tool steel according to claim 1, wherein % Mo=0.01-7.6%.

10. A tool steel according to claim 1, wherein % Co=0.01-5.3%.

11. A steel according to claim 2, wherein % Mn<4.8%.

12. A steel according to claim 2, wherein % Ceq>0.72%.

13. A steel according to claim 2, wherein % Ti=0.01-4.2%.

14. A steel according to claim 2, wherein % W=0.01-4.6%.

15. A steel according to claim 2, wherein % Ta+% Zr+% Hf+% Nb+% La+% Ce>0.01%.

16. A steel according to claim 2, wherein % Cr<6.7%.

17. A steel according to claim 2, wherein % N>0.008%.

18. A steel according to claim 2, wherein % Nb+% Co+% Lu+% La+% Ce+% Nd+% Gd+% Sm+% Y+% Pr+% Sc+% Pm+% Eu+% Tb+% Dy+% Er+% Tm+% Yb=0-10%.

19. A method for the manufacture of a tool steel according to claim 1 having a thickness of more than 303 mm comprising the following steps:
a) providing a tool steel according to claim 1;
b) applying to the tool steel a tempering treatment consisting on at least a partial austenization at a temperature above 980° C.; and
c) Optionally applying one or several machining steps and/or heat treatments below the austenization temperature of the material (also including cryogenic treatments);
d) tempering the material at least once at a temperature above 520° C.;
e) Optionally applying one or several machining steps and/or heat treatments below the austenization temperature of the material (also including cryogenic treatments).

20. A method for the manufacture of a steel according to claim 2 having a thickness of more than 303 mm comprising the following steps:
a) providing a steel according to claim 2;
b) applying to the steel a tempering treatment consisting on at least a partial austenization at a temperature above 980° C.; and
c) Optionally applying one or several machining steps and/or heat treatments below the austenization temperature of the material (also including cryogenic treatments);
d) tempering the material at least once at a temperature above 520° C.;
e) Optionally applying one or several machining steps and/or heat treatments below the austenization temperature of the material (also including cryogenic treatments).
